(19) United States
(12) Patent Application Publication
(10) Pub. No.: US 2008/0024563 A1
(43) Pub. Date: Jan. 31, 2008

(54) PIEZOELECTRIC THIN FILM ELEMENT, INK JET HEAD, AND INK JET TYPE RECORDING APPARATUS

(75) Inventors: Kiyoaki MATSUI, Kumamoto (JP); Eiji FUJII, Osaka (JP); Shintaro HARA, Fukuoka (JP); Osamu WATANABE, Kumamoto (JP); Hisahiro TANAKA, Fukuoka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 11/781,530

(22) Filed: Jul. 23, 2007

(30) Foreign Application Priority Data
Jul. 25, 2006 (JP) 2006-201581
Aug. 7, 2006 (JP) 2006-214116
Sep. 11, 2006 (JP) 2006-245225

(51) Int. Cl. B41J 2/045; H02N 2/00

(52) U.S. Cl. 347/70; 310/365

(57) ABSTRACT

A piezoelectric body (piezoelectric layer 14) is configured to include a first piezoelectric layer 14a, a second piezoelectric layer 14b, and a third piezoelectric layer 14c. A piezoelectric constant of each of the first and third piezoelectric layer 14a and 14c is set to be smaller than that of the second piezoelectric layer 14b. Thus, it is possible to reduce an internal stress generated at an interface between first and second electrode layers 13 and 15 corresponding to the first and third piezoelectric layer 14a and 14c, and generation of a crack caused by high voltage application or driving performed for a long time is expected to be greatly reduced.

### BACKGROUND

1. Field of the Invention

The present invention relates to a piezoelectric thin film element having an electromechanical transduction function, an ink jet head using the piezoelectric thin film element, and an ink jet type recording apparatus including the ink jet head as a printing unit.

2. Describe of the Related Art

A piezoelectric thin film element having an electromechanical transduction function generally has a laminated structure in which a piezoelectric thin film is interposed between two electrodes in the thickness direction of the piezoelectric thin film element.

Typical piezoelectric materials include a lead zirconate titanate (Pb(Zr, Ti)O₃; hereinafter, referred to as ‘PZT’), which is an oxide having a perovskite type crystal structure, a material obtained by adding magnesium, manganese, nickel, niobium, or the like in the PZT, and the like.

In particular, in the case of a tetragonal-system PZT having the perovskite type crystal structure, a large piezoelectric displacement is obtained in the <001> axis directions (C-axis direction). In the case of a rhombohedral-system PZT having the perovskite type crystal structure, a large piezoelectric displacement is obtained in the <111> axis direction. However, many piezoelectric materials are polycrystalline substances (piezoelectric ceramic) that are collection of crystal grains, and crystal axes thereof extend in all directions. Accordingly, spontaneous polarization PS is also arranged irregularly. However, the piezoelectric thin film element is manufactured such that summation of such vectors is parallel to the electric field direction. Moreover, in a piezoelectric thin film actuator that is an application of the piezoelectric thin film element, when a voltage is applied between both electrodes, the mechanical displacement proportional to the intensity of the voltage is obtained. An ink jet head uses the piezoelectric thin film actuator, to which a vibrating plate is attached, as a driving source for ink discharge.

In the case of the ink jet head using the piezoelectric thin film actuator, it is necessary to apply a voltage of several tens of volts to a piezoelectric thin film having a thickness of several micrometers. Accordingly, a voltage endurance of hundreds of kV/cm or more is requested. For this reason, in order to prevent a leak path from being generated in a piezoelectric thin film, various kinds of study have been performed. For example, an insulating matter is embedded in a defective part existing within a piezoelectric thin film (refer to Patent Document 1), a low dielectric constant material is formed in a region of a piezoelectric thin film where crystal grains are exposed (refer to Patent Document 2), or a piezoelectric body having a different crystal grain diameter is laminated in the thickness direction of a piezoelectric thin film such that a leak path in the thickness direction becomes discontinuous (refer to Patent Document 3).

Furthermore, as a related technique, Patent Document 4 discloses a technique of measuring a piezoelectric constant of a piezoelectric thin film element that is formed. In addition, Patent Document 5 discloses a thin-film piezoelectric actuator used in a supporting mechanism of a head, which is used to perform recording and reproduction of information with respect to a disk of a disk device used as, for example, a storage device of a computer.

Patent Document 1: JP-A-2000-351212

Patent Document 2: Japanese Patent No. 3666163

Patent Document 3: JP-A-2000-307163

Patent Document 4: JP-A-2002-225285

Patent Document 5: JP-A-2001-332041

The above measures have been proposed to prevent an insulation performance of a piezoelectric thin film element from deteriorating by improving the voltage endurance of the piezoelectric thin film element. However, since an actuator using a piezoelectric thin film element largely deforms by voltage application, the insulation performance also deteriorates due to a crack, which is caused by a large internal stress occurring inside the piezoelectric thin film element due to the deformation. Particularly in the case when the actuator is used for a long time, a crack generated by fatigue is observed, and thus the insulation performance easily deteriorates.

### SUMMARY

The invention has been finalized in view of the drawbacks inherent in the related art, and it is an object of the invention to provide a piezoelectric thin film element whose insulation performance does not deteriorate and which is highly reliable even if a voltage is applied for a long time to drive the piezoelectric thin film element, an ink jet head using the piezoelectric thin film element, and an ink jet type recording apparatus including the ink jet head as a printing unit.

In order to achieve the above object, according to an aspect of the invention, a piezoelectric thin film element includes: a piezoelectric body; and a pair of electrodes provided on both sides of the piezoelectric body in the thickness direction thereof. The piezoelectric body is configured to include three or more piezoelectric layers, and a piezoelectric constant of each of the piezoelectric layers that are in contact with the electrodes is set to be smaller than that of each of the piezoelectric layers that are not in contact with the electrodes.

According to the aspect of the invention, it becomes possible to reduce an influence of an internal stress occurring in a piezoelectric thin film element.

### BRIEF DESCRIPTION OF THE DRAWINGS

FIG. 1 is a cross-sectional view illustrating the configuration of a piezoelectric thin film element according to a first embodiment of the invention.

FIG. 2 is a view illustrating an external appearance of the entire configuration of an ink jet head according to the first embodiment of the invention.

FIG. 3 is a perspective view illustrating the configuration of main parts of the ink jet head according to the first embodiment of the invention.

FIG. 4 is a cross-sectional view illustrating the configuration of an actuator part which is a main part of the ink jet head ink according to the first embodiment of the invention.

FIGS. 5A to 5C are cross-sectional views illustrating a laminating process, a process of forming a pressure chamber opening, and a process of attaching an adhesive in the first embodiment of the invention.

FIGS. 6A and 6B are cross-sectional views illustrating procedures (a process of bonding a film forming substrate after film formation and a pressure chamber member to each other and a process of forming a longitudinal wall) for manufacturing the ink jet head according to the first embodiment of the invention.

FIGS. 7A and 7B are cross-sectional views illustrating procedures (a process of removing a film forming substrate after film formation and an adhesion layer and a process of separating a first electrode layer into individual parts) for manufacturing the ink jet head according to the first embodiment of the invention.

FIGS. 8A and 8B are cross-sectional views illustrating procedures (a process of separating a piezoelectric layer into individual parts and a process of cutting a substrate for pressure chamber member) for manufacturing the ink jet head according to the first embodiment of the invention.

FIGS. 9A to 9D are cross-sectional views illustrating procedures (a process of generating an ink passage member and a nozzle plate, a process of bonding the ink passage member and the nozzle plate to each other, a process of bonding the pressure chamber member and the ink passage member to each other, and a completed ink jet head) for manufacturing the ink jet head according to the first embodiment of the invention.

FIG. 10 is a plan view illustrating the relationship between a substrate for film formation and a substrate for pressure chamber member in the first embodiment of the invention.

FIG. 11 is a cross-sectional view illustrating a modified example of main parts of the ink jet head according to the first embodiment of the invention.

FIGS. 12A and 12B are cross-sectional views illustrating procedures (laminating process and pressure chamber forming process) for manufacturing a pressure chamber member and an actuator part in the modified example of the first embodiment of the invention.

FIG. 13 is a cross-sectional view schematically illustrating the basic structure of an example of a known piezoelectric thin film element.

FIG. 14 is a cross-sectional view schematically illustrating the basic structure of an example of a known piezoelectric thin film element.

FIG. 15 is a cross-sectional view schematically illustrating an example of a piezoelectric thin film element according to a second embodiment of the invention.

FIG. 16 is a cross-sectional view schematically illustrating a modified example of a piezoelectric thin film element according to the second embodiment of the invention

FIGS. 17A to 17D are process views schematically illustrating an example of a method of manufacturing the piezoelectric thin film element according to the second embodiment of the invention

FIGS. 18A to 18F are process views schematically illustrating another example of a method of manufacturing the piezoelectric thin film element according to the second embodiment of the invention.

FIG. 19 is a cross-sectional view schematically illustrating the configuration of an actuator part in the ink jet head according to the second embodiment of the invention.

FIGS. 20A to 20C are process views schematically illustrating a part of processes in an example of a method of manufacturing the ink jet head configured to include a pressure chamber member, an actuator part, an ink passage member, and a nozzle plate in the second embodiment of the invention.

FIGS. 21A and 21B are process views schematically illustrating another part of processes in the example of the method of manufacturing the ink jet head configured to include a pressure chamber member, an actuator part, an ink passage member, and a nozzle plate in the second embodiment of the invention.

FIGS. 22A and 22B are process views schematically illustrating still another part of processes in the example of a method of manufacturing the ink jet head configured to include a pressure chamber member, an actuator part, an ink passage member, and a nozzle plate in the second embodiment of the invention.

FIGS. 23A and 23B are process views schematically illustrating still another part of processes in the example of a method of manufacturing the ink jet head configured to include a pressure chamber member, an actuator part, an ink passage member, and a nozzle plate in the second embodiment of the invention.

FIGS. 24A to 24D are process views schematically illustrating still another part of processes in the example of a method of manufacturing the ink jet head configured to include a pressure chamber member, an actuator part, an ink passage member, and a nozzle plate in the second embodiment of the invention.

FIG. 25 is a cross-sectional view schematically illustrating main parts of a modified example of the ink jet head according to the second embodiment of the invention.

FIGS. 26A and 26B are process views schematically illustrating an example of a process for manufacturing a modified example of the ink jet head according to the second embodiment of the invention.

FIG. 27 is a cross-sectional view illustrating the configuration of a piezoelectric thin film element according to a third embodiment of the invention.

FIG. 28 is a cross-sectional view illustrating the configuration of a piezoelectric thin film element according to the third embodiment of the invention.

FIG. 29 is a cross-sectional view illustrating the configuration of the piezoelectric thin film element according to the third embodiment of the invention.

FIG. 30 is a cross-sectional view illustrating main parts of an ink jet head substrate in the direction perpendicular to an ink supply direction (arrow X) in the third embodiment of the invention.

FIG. 31 is a cross-sectional view illustrating a laminating process of the ink jet head substrate according to the third embodiment of the invention.

FIG. 32 is a cross-sectional view illustrating a process of forming a pressure chamber opening of the ink jet head substrate according to the third embodiment of the invention.

FIG. 33 is a cross-sectional view illustrating an adhesive bonding process in the ink jet head substrate according to the third embodiment of the invention.

FIG. 34 is a cross-sectional view illustrating a process of bonding a substrate after film formation and a pressure chamber member to each other in the ink jet head substrate according to the third embodiment of the invention.

FIG. 35 is a cross-sectional view illustrating a process of forming a longitudinal wall in the ink jet head substrate according to the third embodiment of the invention.

FIG. 36 is a cross-sectional view illustrating a process of removing a substrate (for film formation) and an adhesive layer in the ink jet head substrate according to the third embodiment of the invention.

FIG. 37 is a cross-sectional view illustrating a process of separating a first electrode layer into individual parts in the ink jet head substrate according to the third embodiment of the invention.

FIG. 38 is a cross-sectional view illustrating a process of separating a piezoelectric layer into individual parts in the ink jet head substrate according to the third embodiment of the invention.

FIG. 39 is a cross-sectional view illustrating a process of cutting a substrate (for pressure chamber member) in the ink jet head substrate according to the third embodiment of the invention.

FIG. 40 is a cross-sectional view illustrating a process of generating an ink passage member and a nozzle plate in the ink jet head substrate according to the third embodiment of the invention

FIG. 41 is a cross-sectional view illustrating a process of bonding the ink passage member and the nozzle plate to each other in the ink jet head substrate according to the third embodiment of the invention.

FIG. 42 is a cross-sectional view illustrating a process of bonding the pressure chamber member and the ink passage member to each other in the ink jet head substrate according to the third embodiment of the invention.

FIG. 43 is a cross-sectional view illustrating a state in which the ink jet head substrate according to the third embodiment of the invention is completed.

FIG. 44 is a perspective view schematically illustrating the configuration of an ink jet type recording apparatus according to a fourth embodiment of the invention.

### DETAILED DESCRIPTION

Hereinafter, a piezoelectric thin film element, an ink jet head, and an ink jet type recording apparatus according to preferred embodiments of the invention will be described in detail with reference to the accompanying drawings.

### First Embodiment

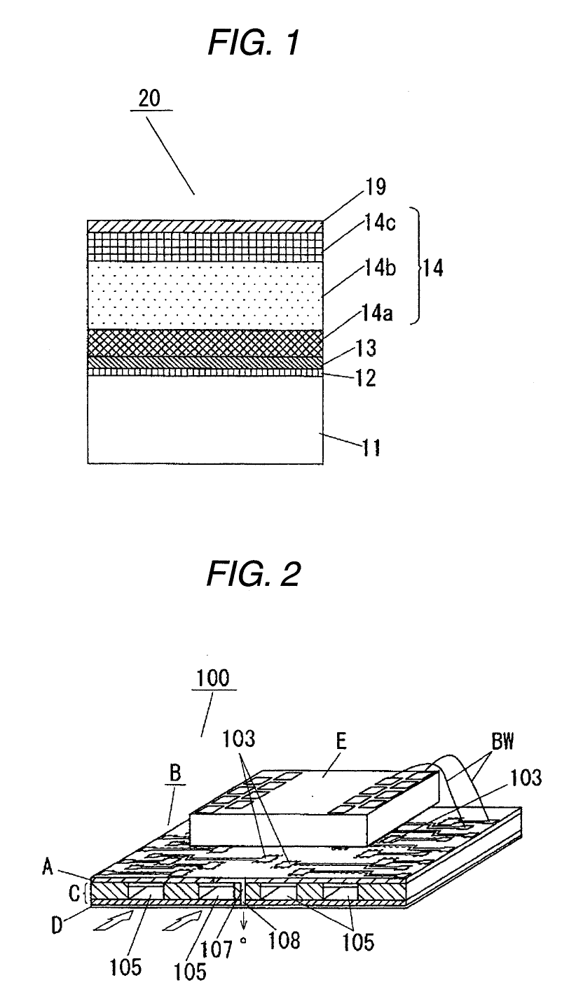

FIG. 1 is a cross-sectional view illustrating the configuration of a piezoelectric thin film element 20 according to a first embodiment of the invention.

As shown in FIG. 1, the piezoelectric thin film element 20 includes an adhesive layer 12, a first electrode layer 13 serving as a lower electrode, a piezoelectric layer 14 that is a piezoelectric thin film formed by using an oxide which has a perovskite type crystal structure and contains Pb, and a second electrode layer 19 serving as an upper electrode, which are formed in this order on a substrate 11. The piezoelectric layer 14 is configured to include three layers of a first piezoelectric layer 14a, a second piezoelectric layer 14b, and a third piezoelectric layer 14c. In addition, the composition of ‘oxide that has a perovskite type crystal structure and contains Pb’, which is a piezoelectric material used for each of the piezoelectric layers 14a, 14b, and 14c, is selected such that a piezoelectric constant of each of the first piezoelectric layer 14a and the third piezoelectric layer 14c is smaller than that of the second piezoelectric layer 14b located in the middle.

That is, the piezoelectric thin film element 20 according to the first embodiment includes a piezoelectric body (piezoelectric layer 14) and a pair of electrodes (first electrode layer 13 and second electrode layer 19) provided on both sides of the piezoelectric body in the thickness direction of the piezoelectric body. In addition, in the piezoelectric thin film element 20 according to the first embodiment, the piezoelectric body is configured to include three or more piezoelectric layers (first piezoelectric layer 14a, second piezoelectric layer 14b, and third piezoelectric layer 14c), and a piezoelectric constant of a piezoelectric layer (first piezoelectric layer 14a or third piezoelectric layer 14c) that is in contact with an electrode (first electrode layer 13 or second electrode layer 19) is set to be smaller than that of a piezoelectric layer (second piezoelectric layer 14b) that is not in contact with the electrode (first electrode layer 13 or second electrode layer 19).

In the piezoelectric thin film element 20, a piezoelectric material used to form the piezoelectric layer 14 deforms significantly due to application of a voltage but a material used to form an electrode layer (first electrode layer 13 and second electrode layer 19) does not deform. Accordingly, a stress is generated at an interface between the piezoelectric layer 14 and the electrode layer. The internal stress generated at the interface between the piezoelectric layer 14 and the electrode layer is considerably large in the case of applying a high voltage to the piezoelectric thin film element 20 or applying a voltage to an actuator and driving the actuator for a long time. For this reason, it is considered that a crack occurs in the piezoelectric layer 14 made of a ceramic material, which is more easily broken than a metallic material used for the electrode layer.

Therefore, in the first embodiment, as shown in FIG. 1, the piezoelectric layer 14 has a three-layered structure, and piezoelectric constants of piezoelectric layers (first piezoelectric layer 14a and third piezoelectric layer 14c) facing both electrode layers are set to be smaller than a piezoelectric constant of the second piezoelectric layer 14b located in the middle such that deformation of the piezoelectric layers (first piezoelectric layer 14a and third piezoelectric layer 14c) facing both electrode layers is smaller than that of the second piezoelectric layer 14b located in the middle of the piezoelectric layer 14.

Thus, it is possible to reduce an internal stress generated at an interface between the first piezoelectric layer 14a and the first electrode layer 13 and an internal stress generated at an interface between the third piezoelectric layer 14c and the second electrode layer 19. Accordingly, it is expected that occurrence of a crack due to application of a high voltage or driving over a long period of time will be greatly reduced.

As the ‘oxide that has a perovskite type crystal structure and contains Pb’ that is a piezoelectric material, a lead zirconate titanate (PZT), a material obtained by adding an additive, such as La, Sr, Nb, and Al, in PZT and the like may be used. That is, a piezoelectric material containing PZT as a main component is used, and it does not matter whether or not the piezoelectric material is PMN or PZN. Hereinafter, the three layers (first piezoelectric layer 14a, second piezoelectric layer 14b, and third piezoelectric layer 14c) that form the piezoelectric layer 14 will be described in detail.

In addition, for the purpose of simple expression in the following description, the first piezoelectric layer 14a and the third piezoelectric layer 14c are described as ‘piezoelectric layers 14a and 14c when the first piezoelectric layer 14a and the third piezoelectric layer 14c are collectively indicated. Moreover, when the three piezoelectric layers that form the piezoelectric layer 14 are collectively indicated, the first piezoelectric layer 14a, the second piezoelectric layer 14b, and the third piezoelectric layer 14c are described as ‘piezoelectric layers 14a, 14b, and 14c’.

The composition of a piezoelectric material will be explained later in experimental examples. As for a piezoelectric constant, a piezoelectric constant of each of the piezoelectric layers 14a and 14c is preferably equal to or smaller than ⅔ of that of the second piezoelectric layer 14b, and more preferably, equal to or smaller than ½ of that of the second piezoelectric layer 14b.

In the piezoelectric layers 14a, 14b, and 14c, satisfactory piezoelectric properties are obtained by performing film formation such that the piezoelectric layers 14a, 14b, and 14c are preferentially oriented on the same plane, that is, either a (111) plane or a (001) plane. As for an orientation rate in the (111) plane or the (001) plane, it is preferable that an orientation rate of the second piezoelectric layer 14b located in the middle be higher than that of each of the piezoelectric layers 14a and 14c facing both electrode layers. Furthermore, even though an orientation rate of each piezoelectric layer in the (111) plane or the (001) plane is preferably 90% or more, a predetermined property is obtained if the orientation rate of each piezoelectric layer in the (111) plane or the (001) is 90% or more.

Here, if an orientation rate in the (111) plane is expressed as α(111) and an orientation rate in the (001) plane is expressed as α(001), α(111) and α(001) are defined as follows. That is, α(111)=l(111)/ΣΣl(hkl) and α(001)=l(001)/Σl(hkl). Σl(hkl) indicates a total sum of peak intensities of diffraction from respective crystal planes in a PZT having a perovskite type crystal structure when 2θ is in a range of 10 to 70° C. in an X-ray diffraction method using Cu—Kα rays.

As for a relative permittivity, a relative permittivity of any of the piezoelectric layers 14a and 14c is set to be smaller than that of the second piezoelectric layer 14b. Specifically, the relative permittivity of each of the piezoelectric layers 14a and 14c is preferably equal to or smaller than ⅔ of that of the second piezoelectric layer 14b, and more preferably, equal to or smaller than ½ of that of the second piezoelectric layer 14b.

Further, as for a thickness, the thickness of any of the piezoelectric layers 14a and 14c is set to be smaller than that of the second piezoelectric layer 14b. Specifically, the thickness of each of the piezoelectric layers 14a and 14c is preferably 1/200 to ¼ of that of the second piezoelectric layer 14b, and more preferably, 1/100 to 1/10 of that of the second piezoelectric layer 14b. Furthermore, the thickness of the second piezoelectric layer 14b is in a range of 1 to 10 μm.

Next, components arrange around the piezoelectric layer 14 will be described with reference to FIG. 1.

The substrate 11 is a silicon substrate, a glass substrate, a metallic substrate, or a ceramic substrate, for example. The adhesive layer 12 is provided to improve adhesion between the substrate 11 and the first electrode layer 13.

In the first embodiment, a case in which the adhesive layer 12 is provided is described to show a normal condition. However, if there is no problem in adhesion between the substrate 11 and the first electrode layer 13, the adhesive layer 12 may not be necessarily provided. It is preferable that the thickness of the adhesive layer 12 be in a range of 0.005 to 1 μm. In the first embodiment, titanium (Ti) is used as a material of the adhesive layer 12. However, tantalum, iron, cobalt, nickel, chromium, or a compound thereof may also be used as a material of the adhesive layer 12.

Platinum (Pt) is usually used as a material of the first electrode layer 13. However, at least one precious metal selected from a group of Pt, iridium, palladium, and ruthenium or a compound thereof may also be used as a material of the first electrode layer 13. In addition, the thickness of the first electrode layer 13 is preferably in a range of 0.05 to 2 μm. In addition, even though platinum (Pt) is usually used as a material of the last second electrode layer 19, an arbitrary conductive material may be used. The thickness of the second electrode layer 19 is preferably in a range of 0.1 to 0.4 μm.

Advantages of the first embodiment will be apparent through experimental examples, which will be described below. In addition, although a film formation method for a piezoelectric thin film element includes various kinds of methods, such as a sputtering method, a vacuum deposition method, a laser abrasion method, an ion plating method, an MBE method, a PVD method, a MOCVD method, a plasma CVD method, a sol-gel method, and an MOD method, the sputtering method is used herein.

### First Experimental Example in the First Embodiment

The substrate 11 is a disc-shaped silicon wafer substrate having a thickness of 0.3 mm and a diameter of 4 inches. A piezoelectric thin film element was manufactured by forming the adhesive layer 12 with a thickness of 0.02 μm, the first electrode layer 13 with a thickness of 0.22 μm, the three-layered piezoelectric layer 14 with a thickness of 3.0 μm, and the second electrode layer with a thickness of 0.02 μm in this order on an upper surface of the disc-shaped silicon substrate 11 using the sputtering method.

Using, for example, a titanium (Ti) target, the adhesive layer 12 was formed to have a thickness of 0.02 μm by applying high-frequency power of 100 W for one minute while heating the substrate 11 at 400° C. in argon gas with a degree of vacuum of 1 Pa. Using, for example, a platinum (Pt) target, the first electrode layer 13 was formed to have a thickness of 0.22 μm by applying high-frequency power of 100 W for 12 minutes while heating the substrate 11 at 400° C. in the argon gas with a degree of vacuum of 1 Pa. Using, for example, a platinum (Pt) target, the second electrode layer 19 was formed to have a thickness of 0.02 μm by applying high-frequency power of 200 W for 10 minutes while keeping the substrate 11 at the room temperature in the argon gas with a degree of vacuum of 1 Pa.

Further, the piezoelectric layer 14 was manufactured using a multi-sputtering apparatus. As for the Zr/Ti composition of the PZT having the rhombohedral-system or tetragonal-system perovskite type crystal structure, Zr/Ti=30/70 to 70/30 is desirable in the second piezoelectric layer 14b. Furthermore, assuming that the composition (Zr/Ti=53/47) near a boundary (morphotropic phase boundary) between the tetragonal system and the rhombohedral system is adopted as the Zr/Ti composition in the second piezoelectric layer 14b, the composition of the first piezoelectric layer 14a and the third piezoelectric layer 14c is set to Zr/Ti=65/35.

In addition, as for a target, a PZT sintered compact target having composition of Zr/Ti=62/38 was used to form the first piezoelectric layer 14a and the third piezoelectric layer 14c and a PZT sintered compact target having composition of Zr/Ti=53/47 was used to form the second piezoelectric layer 14b, and the first piezoelectric layer 14a, and the second piezoelectric layer 14b, and the third piezoelectric layer 14c were formed in the following procedures.

That is, the first piezoelectric layer 14a was formed by applying high-frequency power of 250 W for twenty minutes while heating the substrate 11 at 620° C. in an atmosphere (gas volume ratio of Ar:O₂=15:5), in which argon and oxygen are mixed and a degree of vacuum is 0.3 Pa. The second piezoelectric layer 14b was formed on the first piezoelectric layer 14a by applying high-frequency power of 200 W for two hundred minutes while heating the substrate 11 at 580° C. in an atmosphere (gas volume ratio of Ar:O₂=15:5), in which argon and oxygen are mixed and a degree of vacuum is 0.3 Pa. Then, the third piezoelectric layer 14c was formed on the second piezoelectric layer 14b by applying high-frequency power of 250 W for twenty minutes while heating the substrate 11 at 620° C. in an atmosphere (gas volume ratio of Ar:O₂=15:5), in which argon and oxygen are mixed and a degree of vacuum is 0.3 Pa.

Thereafter, various kinds of observation on the piezoelectric layer 14 in the piezoelectric thin film element manufactured under the above film forming conditions were performed. First, as a result of observation using an SEM (scanning electron microscope), the piezoelectric layer 14 had a columnar structure. The thickness of each of the first piezoelectric layer 14a and the third piezoelectric layer 14c was 0.2 μm and the thickness of the second piezoelectric layer 14b was 2.2 μm.

Further, the crystal structure and crystal orientation were tested using X-ray diffraction. As a result, the piezoelectric layer 14 had a rhombohedral-system perovskite type crystal structure and had (111) orientation. Then, X-ray diffraction was performed on each of the first piezoelectric layer 14a, the second piezoelectric layer 14b, and the third piezoelectric layer 14c that were formed, and a (111) orientation rate in each piezoelectric layer was checked. As a result, the (111) orientation rate in the first piezoelectric layer 14a was 90%, the (111) orientation rate in the second piezoelectric layer 14b was 99%, and the (111) orientation rate in the third piezoelectric layer 14c was 92%.

Then, 100 cantilevers cut to have a size of 15 mm×2 mm by dicing were manufactured before forming the second electrode layer 19, the second electrode layer 19 was formed to have a thickness of 0.2 μm using the sputtering method, and then a piezoelectric constant was measured. In addition, a measuring method is basically the same as that disclosed in Patent Document 4. As a result, an average of piezoelectric constants of the cantilevers was 160 pC/N, and a variation σ thereof was 3.8%.

Then, under the film forming conditions described above, a sample 1A in which only the first piezoelectric layer 14a was formed on the first electrode layer 13, a sample 1B in which the first piezoelectric layer 14a and the second piezoelectric layer 14b were formed on the first electrode layer 13, and a sample 1C in which the first piezoelectric layer 14a, the second piezoelectric layer 14b, and the third piezoelectric layer 14c were formed on the first electrode layer 13 were manufactured, and piezoelectric constants of the samples 1A, 1B, and 1C were measured in the same manner. Then, the obtained piezoelectric constants of the three samples 1A, 1B, and 1C were converted to calculate piezoelectric constants of the first piezoelectric layer 14a, the second piezoelectric layer 14b, and the third piezoelectric layer 14c. As a result, the piezoelectric constants of the first piezoelectric layer 14a, the second piezoelectric layer 14b, and the third piezoelectric layer 14c were 88 pC/N, 160 pC/N, and 96 pC/N, respectively. Moreover, the relative permittivities of the first piezoelectric layer 14a, the second piezoelectric layer 14b, and the third piezoelectric layer 14c were obtained using the same method as described above. As a result, the relative permittivities of first piezoelectric layer 14a, the second piezoelectric layer 14b, and the third piezoelectric layer 14c were 580, 850, and 560, respectively.

Then, in a state in which a sine-wave voltage having a peak value of 40 V and a frequency of 200 Hz is continuously applied to the cantilevers, the change of piezoelectric constants of thirty samples was tested. As a result, in the three-layered piezoelectric layer 14, a decrease in piezoelectric constant was not observed even if a voltage was continuously applied to all of the thirty measured samples for 1000 hours.

After measuring the piezoelectric constant, a voltage of DC 50 V was applied to all of the thirty samples and a leakage current was measured. As a result, in the three-layered piezoelectric layer 14, the leakage current was 5×10⁻⁷ (A/cm²) or less, which was the same value as that before measurement. In addition, an upper electrode was formed at 100 places on a 4-inch Si wafer and a withstand voltage of the three-layered piezoelectric layer 14 was tested. As a result, an average of the withstand voltages was 125 V and a variation σ thereof was 3.1%.

### First Comparative Example in the First Embodiment

A first comparative example is a comparative example for comparison with the first experimental example. In the first comparative example, the piezoelectric layer 14 was formed not to have a three-layered structure but to have a single-layered structure including only the second piezoelectric layer 14b located in the middle, and other film forming conditions were the same as those in the first experimental example.

The thickness of the single-layered piezoelectric layer 14 was 2.6 μm, and the single-layered piezoelectric layer 14 was preferentially oriented on a (111) plane. Then, 100 cantilevers cut to have a size of 15 mm×2 mm by dicing were manufactured before forming the second electrode layer 19, the second electrode layer 19 was formed to have a thickness of 0.2 μm using the sputtering method, and then the piezoelectric constant thereof was measured. As a result, an average of piezoelectric constants of the cantilevers was 168 pC/N, and a variation σ thereof was 2.9%. In addition, a relative permittivity thereof was 870.

Then, in a state in which a sine-wave voltage having a peak value of 40 V and a frequency of 200 Hz is continuously applied to the cantilevers, the change of piezoelectric constants of thirty samples was tested. As a result, in the single-layered piezoelectric layer 14, a decrease in piezoelectric constant was observed if a voltage was continuously applied to all of the thirty measured samples for 1000 hours.

After measuring the piezoelectric constant, a voltage of DC 50 V was applied to all of the thirty samples and a leakage current was measured. As a result, in the single-layered piezoelectric layer 14, the leakage current was 1×10⁻⁴ (A/cm²) or more, that is, it was clear that a leakage current was generated. In addition, an upper electrode was formed at 100 places on a 4-inch Si wafer and a withstand voltage of the single-layered piezoelectric layer 14 was tested. As a result, an average of the withstand voltages was 75 V and a variation σ thereof was 7.6%.

Comparing the first experimental example with the first comparative example, the first experimental example is equal to the first comparative example in a point of preferential orientation on the (111) plane. However, the first experimental example in which the piezoelectric constant of the piezoelectric layer 14 facing upper and lower electrode layers was set to be smaller than that of the piezoelectric layer 14 located in the middle showed an improved insulation performance, that is, outstanding reliability as compared with the first comparative example in which the piezoelectric layer 14 had the single-layered structure.

### Second Experimental Example in the First Embodiment

In a second experimental example, a three-layered piezoelectric layer 14 that is the same as in the first experimental example is manufactured using an MgO single crystal substrate as a substrate 11. That is, a piezoelectric thin film element was manufactured by forming an adhesive layer 12 with a thickness of 0.02 μm, a first electrode layer 13 with a thickness of 0.22 μm, a three-layered piezoelectric layer 14 with a thickness of 3.0 μm, and a second electrode layer with a thickness of 0.02 μm on the MgO single crystal substrate 11 using the sputtering method.

Using, for example, a titanium (Ti) target, the adhesive layer 12 was formed by applying high-frequency power of 100 W for one minute while heating the substrate 11 at 400° C. in argon gas with a degree of vacuum of 1 Pa. Using a Pt target, the first electrode layer 13 was formed by applying high-frequency power of 180 W for 12 minutes while heating the substrate 11 at 600° C. in argon gas with a degree of vacuum of 1 Pa. Using a Pt target, the second electrode layer 19 was formed by applying high-frequency power of 200 W for 10 minutes while keeping the substrate 11 at the room temperature in argon gas with a degree of vacuum of 1 Pa.

Further, the piezoelectric layer 14 was manufactured using a multi-sputtering apparatus. In addition, as for a target, a PLZT (La/Zr/Ti=5/50/50) sintered compact target was used to form the first piezoelectric layer 14a and the third piezoelectric layer 14c and a PZT (Zr/Ti=53/47) sintered compact target was used to form the second piezoelectric layer 14b, and the first piezoelectric layer 14a, and the second piezoelectric layer 14b, and the third piezoelectric layer 14c were formed in the following procedures.

That is, the first piezoelectric layer 14a was formed by applying high-frequency power of 250 W for fifteen minutes while heating the substrate 11 at 600° C. in an atmosphere (gas volume ratio of Ar:O₂=19.7:0.3), in which argon and oxygen are mixed and a degree of vacuum is 0.3 Pa. The second piezoelectric layer 14b was formed on the first piezoelectric layer 14a by applying high-frequency power of 200 W for 180 minutes while heating the substrate 11 at 600° C. in an atmosphere (gas volume ratio of Ar:O₂=19:1), in which argon and oxygen are mixed and a degree of vacuum is 0.3 Pa. Then, the third piezoelectric layer 14c was formed on the second piezoelectric layer 14b by applying high-frequency power of 250 W for fifteen minutes while heating the substrate 11 at 600° C. in an atmosphere (gas volume ratio of Ar:O₂=19.5:0.5), in which argon and oxygen are mixed and a degree of vacuum is 0.3 Pa.

Thereafter, various kinds of observation on the piezoelectric layer 14 in the piezoelectric thin film element manufactured as described above were performed. First, as a result of observation using an SEM (scanning electron microscope), the piezoelectric layer 14 had a columnar structure. The is thickness of each of the first piezoelectric layer 14a and the third piezoelectric layer 14c was 0.1 μm and the thickness of the second piezoelectric layer 14b was 2.4 μm.

Furthermore, the crystal structure and crystal orientation were tested using the X-ray diffraction, the piezoelectric layer 14 had a rhombohedral-system perovskite type crystal structure and had (001) orientation. Then, X-ray diffraction was performed on each of the first piezoelectric layer 14a, the second piezoelectric layer 14b, and the third piezoelectric layer 14c that were formed, and a (001) orientation rate in each piezoelectric layer was checked. As a result, the (001) orientation rate in the first piezoelectric layer 14a was 95%, the (001) orientation rate in the second piezoelectric layer 14b was 99%, and the (001) orientation rate in the third piezoelectric layer 14c was 94%.

Then, 100 cantilevers cut to have a size of 15 mm×2 mm by dicing were manufactured before forming the second electrode layer 19, the second electrode layer 19 was formed to have a thickness of 0.2 μm using the sputtering method, and then the piezoelectric constant thereof was measured. In addition, a measuring method is basically the same as that disclosed in Patent Document 4. As a result, an average of piezoelectric constants of the cantilevers was 134 pC/N, and a variation σ thereof was 3.2%.

Then, under the film forming conditions described above, a sample 1A in which only the first piezoelectric layer 14a was formed on the first electrode layer 13, a sample 1B in which the first piezoelectric layer 14a and the second piezoelectric layer 14b were formed on the first electrode layer 13, and a sample 1C in which the first piezoelectric layer 14a, the second piezoelectric layer 14b, and the third piezoelectric layer 14c were formed on the first electrode layer 13 were manufactured, and piezoelectric constants of the samples 1A, 1B, and 1C were measured in the same manner. Then, the obtained piezoelectric constants of the three samples 1A, 1B, and 1C were converted to calculate piezoelectric constants of the first piezoelectric layer 14a, the second piezoelectric layer 14b, and the third piezoelectric layer 14c. As a result, the piezoelectric constants of the first piezoelectric layer 14a, the second piezoelectric layer 14b, and the third piezoelectric layer 14c were 45 pC/N, 142 pC/N, and 38 pC/N, respectively.

Moreover, the relative permittivities of the first piezoelectric layer 14a, the second piezoelectric layer 14b, and the third piezoelectric layer 14c were obtained using the same method as described above. As a result, the relative permittivities of first piezoelectric layer 14a, the second piezoelectric layer 14b, and the third piezoelectric layer 14c were 280, 430, and 250, respectively.

Then, in a state in which a sine-wave voltage having a peak value of 50 V and a frequency of 200 Hz is continuously applied to the cantilevers, the change of piezoelectric constants of thirty samples was tested. As a result, in the three-layered piezoelectric layer 14, a decrease in piezoelectric constant was not observed even if a voltage was continuously applied to all of the thirty measured samples for 1000 hours.

After measuring the piezoelectric constant, a voltage of DC 50 V was applied to all of the thirty samples and a leakage current was measured. As a result, in the three-layered piezoelectric layer 14, the leakage current was 5×10⁻⁷ (A/cm²) or less, which was the same value as that before measurement. In addition, an upper electrode was formed at 100 places on a 4-inch Si wafer and a withstand voltage of the three-layered piezoelectric layer 14 was tested. As a result, an average of the withstand voltages was 170 V and a variation σ thereof was 1.8%.

### Second Comparative Example in the First Embodiment

A second comparative example is a comparative example for comparison with the second experimental example. In the second comparative example, the piezoelectric layer 14 was formed not to have a three-layered structure but to have a single-layered structure including only the second piezoelectric layer 14b located in the middle, and other film forming conditions were the same as those in the second experimental example.

The thickness of the single-layered piezoelectric layer 14 was 2.6 μm, and the single-layered piezoelectric layer 14 was preferentially oriented on a (001) plane. Then, 100 cantilevers cut to have a size of 15 mm×2 mm by dicing were manufactured before forming the second electrode layer 19, the second electrode layer 15 was formed to have a thickness of 0.2 μm using the sputtering method, and then the piezoelectric constant thereof was measured. As a result, an average of piezoelectric constants of the cantilevers was 148 pC/N, and a variation σ thereof was 2.9%. In addition, a relative permittivity thereof was 450.

Then, in a state in which a sine-wave voltage having a peak value of 50 V and a frequency of 200 Hz is continuously applied to the cantilevers, the change of piezoelectric constants of thirty samples was tested. As a result, in the single-layered piezoelectric layer 14, a decrease in piezoelectric constant was observed if a voltage was continuously applied to all of the thirty measured samples for 1000 hours.

After measuring the piezoelectric constant, a voltage of DC 50 V was applied to all of the thirty samples and a leakage current was measured. As a result, in the single-layered piezoelectric layer 14, the leakage current was 1×10⁻⁴ (A/cm²) or more, that is, it was clear that a leakage current was generated. In addition, an upper electrode was formed at 100 places on a 4-inch Si wafer and a withstand voltage of the single-layered piezoelectric layer 14 was tested. As a result, an average of the withstand voltages was 95 V and a variation σ thereof was 4.6%.

Comparing the second experimental example with the second comparative example, the second experimental example is equal to the second comparative example in a point of preferential orientation on the (001) plane. However, the second experimental example in which the piezoelectric constant of the piezoelectric layer facing upper and lower electrode layers was set to be smaller than that of the piezoelectric layer 14 located in the middle showed an improved insulation performance, that is, outstanding reliability as compared with the second comparative example in which the piezoelectric layer had the single-layered structure.

Hereinafter, an example of the configuration of an ink jet head that uses the piezoelectric thin film element according to the first embodiment as a vibrator serving as a driving source for ink discharge is shown.

Specifically, the ink jet head includes a vibrating plate layer, which is provided on an electrode-layer-side surface of the piezoelectric thin film element described above, and a pressure chamber member, which is in contact with the other surface of the vibrating plate layer not facing the piezoelectric thin film element. The ink jet head is configured to discharge ink in the pressure chamber by displacing the vibrating plate layer in the thickness direction of the piezoelectric thin film element by means of a piezoelectric effect of the piezoelectric thin film element.

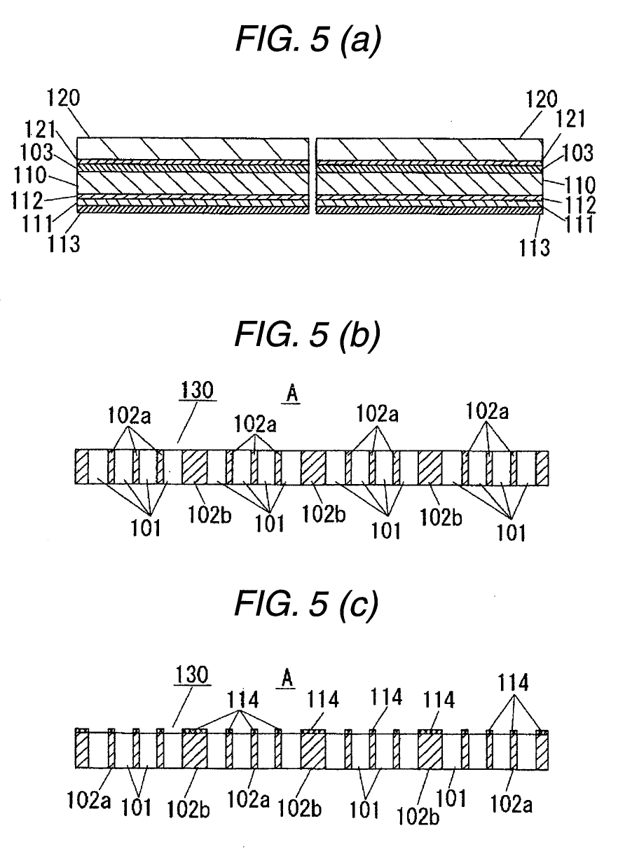

Hereinafter, examples (FIGS. 2 to 4) of the specific configuration and manufacturing procedures (FIGS. 5 to 10) will be described.

FIG. 2 is a view illustrating an external appearance of the entire configuration of an ink jet head according to the first embodiment of the invention.

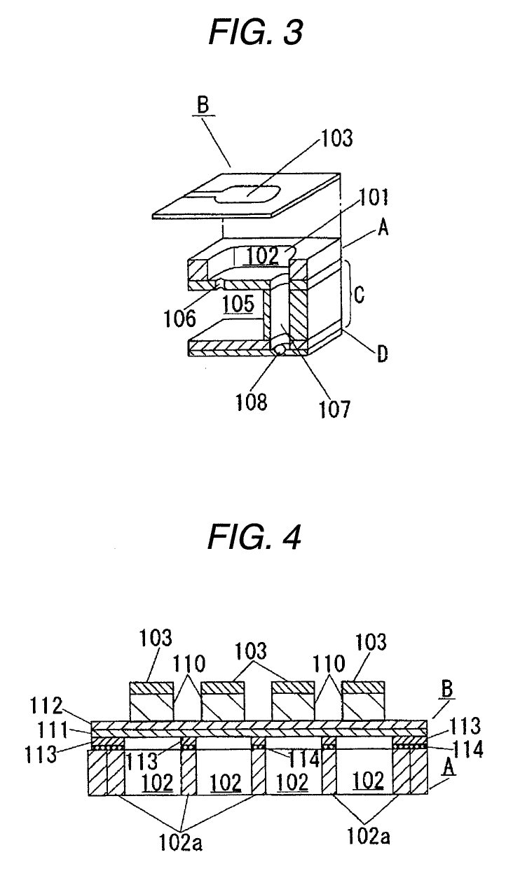

FIG. 3 is a perspective view illustrating the configuration of main parts of the ink jet head according to the first embodiment of the invention.

As shown in FIGS. 2 and 3, an ink jet head 100 includes a pressure chamber member A, an actuator part B, an ink passage member C, and a nozzle plate D as main components.

Referring to FIGS. 2 and 3, a plurality of pressure chamber openings 101 are formed in a zigzag manner in the pressure chamber member A, each of the opening 101 penetrating the pressure chamber member A in the thickness direction (up and down directions) thereof. Upper and lower ends of the plurality of pressure chamber openings 101 are blocked by the actuator part B, which is disposed to cover the upper ends in common, and the ink passage member C, which is disposed to cover the lower ends in common, and thus each of the openings 101 for pressure chamber serves as an individual pressure chamber 102.

The ink passage member C includes a common fluid chamber 105 shared between the pressure chambers 102 provided in a line in the ink supply direction, a supply port 106 for supplying ink in the common fluid chamber 105 to the pressure chambers 102, and an ink passage 107 used to discharge ink in the pressure chambers 102. The nozzle plate D is formed with a nozzle hole 108 communicating with the ink passage 107. In addition, a voltage is supplied from an IC chip E to an individual electrode 103 through a bonding wire BW.

Next, FIG. 4 is a cross-sectional view illustrating the configuration of an actuator part which is a main part of the ink jet head ink according to the first embodiment of the invention.

In FIG. 4, the cross-sectional configuration is shown in the direction perpendicular to the ink supply direction shown in FIG. 2. In addition, in FIG. 4, the pressure chamber member A including the four pressure chambers 102 provided in a line in the perpendicular direction is drawn for reference. The four pressure chambers 102 are separated from each other by means of partition walls 102a.

As shown in FIG. 4, the actuator part B is a member that forms a ceiling surface common to the pressure chambers 102. The actuator part B includes an intermediate layer (that is formed flush with a side wall surface of the partition wall 102a) 113 that is bonded to an upper end surface of the partition wall 102a with an adhesive 114, a vibrating plate layer 111 laminated on the intermediate layer 113, and a second electrode layer 112 that is a common electrode laminated on the vibrating plate layer 111.

Furthermore, the actuator part B includes, as a driving unit for each pressure chamber 102, a piezoelectric layer 110, which is provided on an upper surface of the second electrode layer 112 so as to be positioned directly above each pressure chamber 102, and a first electrode layer 103 that is an individual electrode laminated on the piezoelectric layer 110.

That is, the actuator part B includes a piezoelectric thin film element having a configuration in which the second electrode layer 112, the piezoelectric layer 110, and the first electrode layer 103 are laminated in this order for each pressure chamber 102. In addition, the vibrating plate layer 111 is provided at a side of the second electrode layer 112 which is a common electrode. A material used to form each of the first electrode layer 103, the piezoelectric layer 110, and the second electrode layer 112 is the same as that of each of the first electrode layer 13, the piezoelectric layer 14, and the second electrode layer 19, which was already explained. In this case, the content of elements included in the material may be different. In addition, the structure of the piezoelectric layer 110 is also the same as that of the piezoelectric layer 14 and has a three-layered structure.

According to the configuration, in the actuator part B, the vibrating plate layer 111 is displaced due to a piezoelectric effect of the piezoelectric layer 110 with respect to one pressure chamber 102 and vibrates. Accordingly, the volume of the pressure chamber 102 can be changed.

In addition, the pressure chamber member A and the actuator part B are bonded to each other by the adhesive 114. When bonding the pressure chamber member A and the actuator part B to each other using the adhesive 114, each intermediate layer 113 serves to secure a distance between an upper surface of the pressure chamber 102, which is an upper end surface of the partition wall 102a, and a lower surface of the vibrating plate layer 111 such that the adhesive 114 is not attached to the vibrating plate layer 111 and the vibrating plate layer 111 performs desired displacement and vibration, even if a part of the adhesive 114 overflows into the outside of the partition wall 102a. For this reason, a configuration in which the vibrating plate layer 111 is supported directly on an upper end surface of the partition wall 102a may be adopted without providing the intermediate layer 113.

Next, a method of manufacturing the ink jet head configured to include the main parts (excluding the IC chip E) shown in FIG. 2, that is, the pressure chamber member A, the actuator part B, the ink passage member C, and the nozzle plate D shown in FIG. 5 will be described with reference to FIGS. 5 to 9.

FIGS. 5A to 5C are cross-sectional views illustrating a laminating process, a process of forming a pressure chamber opening, and a process of attaching an adhesive in the first embodiment of the invention.

As shown in FIG. 5A, an adhesive layer 121, a first electrode layer 103, a piezoelectric layer 110, a second electrode layer 112, the vibrating plate layer 111, and the intermediate layer (eventually, serving as a longitudinal wall) 113 are laminated in this order on a substrate 120 using the sputtering method.

In addition, in the same manner as the adhesive layer 12 that was already described above, the adhesive layer 121 is provided between the substrate 120 and the first electrode layer 103 in order to improve adhesion between the substrate 120 and the first electrode layer 103. That is, the adhesive layer 121 is not indispensable.

The adhesive layer 121 is removed in the same manner as the substrate 120, which will be described later.

Here, the substrate 120 is a substrate for film formation, that is, a substrate used as a unit for manufacturing one piezoelectric thin film element. The substrate 120 is the same as the substrate 11 that was already described above, and may be a silicon (Si) substrate, a glass substrate, a metallic substrate, or a ceramic substrate. The substrate 120 may be formed in a disc shape with a proper thickness in the same manner as in the first experimental example. However, a rectangular Si substrate cut to have a thickness of 18 mm, for example, is herein used.

In addition, the adhesive layer 121, the first electrode layer 103, the piezoelectric layer 110, and the second electrode layer 112 are manufactured in the same method as in the first experimental example described above, and the piezoelectric layer 110 has a three-layered structure described in the first experimental example. Here, a material and a method of manufacturing the vibrating plate layer 111 and the intermediate layer 113, which are additional components, will be described.

That is, using any one of simple substances, such as Cr, nickel, aluminum, tantalum, tungsten, and silicon, an oxide thereof, and a nitride thereof (for example, silicon dioxide, aluminum oxide, zirconium oxide, or silicon nitride), for example, a Cr target, the vibrating plate layer 111 was formed to have a thickness of 3 μm by applying high-frequency power of 200 W for six hours while keeping the substrate 120 at the room temperature in the argon gas with a degree of vacuum of 1 Pa. It is preferable that the thickness of the adhesive layer 111 be in a range of 2 to 5 μm.

Further, using a conductive metal, such as Ti or Cr, for example, a Ti target, the intermediate layer 113 was formed to have a thickness of 5 μm by applying high-frequency power of 200 W for five hours while keeping the substrate 120 at the room temperature in the argon gas with a degree of vacuum of 1 Pa. It is preferable that the thickness of the intermediate layer 113 be in a range of 3 to 10 μm.

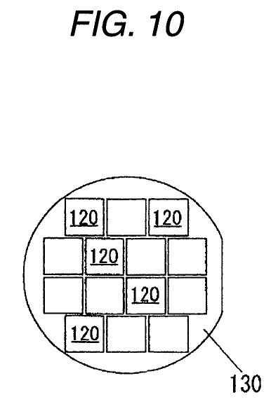

Then, as shown in FIGS. 5B, 5C, and 10, the pressure chamber member A is formed.

In addition, FIG. 10 is a plan view illustrating the relationship between a substrate for film formation (substrate 120) and a substrate for pressure chamber member (substrate 130).

As shown in FIG. 10, the substrate 130 used for the pressure chamber member A is a silicon wafer substrate which is so large that a required number of Si substrates 120 can be mounted thereon. Specifically, the substrate 130 is a disc-shaped substrate having a suitable diameter within a range of 2 inches to 10 inches (here, 4 inches).

The pressure chamber member A is formed using the substrate 130. Specifically, first, a plurality of pressure chamber openings 101 are patterned on the substrate 130. As shown in FIG. 5B, in the patterning, four pressure chamber openings 101 are set as a group, and the width of a partition wall 102b serving to separate a group from another group is set to about twice that of the partition wall 102a serving to separate the pressure chamber openings 101 within each group from each other.

Then, the patterned substrate 130 was processed using chemical etching or dry etching in order to form four pressure chamber openings 101 in each group, thereby obtaining the pressure chamber member A.

Thereafter, as shown in FIG. 5C, the pressure chamber member A and a substrate 130 are bonded to each other using an adhesive. Formation of the adhesive is based on electrodeposition. Referring to FIG. 5C, the adhesive 114 is first bonded to top surfaces of the partition walls 102a and 102b of pressure chambers by means of the electrodeposition, the top surfaces of the partition walls 102a and 102b serving as bonding surfaces of the pressure chamber member A. Specifically, although not shown, an Ni thin film having a thickness of hundreds of angstrom, which is so thin that light can be transmitted therethrough, is formed as a lower electrode layer on the top surfaces of the partition walls 102a and 102b using the sputtering method and then the patterned adhesive 114 is formed on the Ni thin film.

Here, as electrodeposition liquid, a solution obtained by adding 0 to 50 parts by weight of pure water in acrylic resin based water dispersion liquid and agitating and mixing them well is used. In addition, the reason why the thickness of the Ni thin film is set to be so thin that light can be transmitted therethrough is to make it easy to check whether or not the substrate 130 and a bonding resin are completely bonded to each other. According to the experiment, as preferable electrodeposition conditions, the temperature is about 25° C., a DC voltage is 30 V, and a power supply time is 60 seconds. Under these conditions, an acrylic resin having a thickness of about 3 to 10 μm is formed on the Ni thin film of the substrate 130 for pressure chamber by using an electrodeposition method.

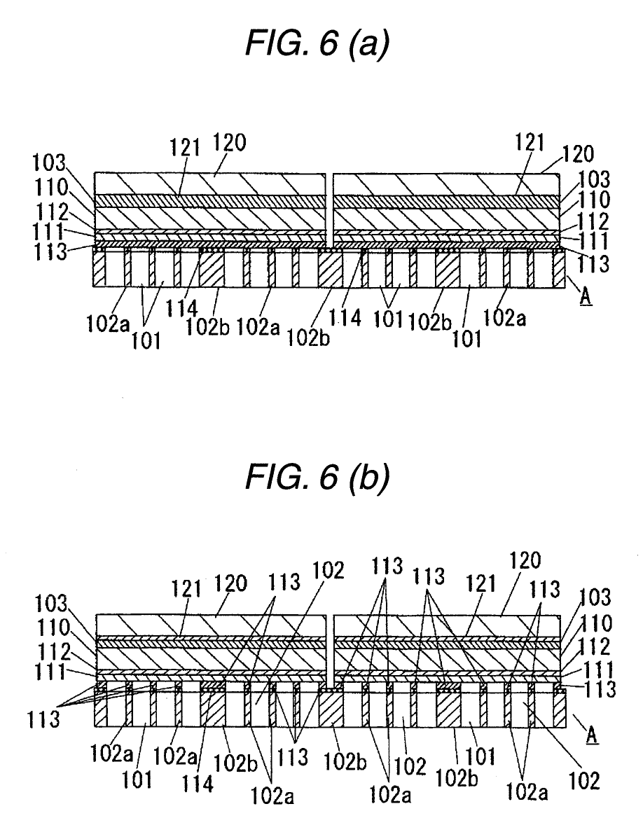

Next, FIGS. 6A and 6B are cross-sectional views illustrating procedures (a process of bonding a film forming substrate after film formation and a pressure chamber member to each other and a process of forming a longitudinal wall) for manufacturing the ink jet head according to the first embodiment of the invention.

As shown in FIG. 6A, a predetermined number of Si substrates 120 for film formation, each of which has a laminated structure described above are bonded with the pressure chamber member A (that is, the substrate 130) using the adhesive 114 electrodeposited as mentioned above.

This bonding is performed by using the intermediate layer 113, which is formed on the Si substrate 120, as a substrate-side bonding surface.

FIG. 10 shows such a state. In an example shown in FIG. 10, the substrate 120 has a rectangular shape of 18 mm square but a surface of the substrate 130 has a circular shape of 4-inch size, which is large. Accordingly, fourteen Si substrates 120 for film formation are bonded to one substrate 130 used for the pressure chamber member A.

This bonding is performed in a state in which the center of each Si substrate 120 is positioned at center of the partition wall 102b of the pressure chamber member A, as shown in FIG. 6A. After the bonding, the pressure chamber member A is pressed against the Si substrate 120 so as to be adhered to the Si substrate 120, such that the pressure chamber member A and the Si substrate 120 are bonded to each other with improved liquid tightness. Then, the pressure chamber member A and the Si substrate 120 that are bonded to each other are gradually heated in a heating furnace, such that the adhesive 114 is completely cured. Subsequently, as shown in FIG. 6B, a plasma treatment is performed to remove fractions protruding into the pressure chamber opening 101 from the adhesive 114. In addition, the intermediate layer 113 is etched by using the partition walls 102a and 102b of the pressure chamber member A as a mask and is then processed to have a predetermined shape such that the etched intermediate layer 113 runs continuously on the partition walls 102a and 102b.

Furthermore, even though the Si substrate 120 after film formation and the pressure chamber member A were bonded to each other in FIG. 6A, the substrate 130 for pressure chamber member in which the pressure chamber openings 101 are not formed may be bonded to the Si substrate 120 after film formation.

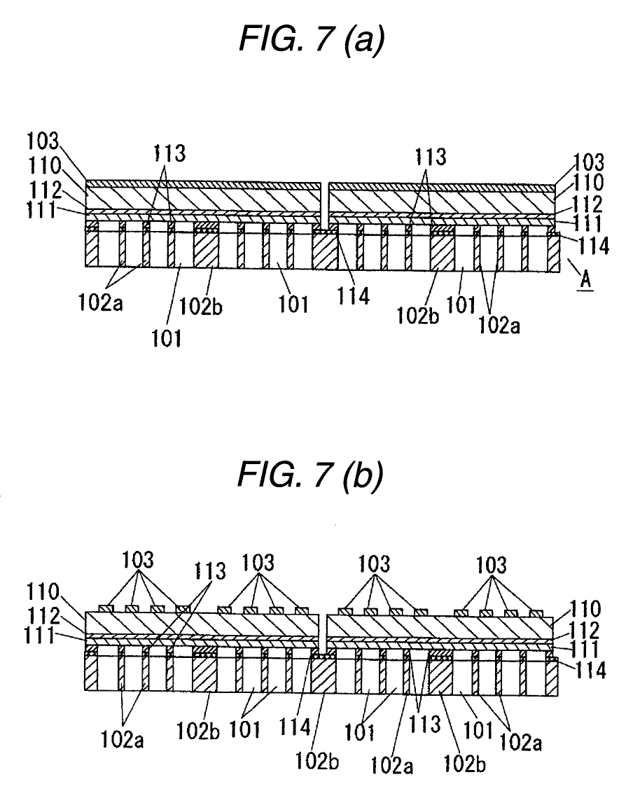

Next, FIGS. 7A and 7B are cross-sectional views illustrating procedures (a process of removing a film forming substrate after film formation and an adhesion layer and a process of separating a first electrode layer into individual parts) for manufacturing the ink jet head according to the first embodiment of the invention.

As shown in FIG. 7A, after the process in FIG. 6B has been completed, the substrate 120 for film formation and the adhesive layer 121 are removed by etching. Thereafter, as shown in FIG. 7B, the first electrode layer 103 located on the pressure chamber member A is etched using a photolithographic method, such that the first electrode layer 103 is separated into individual parts corresponding to each pressure chamber 102.

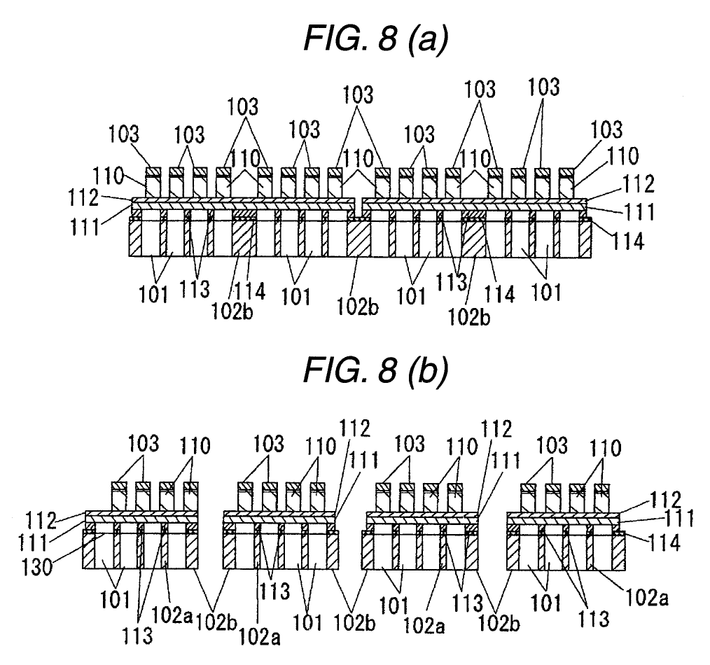

Next, FIGS. 8A and 8B are cross-sectional views illustrating procedures (a process of separating a piezoelectric layer into individual parts and a process of cutting a substrate for pressure chamber member) for manufacturing the ink jet head according to the first embodiment of the invention.

As shown in FIG. 8A, the piezoelectric layer 110 is etched using the photolithography technique, such that the piezoelectric layer 110 is separated into individual parts to have the same shape as the first electrode layer 103. In such etching, the first electrode layer 103 and the piezoelectric layer 110 are positioned above each pressure chamber 102 and are formed such that the centers of the first electrode layer 103 and the piezoelectric layer 110 in the width direction thereof match the center of the corresponding pressure chamber 102 in the width direction thereof with high precision.

Thus, after separating each of the first electrode layer 103 and the piezoelectric layer 110 into individual parts for each pressure chamber 102, the substrate (substrate 130) for pressure chamber member is cut with the individual partition walls 102b as a reference such that four pairs of pressure chamber members A and actuator parts B are completed, the pressure chamber member A having four pressure chambers 102 and the actuator part B being fixed on a top surface of the pressure chamber member A.

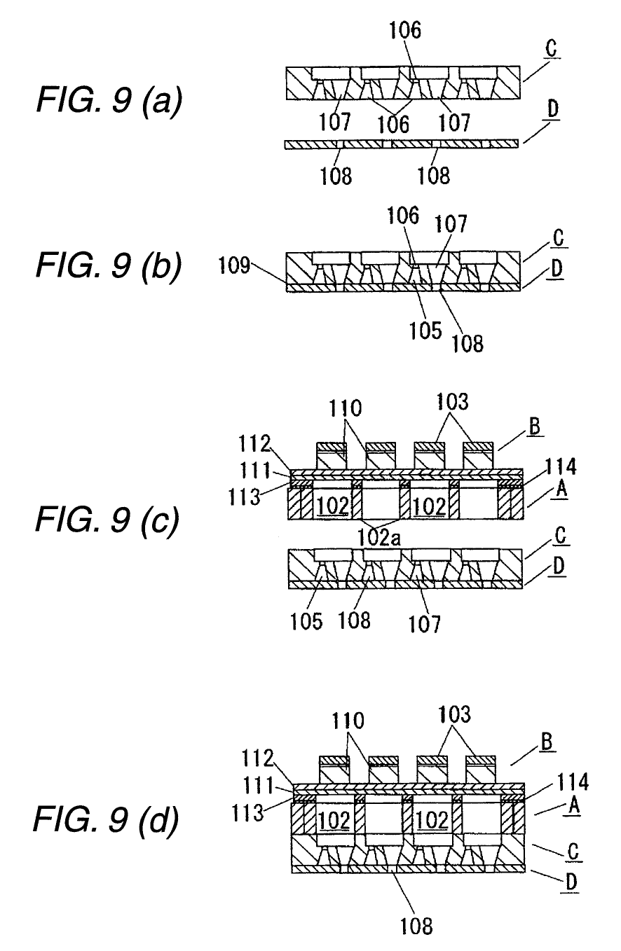

Next, FIGS. 9A to 9D are cross-sectional views illustrating procedures (a process of generating an ink passage member and a nozzle plate, a process of bonding the ink passage member and the nozzle plate to each other, a process of bonding the pressure chamber member and the ink passage member to each other, and a completed ink jet head) for manufacturing the ink jet head according to the first embodiment of the invention.

Then, as shown in FIG. 9A, the common fluid chamber 105, the supply port 106, and the ink passage 107 are formed in the ink passage member C and the nozzle hole 108 is formed in the nozzle plate D. Subsequently, as shown in FIG. 9B, the ink passage member C and nozzle plate D are bonded to each other using an adhesive 109.

Then, as shown in FIG. 9C, an adhesive (not shown) is transferred onto a lower end surface of the pressure chamber member A or an upper end surface of the ink passage member C, an alignment adjustment between the pressure chamber member A and the ink passage member C is performed, and the pressure chamber member A and the ink passage member C are bonded to each other using the adhesive. As a result, as shown in FIG. 9D, an ink jet head including the pressure chamber member A, the actuator part B, the ink passage member C, and nozzle plate D is completed.

The ink jet head 100 manufactured as described above uses a piezoelectric thin film element having a three-layered piezoelectric thin film (piezoelectric layer) manufactured under the composition conditions in the first experimental example of the first embodiment. An AC voltage having a frequency of 20 kHz and a peak value of 30 V was continuously applied for 100 days between the first electrode layer 103 and the second electrode layer 112 in the ink jet head 100. As a result, in the ink jet head 100, there was no ink discharge failure and deterioration of discharge performance was not also observed.

On the other hand, the ink jet head 100 that uses a piezoelectric thin film element having a single-layered piezoelectric thin film (piezoelectric layer) formed on the basis of the method in the first comparative example of the first embodiment was manufactured and then the same test as described above was performed for the ink jet head 100. At this time, the ink discharge failure occurred in a portion corresponding to the pressure chamber 102. Since this was not caused by clogging of ink, it is considered that a crack was generated in the actuator part B (piezoelectric thin film element) and this caused a leakage current to flow therethrough.

Therefore, it can be seen that the ink jet head 100 that uses a piezoelectric thin film element having a three-layered piezoelectric thin film (piezoelectric layer) manufactured under the composition conditions in the first experimental example of the first embodiment is excellent in terms of durability over a long period of time.

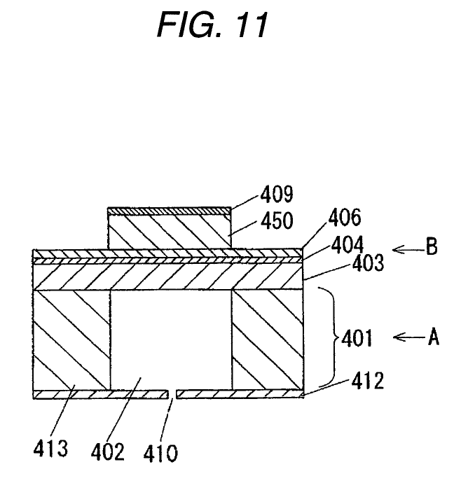

FIG. 11 is a cross-sectional view illustrating a modified example of main parts of the ink jet head according to the first embodiment of the invention.

In this modified example, the exemplary configuration in a case in which one substrate is used as both the above-described substrate (substrate 120; refer to FIG. 10) for film formation and the substrate for pressure chamber member (substrate 130; refer to FIG. 10).

Therefore, FIG. 11 shows parts related to the pressure chamber member A and the actuator part B as main parts.

In FIG. 11, reference numeral ‘401’ denotes a substrate used as both a film forming substrate (substrate 120) and a substrate (substrate 130) for pressure chamber member. Here, reference numeral ‘401’ is referred to as a ‘pressure chamber substrate’. As already described above, the pressure chamber substrate 401 may also be an Si substrate, a glass substrate, a metallic substrate, or a ceramic substrate. In the following description, the Si substrate is used as the pressure chamber substrate 401.

Specifically, the pressure chamber substrate 401 is a disc-shaped Si substrate having a diameter of 4 inches and a thickness of 200 μm. A surface (lower surface in the shown example) of the pressure chamber substrate 401 is etched to form a pressure chamber 402. The pressure chamber 402 is surrounded by a side wall 413. Although one pressure chamber 402 is shown in FIG. 11, a plurality of pressure chambers 402 are disposed so as to be separated from one another by means of the side wall 413.

In addition, the pressure chamber 402 formed in the pressure chamber substrate 401 is formed using a dry etching method when the pressure chamber substrate 401 is a glass substrate or a ceramic substrate and is formed by using a wet etching method when the pressure chamber substrate 401 is a metallic substrate.

On a surface (lower surface in the drawing) of the side wall 413, a nozzle plate 412 having a nozzle hole 410 is provided to cover an opening of each pressure chamber 402. In addition, a vibrating plate layer 403, an adhesive layer 404, and a first electrode layer (common electrode) 406 that form a ceiling of each pressure chamber 402 are laminated in this order on the other surface (upper surface in the drawing), and then a piezoelectric layer 450 and a second electrode layer (individual electrode) 409 that form a piezoelectric thin film element for the pressure chamber 402 are laminated in this order on the first electrode layer 406.

A material used to form each of the adhesive layer 404, the first electrode layer 406, the piezoelectric layer 450, and the second electrode layer 409 is the same as that of each of the adhesive layer 121, the first electrode layer 103, the piezoelectric layer 110, and the second electrode layer 112, which was already explained. In addition, the structure of the piezoelectric layer 450 is the same as that of the piezoelectric layer 110 and has a three-layered structure explained in the experimental example of the first embodiment. In addition, the adhesive layer 404 is provided to improve adhesion between the vibrating plate layer 403 and the first electrode layer 406. However, if the adhesion does not matter, the adhesive layer 404 may not be provided as described above.

Next, a method of manufacturing the ink jet head shown in the modified example of the first will be described.

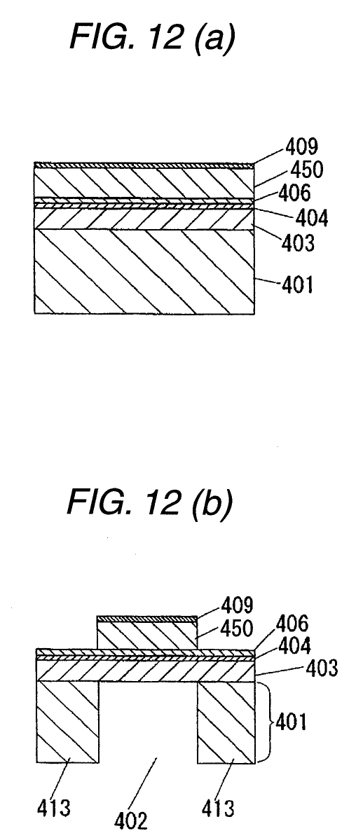

Here, a method of manufacturing the pressure chamber member and the actuator part, which are main parts shown in FIG. 11, will be described with reference to FIGS. 12A and 12B.

Moreover, FIGS. 12A and 12B are cross-sectional views illustrating procedures (laminating process and pressure chamber forming process) for manufacturing the pressure chamber member and the actuator part in the modified example of the first embodiment of the invention.

As shown in 12A, first, the vibrating plate layer 403, the adhesive layer 404, the first electrode layer 406, the piezoelectric layer 450, and the second electrode layer 409 are sequentially formed on a top surface of the pressure chamber substrate 401 under a state before forming the pressure chamber 402 by using a sputtering method.

Using materials already described above, that is, any one of a simple substance, such as chromium and nickel, an oxide thereof, and a nitride thereof (for example, silicon dioxide, aluminum oxide, zirconium oxide, or silicon nitride), for example, a silicon dioxide sintered compact target, the vibrating plate layer 403 was formed to have a thickness of 2.8 μm by applying high-frequency power of 300 W for eight hours while keeping the substrate 401 at the room temperature in an atmosphere (gas volume ratio of Ar:O₂=5:25), in which argon and oxygen are mixed and a degree of vacuum is 0.3 Pa. It is preferable that the thickness of the adhesive layer 111 be in a range of 0.5 to 10 μm. In addition, a method of forming the vibrating plate layer 403 is not limited to the sputtering method. For example, a heat CVD method, a plasma CVD method, a sol-gel method, and the like may used. Alternatively, the vibrating plate layer 403 may be formed by performing thermal oxidation processing on the pressure chamber substrate 401.

Using any one of Ti, tantalum, iron, cobalt, nickel, chromium, and a compound (including Ti) thereof, for example, a Ti target, the adhesive layer 404 was formed to have a thickness of 0.03 μm by applying high-frequency power of 100 W for one minute while heating the substrate 401 at 400° C. in argon gas with a degree of vacuum of 1 Pa. It is preferable that the thickness of the adhesive layer 404 be in a range of 0.005 to 0.1 μm.

Using, for example, a Pt target, the first electrode layer 406 was formed to have a thickness of 0.2 μm by applying high-frequency power of 200 W for 12 minutes while heating the substrate 120 at 600° C. in the argon gas with a degree of vacuum of 1 Pa. In the same manner as the first electrode layer 13 described above, at least one precious metal selected from a group of Pt, iridium, palladium, and ruthenium or a compound thereof may be preferably used as a material of the first electrode layer 103. In addition, it is preferable that the thickness of the first electrode layer 406 be in a range of 0.05 to 2 μm.

Using a multi-sputtering apparatus, the piezoelectric layer 450 was manufactured to have a three-layered structure including first, second, and third layers formed of PZT having a rhombohedral-system or tetragonal-system perovskite type crystal structure, in the same manner as in the first experimental example. Therefore, in the same manner as in the first experimental example, the thickness of the piezoelectric layer 450 is 2.6 μm, and the three layers of the piezoelectric layer 450 are preferentially oriented on the (111) plane. In addition, a (111) orientation rate, a piezoelectric constant, a relative permittivity, and the like are the same as those in the first embodiment.

Then, using, for example, a Pt target which is a conductive material, the second electrode layer 409 was formed on the piezoelectric layer 450, which was formed to have the three-layered structure as described above, to have a thickness of 0.2 μm by applying high-frequency power of 200 W for 10 minutes at the room temperature and in argon gas with a degree of vacuum of 1 Pa. It is preferable that the thickness of the second electrode layer 409 be in a range of 0.1 to 0.4 μm.

Subsequently, a resist is coated on the second electrode layer 409 using a spin coat method and is then patterned by performing exposure and development in a state in which the resist is positioned to match a place where the pressure chamber 402 is to be formed. Then, as shown in FIG. 12B, the second electrode layer 409 and the piezoelectric layer 450 are etched to be separated into individual parts. This etching is performed on the basis of a dry etching method using mixed gas obtained by mixing argon with organic gas containing a fluorine element.

Then, as shown in FIG. 12B, a lower surface of the pressure chamber substrate 401 positioned immediately below the second electrode layer 409 and the piezoelectric layer 450, which are separated into individual parts, is etched to thereby form the pressure chamber 402 that is open downward by a predetermined width. The pressure chamber 402 is formed using an anisotropy dry etching method in which sulfur hexafluoride gas, organic gas containing a fluorine element, or mixed gas thereof is used. That is, an etching mask is formed on a part, which is to be the side wall 413 that defines both ends of a lower surface of the pressure chamber substrate 401 in the width direction of the above-described layers as inner ends of an opening, of a lower surface of the pressure chamber substrate 401 opposite an upper surface thereof on which the above-described layers are formed, and then the pressure chamber 402 having an opening corresponding to the width of the above-described layers is formed using an anisotropy dry etching method.

Then, by bonding the nozzle plate 412, in which the nozzle hole 410 is formed beforehand, to a lower end surface of the side wall 413 using an adhesive, formation of the ink jet head shown in FIG. 11 is completed.

The nozzle hole 410 is opened at a predetermined location of the nozzle plate 412 using a lithographic method, a laser processing method, an electric spark method, and the like. The nozzle plate 412 is aligned such that each nozzle hole 410 is disposed at the proper position, such as the center of an opening of the corresponding pressure chamber 402, and then the nozzle plate 412 is bonded to a lower end surface of the side wall 413 of the pressure chamber substrate 401.

An AC voltage having a frequency of 20 kHz and a peak value of 30 V was continuously applied for 100 days between the first electrode layer and the second electrode layer of the ink jet head obtained as described above. As a result, in the ink jet head, there was no ink discharge failure and deterioration of discharge performance was not also observed.

On the other hand, the ink jet head that uses a piezoelectric thin film element having a single-layered piezoelectric thin film (piezoelectric layer) formed on the basis of the method in the first comparative example of the first embodiment was manufactured and then the same test as described above was performed for this ink jet head. At this time, the ink discharge failure occurred in a portion corresponding to the pressure chamber 402. Since this was not caused by clogging of ink, it is considered that a crack was generated in the actuator part B (piezoelectric thin film element) and this caused a leakage current to flow therethrough.

Therefore, it can be seen that the ink jet head according to the modified example of the first embodiment that uses a piezoelectric thin film element having a three-layered piezoelectric thin film (piezoelectric layer) manufactured under the composition conditions in the first experimental example is excellent in terms of durability over a long period of time.

In the first embodiment, examples in which a piezoelectric body is configured to include three piezoelectric layers have been described in detail. However, the number of piezoelectric layers laminated is not limited to three but, for example, five or seven piezoelectric layers may be adopted. In such a case in which the piezoelectric body is configured to include a more number of piezoelectric layers, it is needless to say that a piezoelectric constant of a piezoelectric layer that is in contact with electrodes be smaller than that of a piezoelectric layer that in not in contact with the electrodes.

In the first embodiment, the number of piezoelectric layers that are not in contact with electrodes was one. However, in the case when a plurality of piezoelectric layers are provided so as not to be in contact with electrodes, for example, in the case when a fourth piezoelectric layer is further provided between the first piezoelectric layer 14a and the second piezoelectric layer 14b described in the first embodiment, a film forming condition may be adjusted such that a piezoelectric constant of the fourth piezoelectric layer becomes a middle value of the first piezoelectric layer 14a and the second piezoelectric layer 14.

Further, as long as requirements that a piezoelectric constant of a piezoelectric layer that is in contact with an electrode is smaller than that of a piezoelectric layer that is not in contact with the electrode are satisfied, the piezoelectric constant of the fourth piezoelectric layer may be set to be larger than that of the first piezoelectric layer 14a or the second piezoelectric layer 14b.

The same is true for a fifth piezoelectric element in the case when the fifth piezoelectric element is provided between the second piezoelectric element 14b and the third piezoelectric element 14c.

Furthermore, the number of piezoelectric layers laminated may be an odd number or an even number.

### Second Embodiment

While the first embodiment is focused on improving the reliability of a piezoelectric thin film element by reducing an influence of an internal stress generated in the piezoelectric thin film element, a second embodiment is focused on improving the reliability of a piezoelectric thin film element by preventing a foreign matter from being mixed at the time of film formation.

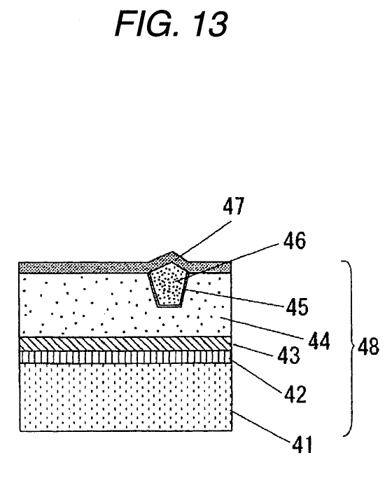

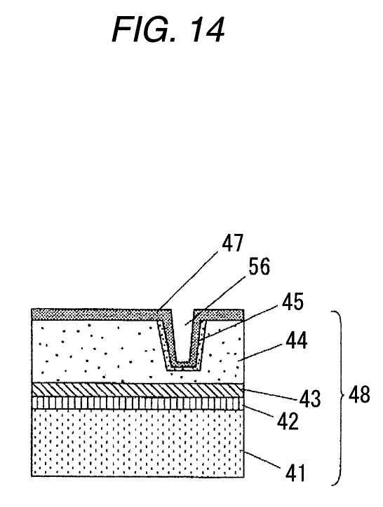

FIGS. 13 and 14 are cross-sectional views schematically illustrating a basic structure of an example of a known piezoelectric thin film element.

A piezoelectric thin film element 48 shown in FIG. 13 has a structure in which an adhesive layer 42, a lower electrode layer 43, a piezoelectric layer 44, and an upper electrode layer 47 are laminated in this order on a substrate 41. Each of the adhesive layer 42, the lower electrode layer 43, and the upper electrode 47 is formed by using a sputtering method and the like, and the piezoelectric layer 44 is formed by using the sputtering method, a CVD method, a sol-gel method, and the like.

If a foreign matter 46 is mixed when forming the piezoelectric layer 44, a by-product layer having composition different from the piezoelectric layer 44 is easily formed at an interface between the foreign matter 46 and the piezoelectric layer 44. Particularly in the case when forming a piezoelectric layer that contains lead (Pb) and has a perovskite type crystal structure, 5 to 15 mol % of excessive Pb is added, as compared with a stoichiometric composition, in order to improve the piezoelectric performance by improving crystallinity. Accordingly, a by-product layer 45 made of a lead oxide, such as a lead monoxide (PbO) or a lead dioxide (PbO₂), is easily formed.

On the other hand, the piezoelectric thin film element 48 shown in FIG. 14 also has a structure in which the adhesive layer 42, the lower electrode layer 43, the piezoelectric layer 44, and the upper electrode layer 47 are laminated in this order on the substrate 41.

The piezoelectric thin film element 48 shown in FIG. 14 is different from the piezoelectric thin film element 48 shown in FIG. 13 in that the foreign matter 46 shown in FIG. 13 is missing and a foreign matter missing part (hole) 56 exists until the upper electrode layer 47 is formed after forming the piezoelectric layer 44. Since adhesion between the foreign matter and the piezoelectric layer 44 is not good, the foreign matter is easily missing. The by-product layer 45 made of a lead oxide, such as PbO or PbO₂, exist at an interface between the piezoelectric layer 44 and the upper electrode 47 in the foreign matter missing part (hole) 56.

For example, in an ink jet head using a piezoelectric thin film actuator, it is necessary to apply a voltage of several tens of volts to a piezoelectric layer having a thickness of several micrometers. Accordingly, a voltage endurance of hundreds of kV/cm or more is requested. Thus, in the piezoelectric thin film element for which high voltage endurance is requested, if the foreign matter 46 is mixed in the piezoelectric layer 44 as in the piezoelectric thin film element 48 shown in FIG. 13 and the by-product layer 45 is formed in the periphery of the foreign matter 46, a leakage current is easily generated through the foreign matter 46 or the by-product layer 45 when a voltage is applied. As a result, the reliability is reduced.

Further, if the foreign matter missing part (hole) 56 is generated in the piezoelectric layer 44 as in the piezoelectric thin film element 48 shown in FIG. 14, the thickness of the piezoelectric film layer 44 below the foreign matter missing part (hole) 56 becomes small. Accordingly, since electric field concentration below the foreign matter missing part (hole) 56 occurs when a voltage is applied, a dielectric breakdown easily occurs. As a result, the reliability is reduced.

For example, in a piezoelectric element disclosed in JP-A-2000-351212, in order to improve the reliability of a piezoelectric thin film element, a thin-walled part produced in the piezoelectric layer (piezoelectric film) is embedded using an organic insulation material, specifically, a polyimide resin. Further, in a piezoelectric element disclosed in Japanese Patent No. 3666163, a low-dielectric material having the same element configuration as a piezoelectric thin film but different crystallinity (amorphous or pyrochlore structure) is formed in a grain boundary exposure region of crystal grains in a piezoelectric layer (piezoelectric film).

In each of the piezoelectric elements disclosed in JP-A-2000-351212 and Japanese Patent No. 3666163, an electrically insulating material not having a piezoelectric property is formed in a piezoelectric layer. Accordingly, since the piezoelectric layer deforms but the electrically insulating material does not deform when a voltage is applied to the piezoelectric layer, a large internal stress is generated in a boundary region between the piezoelectric layer and the electrically insulating material layer. For this reason, in the case when a voltage is applied to the piezoelectric element in a periodical or non-periodical manner for a long time to thereby repeat deformation, a microcrack or the like is easily generated in the piezoelectric element. Since the microcrack causes a leakage current to be generated, durability deteriorates.

The second embodiment has been finalized in view of the above problems, and it is an object of the second embodiment to provide a piezoelectric thin film element whose reliability and durability can be easily improved.

Hereinafter, a piezoelectric thin film element, a method of manufacturing a piezoelectric thin film element, an ink jet head, and an ink jet type recording apparatus according to the second embodiment of the invention will be described with reference to the accompanying drawings.

In addition, the invention is not limited to the embodiment described below.

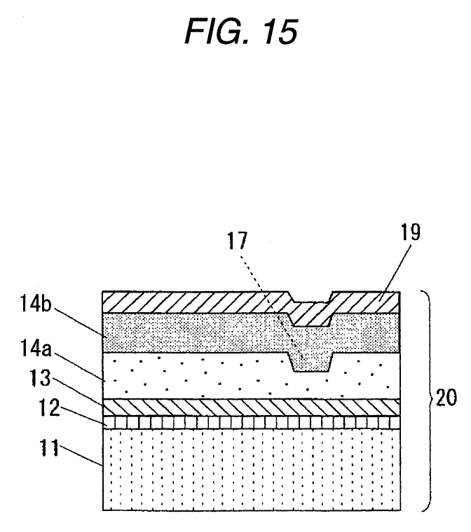

FIG. 15 is a cross-sectional view schematically illustrating an example of a piezoelectric thin film element according to the second embodiment of the invention.

In the drawing, reference numeral ‘11’ denotes a substrate, reference numeral ‘12’ denotes an adhesive layer, reference numeral ‘13’ denotes a first electrode layer, reference numeral ‘14a’ denotes a first piezoelectric layer, reference numeral ‘17’ denotes a hole, reference numeral ‘14b’ denotes a second piezoelectric layer, reference numeral ‘19’ denotes a second electrode layer, and reference numeral ‘20’ denotes a piezoelectric thin film element. The adhesive layer 12, the first electrode layer 13, the first piezoelectric layer 14a, the second piezoelectric layer 14b, and the second electrode layer 19 are laminated in this order on the substrate 11, thereby forming the piezoelectric thin film element 20.

As the substrate 11, for example, a silicon wafer, a magnesium oxide (MgO) single crystal substrate, a glass substrate, a metallic substrate, a ceramic substrate, and the like may be used.

The adhesive layer 12 is not an essential component but is provided to improve adhesion between the substrate 11 and the first electrode layer 13 as necessary. This adhesive layer 12 is formed of a metal, such as titanium (Ti), tantalum (Ta), iron (Fe), cobalt (Co), nickel (nickel), and chromium (Cr), or a compound thereof and in most cases, that the thickness of the adhesive layer 12 is properly selected within a range of 0.005 to 1 μm. For example, in the case when a silicon wafer is used as a substrate and the a first electrode layer is formed using platinum (Pt), the adhesion between the substrate 11 and the first electrode layer 12 can be improved by providing the adhesive layer 12 formed of titanium (Ti).

The first electrode layer 13 is provided to apply a voltage to a piezoelectric layer (the first piezoelectric layer 14a and the second piezoelectric layer 14b) together with the second electrode layer 19 and is formed of a predetermined conductive material. Since the substrate 11 is eventually removed when the piezoelectric thin film element 20 is used for a piezoelectric thin film actuator of an ink jet head, the first electrode layer 13 is preferably formed using a corrosion-resistant metal, such as platinum (Pt), iridium (Ir), palladium (Pd), and ruthenium (Ru) such that the first electrode layer 13 is not damaged when removing the substrate 11. The thickness of the first electrode layer 13 is properly selected according to a material.

The first piezoelectric layer 14a is formed by using an oxide containing lead as a constituent element and having a perovskite type crystal structure, for example, a PZT having a rhombohedral-system or tetragonal-system perovskite type crystal structure, a material obtained by adding an additive, such as lanthanum (La), strontium (Sr), niobium (Nb), and aluminum (Al), in the PZT, a lead magnesium niobate (PMN), a lead zinc niobate (PZN), or a lead lanthanum titanate (PLT) doped with lanthanum.

For example, in the case of forming the first piezoelectric layer 14a using the PZT, it is possible to form the crystal structure of the first piezoelectric layer 14a as a rhombohedral-system or tetragonal-system perovskite type crystal structure by setting the atomic ratio Zr/Ti between zinc (Zn) atom and titanium (Ti) atom in the first piezoelectric layer 14a to be within a range of about 30/70 to 70/30. In addition, in the PZT, when Zr/Ti is approximately 53/47, a morphotropic phase boundary (boundary between tetragonal crystal and rhombohedral crystal) is obtained.

Without being limited to the PZT, the oxide described above is generally a polycrystalline substance.

In the case of forming the first piezoelectric layer 14a with the polycrystalline substance of the oxide, a polarization axis is positioned toward the voltage application direction as long as a small amount of crystal grains are oriented, and accordingly, a piezoelectric performance is improved. However, by an influence of an internal stress generated at the time of forming the first piezoelectric layer 14a or a stress generated due to a difference in coefficients of linear expansion of the first piezoelectric layer 14a and the substrate at the time of forming the first piezoelectric layer 14a under a high temperature environment, the piezoelectric performance is suppressed.

Accordingly, for practical purposes, it is preferable to form the first piezoelectric layer 14a using a polycrystalline substance preferentially oriented on the (001) plane or the (111) plane. In this case, preferably, an orientation rate α(111) with respect to the (111) plane or an orientation rate α(001) with respect to the (001) plane is 70% or more. More preferably, the orientation rate α(111) with respect to the (111) plane or the orientation rate α(001) with respect to the (001) plane is 90% or more since the influence of each stress described above is negligible. The orientation rate α(111) is defined as α(111)=l(111)/Σl(hkl), and the orientation rate α(001) is defined as α(001)=l(001)/Σl(hkl). In the above expression, Σl(hkl) indicates a total sum of peak intensities of diffraction from respective crystal planes when 2θ is in a range of 10 to 70° C. in an X-ray diffraction method using Cu—Kα rays. The orientation rate in a polycrystalline substance is controlled by properly selecting a method of forming the polycrystalline substance, a film forming condition, property and state of a base layer, and the like.

The thickness of the first piezoelectric layer 14a is properly selected depending on the composition, application of the piezoelectric thin film element 20, and the like. In the case of using the piezoelectric thin film element 20 as a piezoelectric thin film actuator of an ink jet head, it is preferable, in most cases, to select the maximum thickness of the first piezoelectric layer 14a within a range of 1 to 10 μm. If the maximum thickness of the first piezoelectric layer 14a is out of the range, it is difficult to improve the reliability and durability of the piezoelectric thin film element 20 even if the second piezoelectric layer 14b is provided.

In addition, a foreign matter mixed with the first piezoelectric layer 14a while the first piezoelectric layer 14a is being formed is removed before forming the second piezoelectric layer 14b. As a result of the removal of the foreign matter, a hole 17 is generated in the first piezoelectric layer 14. In addition, a by-product generated while the first piezoelectric layer 14a is being formed is also removed before forming the second piezoelectric layer 14b. A method of removing a foreign matter or a by-product will be described later.

The second piezoelectric layer 14b serves to cause the hole 17 to be embedded, the hole 17 being generated in the first piezoelectric layer 14a after removing a foreign matter from the first piezoelectric layer 14a. The second piezoelectric layer 14b is formed using a piezoelectric material that is an electrically insulating oxide. As the piezoelectric material of the second piezoelectric layer 14b, for example, the oxide referred in the description on the first piezoelectric layer 14a may be used. However, the composition of the second piezoelectric layer 14b is different from that of the first piezoelectric layer 14a. A relative permittivity of the second piezoelectric layer 14b is preferably equal to or larger than ⅓ of that of the first piezoelectric layer 14a and equal to or smaller than 1, and a piezoelectric constant d31 of the second piezoelectric layer 14b is preferably equal to or larger than 1/50 of that of the first piezoelectric layer 14a and equal to or smaller than 1. More preferably, the piezoelectric constant d31 of the second piezoelectric layer 14b is equal to or larger than ½ of the first piezoelectric layer 14a. By selecting the piezoelectric constant d31 of the second piezoelectric layer 14b as described above, it becomes easy to suppress occurrence of an internal stress in an interface between the first piezoelectric layer 14a and the second piezoelectric layer 14b when applying a voltage to the piezoelectric thin film element 20.

In addition, it is preferable that a piezoelectric material for forming the second piezoelectric layer 14b be also a polycrystalline substance preferentially oriented on the (111) plane or the (001) plane. At this time, the orientation rate α(111) or α(001) is preferably 70% or more in the same manner as in the first piezoelectric layer 14a. More preferably, the orientation rate α(111) or α(001) is 90% or more.

The second electrode layer 19 is provided to apply a voltage to a piezoelectric layer (the first piezoelectric layer 14a and the second piezoelectric layer 14b) together with the first electrode layer 13 and is formed of a predetermined conductive material. The thickness of the second electrode layer 19 is properly selected within a range of approximately 0.1 to 0.4 μm in accordance with a material.

In the piezoelectric thin film element 20 having such a structure, the hole 17 generated in the first piezoelectric layer 14a is embedded by the second piezoelectric layer 14b, and accordingly, formation of a leak path and the concentration of an electric field when applying a voltage are suppressed. In addition, since both the first piezoelectric layer 14a and the second piezoelectric layer 14b deform when a voltage is applied, a large internal stress is not easily generated. As a result, a microcrack is not easily generated. For this reason, in the piezoelectric thin film element 20, the reliability and the durability are easily improved.

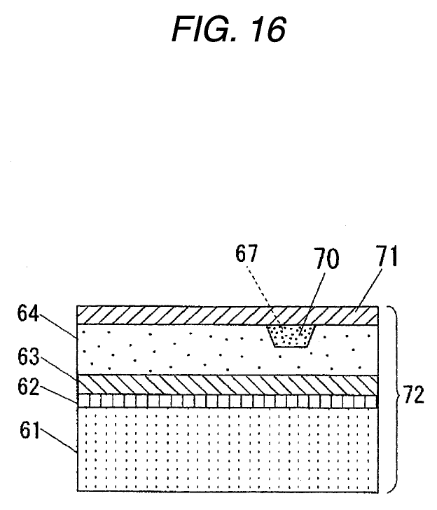

FIG. 16 is a cross-sectional view schematically illustrating a modified example of the piezoelectric thin film element according to the second embodiment of the invention.

In the drawing, reference numeral ‘61’ denotes a substrate, reference numeral ‘62’ denotes an adhesive layer, reference numeral ‘63’ denotes a first electrode layer, reference numeral ‘64’ denotes a first piezoelectric layer, reference numeral ‘67’ denotes a hole, reference numeral ‘70’ denotes a second piezoelectric layer, reference numeral ‘71’ denotes a second electrode layer, and reference numeral ‘72’ denotes a piezoelectric thin film element. The adhesive layer 62, the first electrode layer 63, and the first piezoelectric layer 64 are laminated in this order on the substrate 61. Then, the second piezoelectric layer 70 is formed only on the hole 67 such that the hole 67 generated in the first piezoelectric layer 64 is embedded. Then, the second electrode layer 71 is formed to cover the first piezoelectric layer 64 and the second piezoelectric layer 70. Thus, the piezoelectric thin film element 72 is formed.

The piezoelectric thin film element 72 in the modified example is different from the piezoelectric thin film element 20 (refer to FIG. 15) described earlier in that the piezoelectric thin film element 20 is formed only on the hole 67. Other configurations in the piezoelectric thin film element 72, which include the composition of each layer, are the same as those in the piezoelectric thin film element 20.

Even in the piezoelectric thin film element 72 having such a structure, the hole 67 generated in the first piezoelectric layer 64 is embedded by the second piezoelectric layer 70, in the same manner as the piezoelectric thin film element 20 described earlier. Accordingly, formation of a leak path and the concentration of an electric field when applying a voltage are suppressed. In addition, since both the first piezoelectric layer 64 and the second piezoelectric layer 70 deform when a voltage is applied, a large internal stress is not easily generated. As a result, a microcrack is not easily generated. For this reason, in the piezoelectric thin film element 72, the reliability and the durability are easily improved.

The piezoelectric thin film element according to the embodiment of the invention can be manufactured by using a method of manufacturing a piezoelectric thin film element, which includes a process of removing a foreign matter and a process of forming a second piezoelectric layer, for example.

Hereinafter, an example of a manufacturing method of the invention will be described for every process by way of a case in which the piezoelectric thin film element 20 (refer to FIG. 15) is manufactured.

### (Process of Removing a Foreign Matter)

In a process of removing a foreign matter, a substrate on which a first piezoelectric layer, which is made of an oxide containing lead as a constituent element and having a perovskite type crystal structure, is formed with a first electrode layer interposed therebetween is washed, such that a foreign matter mixed into the first piezoelectric layer or a by-product layer formed in the first piezoelectric layer while the first piezoelectric layer is being formed is removed.

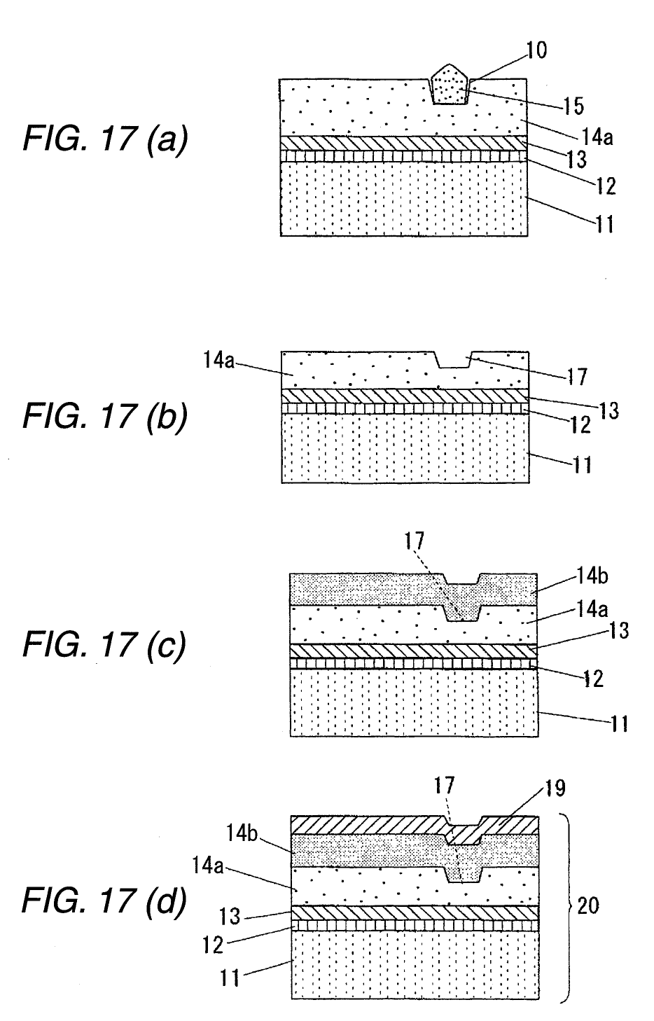

FIGS. 17A to 17D are process views schematically illustrating an example of a method of manufacturing the piezoelectric thin film element according to the second embodiment of the invention.

FIG. 17A is a view schematically illustrating an example of a foreign matter mixed into the first piezoelectric layer and an example of a by-product layer generated in the first piezoelectric layer. In the drawings, constituent components that are common with those shown in FIG. 15 have the same reference numerals as in FIG. 15, and an explanation thereof will be omitted.

As shown in FIG. 17A, the first piezoelectric layer 14a is formed on the substrate 11 with the first electrode layer 13 interposed therebetween and the adhesive layer 12 is interposed between the first electrode layer 13 and the substrate 11. A foreign matter 15 is mixed in the first piezoelectric layer 14a, and a by-product layer 16 made of, for example, a lead oxide is formed in the periphery of the foreign matter 15.

In addition, each of the adhesive layer 12, the first electrode layer 13, and the first piezoelectric layer 14a is formed depending on each composition by using a physical vapor deposition (PVD) method such as a sputtering method, a vacuum deposition method, a laser beam vacuum deposition method, an ion plating method, and a molecular beam epitaxy (MBE) method, a chemical vapor deposition (CVD) method such as a metal organic chemical vapor deposition (MOCVD) method and a plasma CVD method, a chemical solution deposition (CSD) method such as a metal organic deposition (MOD) method, or a sol-gel method.

In the process of removing a foreign matter, the foreign matter 15 or the by-product layer 16 is removed by using a specific washing process. For example, after performing ultrasonic washing in water or an organic solvent, an operation for washing using liquid (solvent) in which the by-product layer 16 dissolves is repeated once or a plural number of times, thereby removing the foreign matter 15 or the by-product layer 16. In order to wash off the by-product layer 16 by the use of solvent, washing using a dilute sulfuric acid and the like and washing using hydrogen peroxide solution may be performed in this order, for example.

FIG. 17B is a cross-sectional view schematically illustrating the first piezoelectric layer from which the foreign matter and the by-product layer are removed. In the drawings, constituent components that are common with those shown in FIG. 15 have the same reference numerals as in FIG. 15, and an explanation thereof will be omitted. As shown in FIG. 17B, in the first piezoelectric layer 14a from which the foreign matter 15 and the by-product layer 16 (refer to FIG. 17A) are removed by the above washing, the hole 17 is formed at a place where the foreign matter 15 and the by-product layer 16 exist.

### (Process of Forming a Second Piezoelectric Layer)

In a process of forming the second piezoelectric layer, the second piezoelectric layer made of an electrically insulating oxide is formed on the first piezoelectric layer, for which the process of removing a foreign matter described above has been performed, such that the hole in the first piezoelectric layer is embedded by the second piezoelectric layer.

FIG. 17C is a cross-sectional view schematically illustrating an example of the second piezoelectric layer.

As shown in FIG. 17C, the second piezoelectric layer 14b is formed on the first piezoelectric layer 14a so as to embed a hole, thereby covering the first piezoelectric layer 14a. In addition, the second piezoelectric layer 14b may be formed by using the same method as the method of forming the first piezoelectric layer 14a.

The piezoelectric thin film element 20 is obtained by forming the second electrode layer 19 on the second piezoelectric layer 14b, as shown in FIG. 17D, after forming the second piezoelectric layer 14b as described above. The second electrode layer 19 may be formed by using the same method as the method of forming the first electrode layer 13.

In the case of obtaining the piezoelectric thin film element 72, in which the second piezoelectric layer is formed on only the hole 67 so as to embed the hold formed in the first piezoelectric layer 64, by using the manufacturing method according to the embodiment of the invention like the piezoelectric thin film element 72 shown in FIG. 16, the above-described process of forming the second piezoelectric layer is divided into three sub-processes.

Hereinafter, another example of the manufacturing method according to the embodiment of the invention will be described in detail for each process by way of a case in which the piezoelectric thin film element 72 shown in FIG. 16 is manufactured.

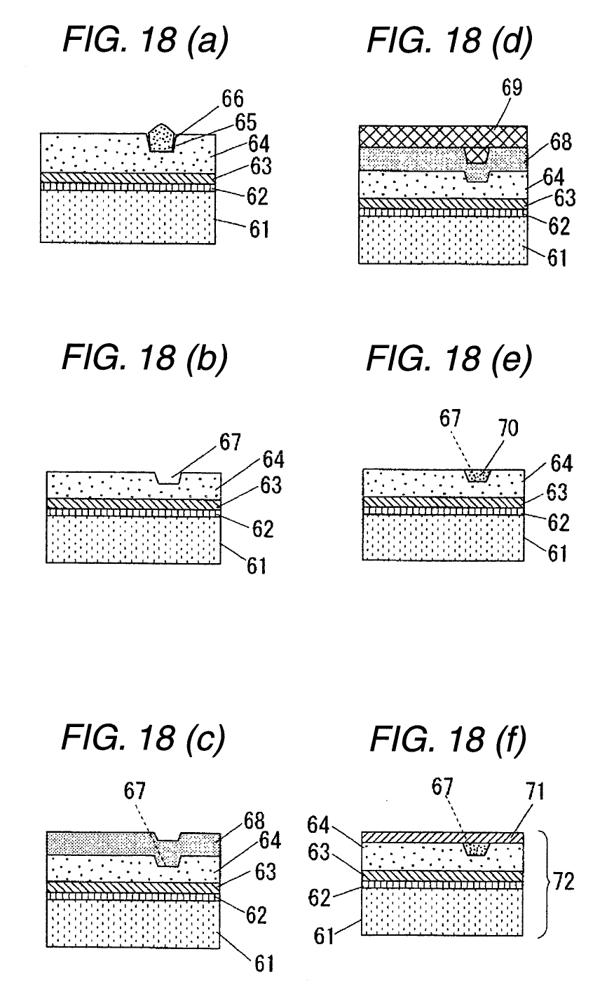

FIGS. 18A to 18F are process views schematically illustrating another example of a method of manufacturing the piezoelectric thin film element according to the second embodiment of the invention. (Washing process)

A washing process is performed in the same manner as the washing process described above. As shown in FIG. 18A, the first piezoelectric layer 64 to be washed is formed on a substrate 61 with the first electrode layer 63 interposed therebetween and the adhesive layer 62 is interposed between the first electrode layer 63 and the substrate 61. A foreign matter 65 is mixed in the first piezoelectric layer 64 and a by-product layer 66 made of, for example, a lead oxide is formed in the periphery of the foreign matter 65.

As shown in FIG. 18B, after performing the washing process, the foreign matter 65 and the by-product layer 66 (refer to FIG. 18A) are removed from the first piezoelectric layer 64 and a hole 67 is formed in a place where the foreign matters 65 and the by-product layer 66 exist.

In addition, if the adhesive layer 62, the first electrode layer 63, and the first piezoelectric layer 64 is formed in the same manner as the adhesive layer 12, the first electrode layer 13, and the first piezoelectric layer 14a already described above.

In FIG. 18A or 18B, constituent components that are common with those shown in FIG. 16 have the same reference numerals as in FIG. 16, and an explanation thereof will be omitted. The same is true for constituent components shown in FIGS. 18E and 18F.

### (Process of Forming a Second Piezoelectric Layer)

In a method of forming a second piezoelectric layer, first to third sub-processes are performed in this order, and the second piezoelectric layer is formed on only a hole such that the hole formed in the first piezoelectric layer is embedded.

As shown in FIG. 18C, in the first sub-process, the piezoelectric layer 68 by which the hole 67 is embedded is formed in an entire top surface of the first piezoelectric layer 64 in the same manner as in the process of forming the second piezoelectric layer already described above.

As will be described later, a piezoelectric layer 68 is patterned to form the second piezoelectric layer.

The piezoelectric layer 68 is formed in the same manner as the second piezoelectric layer 14b described above.

In the second sub-process, as shown in FIG. 18D, a resist layer 69 is formed on the piezoelectric layer 68. This resist layer 69 is formed such that a top surface thereof becomes flat by using a spin coat method, for example.

In the third sub-process, as shown in FIG. 18E, the resist layer 69 and the piezoelectric layer 68 are etched, such that the piezoelectric layer 68 remains in only the hole 67. This piezoelectric layer serves as the second piezoelectric layer 70. In addition, in the case of etching the resist layer 69 and the piezoelectric layer 68, it is most preferable that an etching rate of the resist layer 69 and an etching rate of the piezoelectric layer 68 are equal to each other. Accordingly, a material of the resist layer 69 is selected depending on a material of the piezoelectric layer 68 and etching gas and an etching condition at the time of etchback are selected such that the etching rate of the resist layer 69 and the etching rate of the piezoelectric layer 68 are equal to each other as much as possible or are completely equal to each other.

The piezoelectric thin film element 72 is obtained by forming the second electrode layer 71 on the second piezoelectric layer 70, as shown in FIG. 18F, after forming the second piezoelectric layer 70 as described above. The second electrode layer 71 may be formed by using the same method as the method of forming the first electrode layer 63.

An ink jet head using the piezoelectric thin film element according to the embodiment of the invention includes: a piezoelectric thin film element in which a piezoelectric layer is formed on a first electrode layer and a second electrode layer is formed on the piezoelectric layer; a vibrating plate layer provided on either the first electrode layer or the second electrode layer of the piezoelectric thin film element; and a pressure chamber member that is bonded to a surface of the vibrating plate layer not facing the piezoelectric thin film element and has a pressure chamber that contains ink. The ink jet head is configured to discharge ink in the pressure chamber by displacing the vibrating plate layer in the thickness direction of the piezoelectric thin film element by means of a piezoelectric effect of the piezoelectric thin film element. Then, the above piezoelectric thin film element has a configuration in which a substrate is removed from the piezoelectric thin film element according to the embodiment of the invention.

Hereinafter, an explanation will be described referring back to FIGS. 2 and 3 used in the description of the first embodiment.

In FIGS. 2 and 3, ‘A’ indicates a pressure chamber member, and the pressure chamber opening 101 (refer to FIG. 3) that penetrates the pressure chamber member A in the thickness direction (up and down directions) thereof is formed in the pressure chamber member A. ‘B’ indicates a piezoelectric thin film actuator part (hereinafter, simply referred to as ‘actuator part’) provided to cover an upper end opening of the pressure chamber opening 101, and ‘C’ is an ink passage member provided to cover a lower end opening of the opening 101 for pressure chamber. The pressure chamber opening 101 of the above pressure chamber member A is blocked by the actuator part B and the ink passage member C positioned thereabove and therebelow, respectively, thereby serving as the pressure chamber 102.

The actuator part B includes the first electrode layer 103 (individual electrode) located right above each pressure chamber 102, and a plurality of pressure chambers 102 and a plurality of first electrode layers 103 are arranged in a zigzag manner as can be seen from FIG. 2.

The ink passage member C includes the common fluid chamber 105 shared between the pressure chambers 102 provided in a line in the ink supply direction, the supply port 106 for supplying ink in the common fluid chamber 105 to the pressure chambers 102, and the ink passage 107 used to discharge ink in the pressure chambers 102.

‘D’ is a nozzle plate, and the nozzle hole 108 communicating with the ink passage 107 is formed in the nozzle plate D. In addition, ‘E’ is an IC chip, and a voltage is supplied from the IC chip to the first electrode layer 103 through the bonding wire BW.

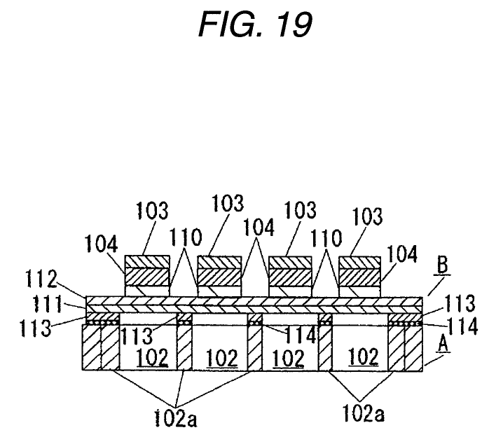

Next, the configuration of the actuator part B will be described with reference to FIG. 19.

FIG. 19 is a cross-sectional view schematically illustrating the configuration of an actuator part in the ink jet head according to the second embodiment of the invention.

FIG. 19 illustrates a cross-sectional view in the direction perpendicular to the ink supply direction shown in FIG. 2. In FIG. 19, the pressure chamber member A having four pressure chambers 102 located in a line in the perpendicular direction is drawn for reference. The actuator part B includes: a first electrode layer 103 located approximately right above each pressure chamber 102; a first piezoelectric layer 104 provided on each of the first electrode layers 103 (lower surface of the first electrode layer 103 in FIG. 19); a second piezoelectric layer 110 provided on the first piezoelectric layer 104 (lower surface of the first piezoelectric layer 104); a second electrode layer 112 (common electrode) that is provided on the second piezoelectric layer 110 (lower surface of the piezoelectric layer 110) and is common to all of the second piezoelectric layers 110; a vibrating plate layer 111 that is provided on the second electrode layer 112 (lower surface of the second electrode layer 112) and is displaced in the layer thickness direction due to a piezoelectric effect of the first piezoelectric layer 104 and the second piezoelectric layer 110 so as to vibrate; and an intermediate layer 113 (longitudinal wall) located above the partition wall 102a serving to separate the pressure chambers 102 from each other. The first electrode layer 103, the first piezoelectric layer 104, the second piezoelectric layer 110, and the second electrode layer 112 are laminated in this order to thereby form a piezoelectric thin film element. In addition, the vibrating plate layer 111 is provided on a surface of the second electrode layer 112 of piezoelectric thin film element.

In addition, reference numeral ‘114’ shown in FIG. 19 indicates an adhesive serving to bond the pressure chamber member A and the actuator part B to each other. When bonding the pressure chamber member A and the actuator part B to each other using the adhesive 114, the intermediate layer 113 serves to secure a distance between an upper surface of the pressure chamber 102 and a lower surface of the vibrating plate layer 111 such that the adhesive 114 is not attached to the vibrating plate layer 111 and the vibrating plate layer 111 performs desired displacement and vibration, even if a part of the adhesive 114 overflows into the outside of the partition wall 102a. Thus, it is preferable to bond the pressure chamber member A to a surface of the vibrating plate layer 111 of the actuator part B not facing the second electrode layer 112 with the intermediate layer 113 interposed therebetween. However, the pressure chamber member A may be directly bonded to the surface of the vibrating plate layer 111 not facing the second electrode layer 112.

Materials of the first electrode layer 103, the first piezoelectric layer 104, the second piezoelectric layer 110, and the second electrode layer 112 are the same as those of the first electrode layer 13, the first piezoelectric layer 14a, the second piezoelectric layer 14b, and the second electrode layer 19, respectively (the content of elements may be different).

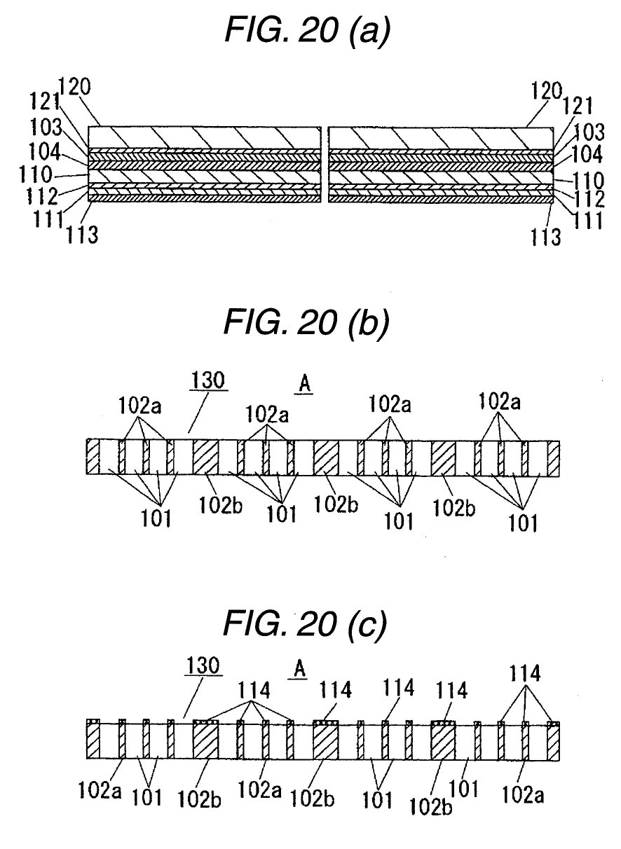

Next, a method of manufacturing the ink jet head excluding the IC chip E shown in FIG. 2, that is, the ink jet head configured to include the pressure chamber member A, the actuator part B, the ink passage member C, and the nozzle plate D shown in FIG. 3 or 19 will be described with reference to FIGS. 20A to 20C, 21A and 21B, 22A and 22B, 23A and 23B, 24A to 24D.

FIGS. 20A to 20C are process views schematically illustrating a part of processes in an example of a method of manufacturing the ink jet head configured to include a pressure chamber member, an actuator part, an ink passage member, and a nozzle plate in the second embodiment of the invention.

As shown in FIG. 20A, the adhesive layer 121, the first electrode layer 103, the first piezoelectric layer 104, the second piezoelectric layer 110, the second electrode layer 112, the vibrating plate layer 111, and the intermediate layer 113 are laminated in this order on the substrate 120 using a sputtering method. In addition, the substrate 120 is equivalent to the substrate 11 already described above, and the adhesive layer 121 is equivalent to the adhesive layer 12. The adhesive layer 121 is formed between the substrate 120 and the first electrode layer 103 in order to improve adhesion between the substrate 120 and the first electrode layer 103 as necessary. The adhesive layer 121 is removed in the same manner as the substrate 120, which will be described later. For example, chromium (Cr) is used as a material of the vibrating plate layer 111 and titanium (Ti) is used as a material of the intermediate layer 113. In addition, after forming the first piezoelectric layer 104, washing for removing a foreign matter or a by-product layer, such as a lead oxide layer, is performed and then the second piezoelectric layer 110 is formed.

A washing method and a method of forming each of the adhesive layer 121, the first electrode layer 10a, the first piezoelectric layer 104, the second piezoelectric layer 110, and the second electrode layer 112 are the same as those in the first embodiment of the invention.

Using, for example, a chromium (Cr) target, the vibrating plate layer 111 is obtained by sputtering for six hours with high-frequency power of 200 W and in an argon gas atmosphere with a degree of vacuum of 1 Pa while keeping the film forming temperature at the room temperature. The thickness of the vibrating plate layer 111 is set to 3 μm. The material of the vibrating plate layer 111 is not limited to chromium (Cr). For example, a metal (it is assumed that silicon is included in a metal) such as nickel (Ni), aluminum (Al), tantalum (Ta), tungsten (W), and silicon (Si), or an oxide or nitride thereof, for example, silicon dioxide, aluminum oxide, zirconium oxide, or silicon nitride may be used. In addition, in most cases, the thickness of the vibrating plate layer 111 can be properly selected within a range of 2 to 5 μm.

Using, for example, a titanium (Ti) target, the intermediate layer 113 is obtained by sputtering for five hours with high-frequency power of 200 W and in an argon gas atmosphere with a degree of vacuum of 1 Pa while keeping the film forming temperature at the room temperature. The thickness of the intermediate layer 113 is set to 5 μm, for example. The material of the intermediate layer 113 is not limited to the titanium (Ti). For example, a conductive metal, such as chromium (Cr) may be used. In addition, in most cases, the thickness of the intermediate layer 113 can be properly selected within a range of 3 to 10 μm.

Apart from forming these layers, the pressure chamber member A is formed as shown in FIG. 20B. This pressure chamber member A is formed using a substrate larger than the substrate 120, for example, a 4-inch silicon substrate 130 (refer to FIG. 10 described in the first embodiment). Specifically, the substrate 130 (for pressure chamber member) is patterned to form a plurality of pressure chamber openings 101. As can be seen from FIG. 20B, this patterning is performed by setting four pressure chamber openings 101 as one group. The thickness (thickness in a horizontal direction) of each of the partition wall 102b serving to separate groups from each other is set to be about twice that of the partition wall 102a serving to separate the pressure chamber openings 101 within each group.

Thereafter, the substrate 120 on which the layers described above are formed and the pressure chamber member A are bonded to each other using an adhesive. As shown in FIG. 20C, the adhesive layer used at this time is formed on each of the partition walls 102a and 102b in the pressure chamber member A by using an electrodeposition method. In order to form the adhesive layer 114 using the electrodeposition method, first, a base electrode layer (not shown) formed of a nickel (Ni) thin film having a thickness of hundreds of angstrom (several tens of nanometer), which is so thin that light can be transmitted therethrough, is formed on top surfaces of the partition walls 102a and 102b using the sputtering method. Subsequently, the adhesive layer 114 is formed on the nickel (Ni) thin film using the electrodeposition method. As electrodeposition liquid at this time, a solution obtained by adding 0 to 50 parts by weight of pure water in acrylic resin based water dispersion liquid and agitating and mixing them well is used. The reason why the thickness of the nickel (Ni) thin film is set to be so thin that light can be transmitted therethrough is to make it easy to check whether or not the pressure chamber member A and a bonding resin are completely bonded to each other. As the electrodeposition condition, for example, the temperature is about 25° C., a DC voltage is 30 V, and a power supply time is 60 seconds. In addition, the thickness of the adhesive layer 114 is set as to 3 to 10 μm.

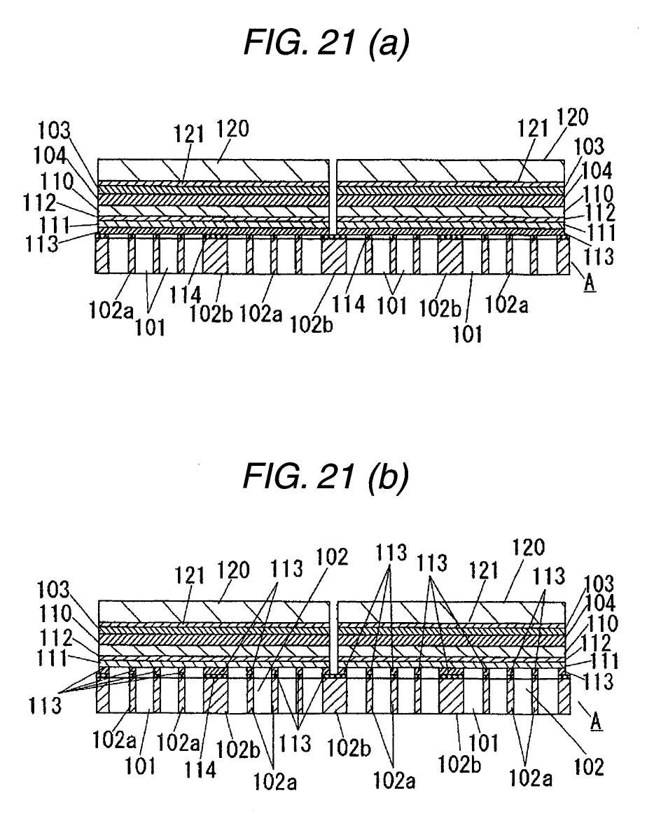

FIGS. 21A and 21B are process views schematically illustrating another part of processes in the example of the method of manufacturing the ink jet head configured to include a pressure chamber member, an actuator part, an ink passage member, and a nozzle plate in the second embodiment of the invention.

Then, as shown in FIG. 21A, the substrate 120 on which the layers described above are formed and the pressure chamber member A are bonded to each other using the adhesive layer 114. This bonding is performed by using the intermediate layer 113 formed on the substrate 120 as a substrate-side adhesive face. In addition, since the substrate 130 is larger than the substrate 120 (for film formation), a plurality of substrates 120 (four substrates 120 in the drawing) may be attached to one pressure chamber member A (substrate 130) assuming that, for example, the size of the substrate 120 is 18 mm and the substrate 130 is a 4-inch wafer, as shown in FIG. 10. As shown in FIG. 21A, this attachment is performed under a positioning alignment that allows the center of each substrate 120 is positioned at the center of one partition wall 102b in the pressure chamber member A. After the attachment, the pressure chamber member A is pressed against the substrate 120 so as to be adhered to the substrate 120, thereby bonding the pressure chamber member A and the substrate 120 to each other with satisfactory liquid tightness. Then, the substrate 120 and the pressure chamber member A that are bonded to each other are gradually heated in a heating furnace, such that the adhesive layer 114 is completely cured. Then, a plasma treatment is performed to remove protruding fractions from the adhesive 114.

In addition, even though the substrate 120 on which the individual layers are formed is bonded with the pressure chamber member A in FIG. 21A, the substrate 130 in which the pressure chamber openings 101 are not formed may be bonded to the substrate 120 on which the individual layers are formed.

Then, as shown in FIG. 21B, the intermediate layer 113 is etched using the partition walls 102a and 102b of the pressure chamber member A as a mask, such that the intermediate layer 113 is patterned in a predetermined shape, that is, in a shape (longitudinal wall) that is continuous with the partition walls 102a and 102b.

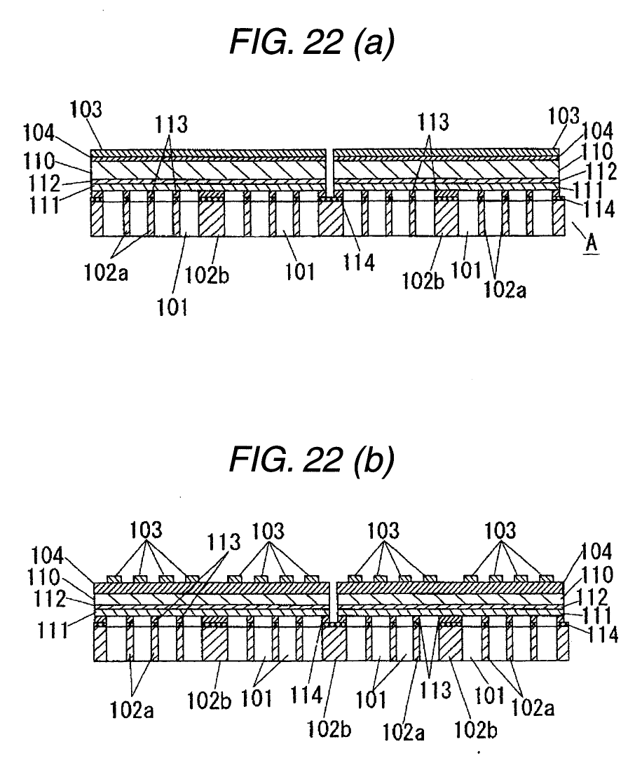

FIGS. 22A and 22B, 23A and 23B, 24A to 24D are process views schematically illustrating still another part of processes in the example of a method of manufacturing the ink jet head configured to include a pressure chamber member, an actuator part, an ink passage member, and a nozzle plate in the second embodiment of the invention.

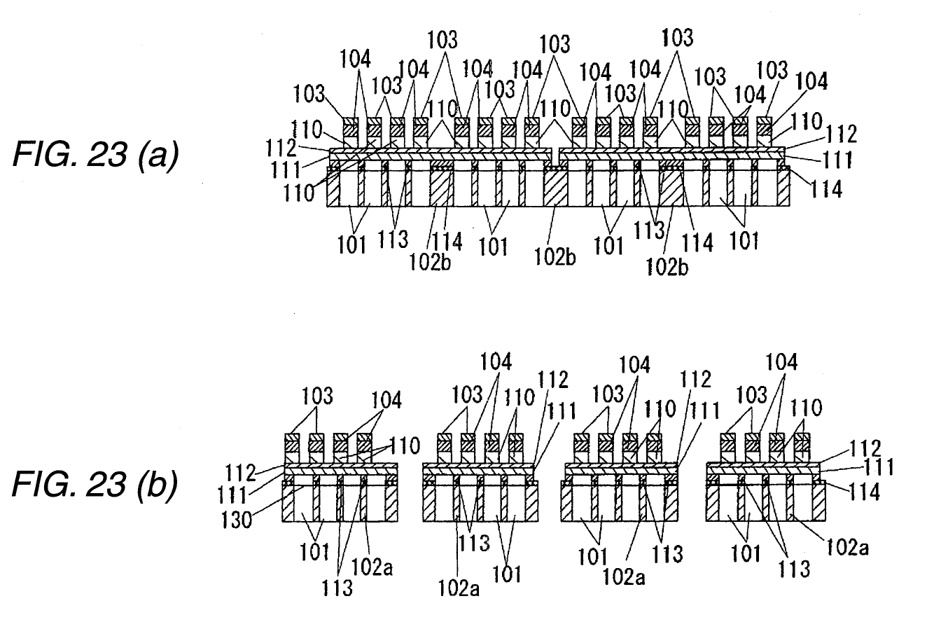

As shown in FIG. 22A, the substrate 120 and the adhesive layer 121 are etched to be removed. Then, as shown in FIG. 22B, the first electrode layer 103 located on the pressure chamber member A is etched using a photolithographic method, such that the first electrode layer 103 is separated into individual parts for every pressure chamber 102. Then, as shown in FIG. 23A, the first piezoelectric layer 104 and the second piezoelectric layer 110 are etched using the photolithographic method, such that the first piezoelectric layer 104 and the second piezoelectric layer 110 are separated into individual parts in the same manner as the first electrode layer 103. The first electrode layer 103, the first piezoelectric layer 104, and the second piezoelectric layer 110 after the etching are formed such that the first electrode layer 103, the first piezoelectric layer 104, and the second piezoelectric layer 110 are positioned above each pressure chamber 102 and the centers of the first electrode layer 103, the first piezoelectric layer 104, and the second piezoelectric layer 110 in the width direction thereof match the center of the corresponding pressure chamber 102 in the width direction thereof with high precision.

After separating each of the first electrode layer 103, the first piezoelectric layer 104, and the second piezoelectric layer 110 into individual parts for each pressure chamber 102, the substrate 130 is cut with the individual partition walls 102b as a reference such that four pairs of pressure chamber members A and actuator parts B are completed, the pressure chamber member A having four pressure chambers 102 and the actuator part B being fixed on a top surface of the pressure chamber member A.

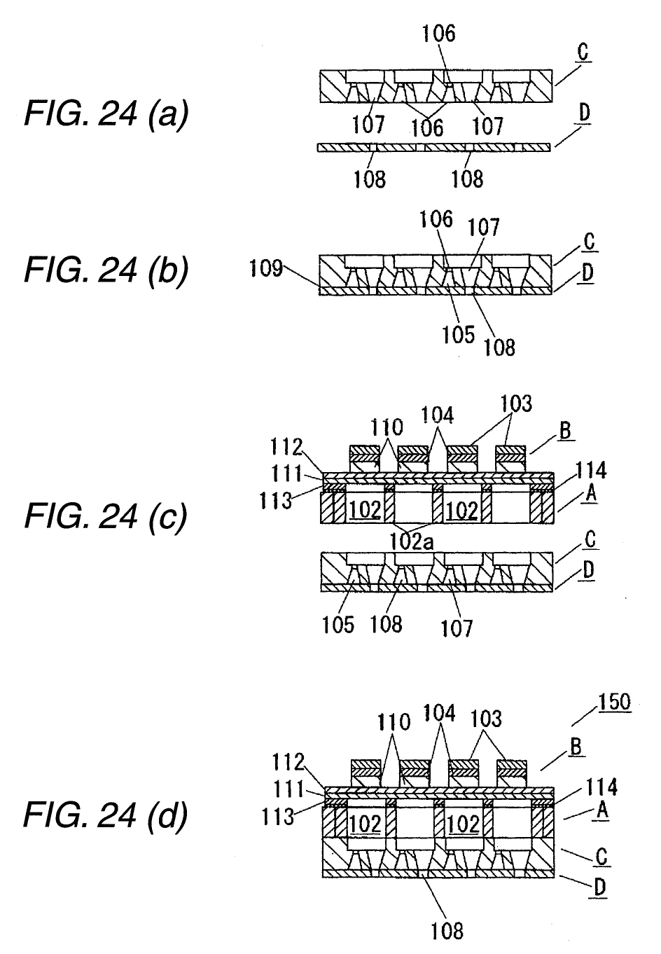

Subsequently, as shown in FIG. 24A, the common fluid chamber 105, the supply port 106, and the ink passage 107 are formed in the ink passage member C, and the nozzle hole 108 is formed in nozzle plate D. Then, as shown in FIG. 24D, the ink passage member C and the nozzle plate D are bonded to each other using the adhesive 109.

Then, as shown in FIG. 24C, an adhesive (not shown) is transferred onto a lower end surface of the pressure chamber member A or an upper end surface of the ink passage member C, an alignment adjustment between the pressure chamber member A and the ink passage member C is performed, and the pressure chamber member A and the ink passage member C are bonded to each other using the adhesive. Thus, as shown in FIG. 24D, an ink jet head 150 having the pressure chamber member A, the actuator part B, the ink passage member C, and nozzle plate D is completed.

By applying a voltage between the first electrode layer 103 and the second electrode layer 112 of the ink jet head 150 manufactured as described above, the amount of displacement of a portion of the vibrating plate layer 111 corresponding to each pressure chamber 102 in the thickness direction thereof was measured. As a result, a variation σ of the amount of displacement was 1.8%.

Further, a 20 V AC voltage having a frequency of 20 kHz was continuously applied for 10 days. As a result, there was no ink discharge failure and deterioration of discharge performance was not also observed.

On the other hand, an ink jet head different from the ink jet head 150 only in that the second piezoelectric layer 110 is not provided was manufactured and then a predetermined voltage was applied between the first electrode layer 103 and the second electrode layer 112 in the ink jet head. Then, the amount of displacement of a portion of the vibrating plate layer 111 corresponding to each pressure chamber 102 in the thickness direction thereof was measured. As a result, a variation σ of the amount of displacement was 2.2%. In addition, a 20 V AC voltage having a frequency of 20 kHz was continuously applied for 10 days. As a result, an ink discharge failure occurred in portions corresponding to about 70% of all of the pressure chambers 102. Since this was not caused by clogging of ink, it is considered that the ink discharge failure is due to deterioration of durability of the actuator part B (piezoelectric thin film element).

This indicates that the ink jet head 150 according to the second embodiment is excellent in terms of durability.

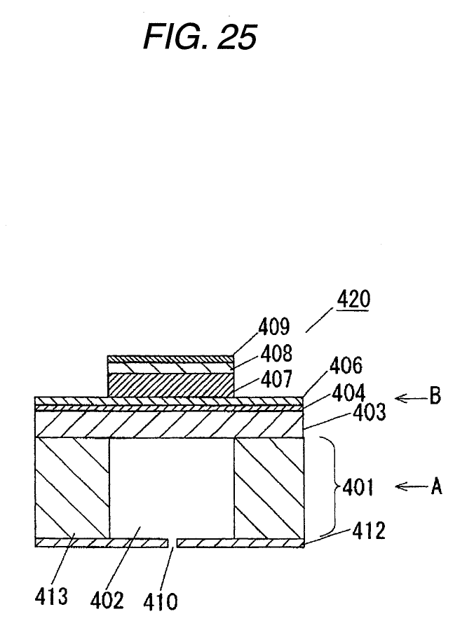

FIG. 25 is a cross-sectional view schematically illustrating main parts of a modified example of the ink jet head according to the second embodiment of the invention.

In an ink jet head 420 shown in FIG. 25, a substrate for piezoelectric thin film element and a substrate for pressure chamber member are not individually used unlike the ink jet head 150 (refer to FIG. 24D) already described above, but one substrate is used as both the substrate for piezoelectric thin film element and the substrate for pressure chamber member.

Specifically, the vibrating plate layer 403, the adhesive layer 404, the first electrode layer 406 (common electrode), a first piezoelectric layer 407, a second piezoelectric layer 408, and the second electrode layer 409 (individual electrode) are laminated in this order on the pressure chamber substrate 401 in which the pressure chamber 402 is formed through etching processing. The first electrode layer 406, the first piezoelectric layer 407, the second piezoelectric layer 408, and the second electrode layer 409 are laminated in this order to thereby form a piezoelectric thin film element. In addition, the vibrating plate layer 403 is provided on a surface of the second electrode layer 406 of the piezoelectric thin film element with the adhesive layer 404 interposed therebetween. The adhesive layer 404 is provided to improve adhesion between the vibrating plate layer 403 and the first electrode layer 406. Accordingly, as described before, the adhesive layer 404 may not be provided.

Materials used to form the adhesive layer 404, the first electrode layer 406, the first piezoelectric layer 407, the second piezoelectric layer 408, and the second electrode layer 409 are the same as those of the adhesive layer 121, the first electrode layer 103, the first piezoelectric layer 104, the second piezoelectric layer 110, and the second electrode layer 112, which were already explained. In addition, structures of the first piezoelectric layer 407 and the second piezoelectric layer 408 are also similar to those of the first piezoelectric layer 104 and the second piezoelectric layer 110, respectively. After forming the first piezoelectric layer 407, washing for removing a foreign matter or a by-product layer, such as a lead oxide layer, is performed and then the second piezoelectric layer 408 is formed.

As the pressure chamber substrate 401, for example, a 4-inch silicon wafer having a thickness of 200 μm, a glass substrate, a metallic substrate, or a ceramic substrate may be used.

In most cases, the thickness of the vibrating plate layer 403 is properly selected within a range of 0.5 to 10 μm. For example, the vibrating plate layer 403 can be formed using a silicon dioxide layer having a thickness of 2.8 μm. In addition, the materials of the vibrating plate layer 403 is not limited to the silicon dioxide. For example, it may be possible to use materials (simple substance, such as nickel and chromium or oxide or nitride thereof) already described above.

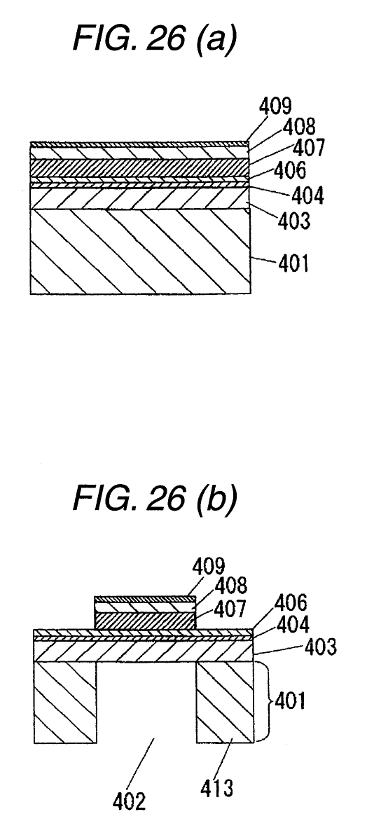

FIGS. 26A and 26B are process views schematically illustrating an example of a process for manufacturing a modified example of the ink jet head according to the second embodiment of the invention.

Next, a method of manufacturing the ink jet head 420 will be described with reference to FIG. 25.

In order to manufacture the ink jet head 420, as shown in FIG. 26A, first, the vibrating plate layer 403, the adhesive layer 404, the first electrode layer 406, the first piezoelectric layer 407, the second piezoelectric layer 408, and the second electrode layer 409 are formed in this order on the pressure chamber substrate 401 in which the pressure chamber 402 is not formed using a sputtering method.

For example, the above-mentioned vibrating plate layer 403 is obtained by sputtering a silicon dioxide sintered compact target with high-frequency power of 300 W for eight hours while keeping the film forming temperature at the room temperature in an atmosphere containing a mixed gas (gas volume ratio of Ar:O₂=5:25), in which argon (Ar) and oxygen (O₂) are mixed and a degree of vacuum is 0.4 Pa. In addition, the method of forming the vibrating plate layer 403 is not limited to the sputtering method. For example, a heat CVD method, a plasma CVD method, a sol-gel method, and the like may used. Alternatively, the vibrating plate layer 403 may be formed by performing thermal oxidation processing on the pressure chamber substrate 401.

A method of forming each of the adhesive layer 404, the first electrode layer 406, the first piezoelectric layer 407, the second piezoelectric layer 408, and the second electrode layer 409 formed on the vibrating plate layer 403 and a washing method performed after forming the first piezoelectric layer 407 are the same as the method of forming each of the adhesive layer 12, the first electrode layer 13, the first piezoelectric layer 14a, the second piezoelectric layer 14b, and the second electrode layer 19 described with reference to FIG. 5 and the washing method performed after forming the first piezoelectric layer 14a.

After forming the second electrode layer 409, a resist is coated on the second electrode layer 409 using a spin coat method and then exposure and development are performed corresponding to the position where the pressure chamber 402 is to be formed, thereby obtaining a resist pattern. Each of the second electrode layer 409, the second piezoelectric layer 408, and the first piezoelectric layer 407 is etched to be separated into individual parts by using the resist pattern as an etching mask. For example, this etching is performed using a dry etching method in which mixed gas of argon gas and organic gas containing a fluorine element is used as etching gas.

Then, as shown in FIG. 26B, the pressure chamber 402 is formed in the pressure chamber substrate 401. For example, the pressure chamber 402 is formed using an anisotropy dry etching method in which sulfur hexafluoride gas, organic gas containing a fluorine element, or mixed gas thereof is used as etching gas. A resist pattern is formed on a surface of the pressure chamber substrate 401 on which the layers described above are not formed such that a portion to become the side wall 413 is covered and then anisotropic dry etching is performed using the resist pattern as an etching mask, thereby forming the pressure chamber 402.

Thereafter, the nozzle plate 412 (refer to FIG. 25) in which the nozzle hole 410 is formed beforehand is bonded to the surface of the pressure chamber substrate 401, on which the layers described above are not formed, using an adhesive, and thus the ink jet head 420 (refer to FIG. 25) is completed. The nozzle hole 410 is formed at a predetermined position of the nozzle plate 412 using a lithographic method, a laser processing method, an electric spark method, and the like. Moreover, when bonding the nozzle plate 412 to the pressure chamber substrate 401, a positional alignment is performed such that each nozzle hole 410 is arranged corresponding to the pressure chamber 402.

By applying a voltage between the first electrode layer 406 and the second electrode layer 409 of the ink jet head 420 manufactured as described above, the amount of displacement of a portion of the vibrating plate layer 403 corresponding to each pressure chamber 402 in the thickness direction thereof was measured. As a result, a variation σ of the amount of displacement was 1.8%.

Further, a 20 V AC voltage having a frequency of 20 kHz was continuously applied for 10 days. As a result, there was no ink discharge failure and deterioration of discharge performance was not also observed.

On the other hand, an ink jet head different from the ink jet head 420 only in that the second piezoelectric layer 408 is not provided was manufactured and then a predetermined voltage was applied between the first electrode layer 406 and the second electrode layer 409 in the ink jet head. Then, the amount of displacement of a portion of the vibrating plate layer 403 corresponding to each pressure chamber 402 in the thickness direction thereof was measured. As a result, a variation σ of the amount of displacement was 2.4%. In addition, a 20 V AC voltage having a frequency of 20 kHz was continuously applied for 10 days. As a result, an ink discharge failure occurred in portions corresponding to about 65% of all of the pressure chambers 402. Since this was not caused by clogging of ink, it is considered that the ink discharge failure is due to deterioration of durability of the actuator part (piezoelectric thin film element).

This indicates that the ink jet head 420 according to the second embodiment is excellent in terms of durability.

Hereinafter, experimental examples of the piezoelectric thin film element 20 according to the second embodiment will be described in detail.

### First Experimental Example in the Second Embodiment

A first experimental example of the piezoelectric thin film element 20 (refer to FIG. 15) according to the second embodiment will be described in detail by suitably using reference numerals used in FIG. 15.

The adhesive layer 12, the first electrode layer 13, and the first piezoelectric layer 14a were sequentially formed on a 4-inch silicon wafer (substrate 11) using a sputtering method, the foreign matter 15 and the by-product layer 16 were remove by washing, the second piezoelectric layer 14b was formed on the first piezoelectric layer 14a using the sputtering method, the above layers were diced to have a predetermined size, and then the second electrode layer 19 was formed using the sputtering method, thereby obtaining a predetermined number of piezoelectric thin film elements 20.

First, the adhesive layer 12 that is made of titanium and has a thickness of 0.02 μm was formed on a silicon wafer (substrate 11) by sputtering a titanium (Ti) target with high-frequency power of 100 W for one minute while heating the silicon wafer (substrate 11) at 400° C. in an argon (Ar) gas atmosphere with a degree of vacuum of 1 Pa.

Then, the first electrode layer 13 that is made of platinum and has a thickness of 0.22 μm was formed on the adhesive layer 12 by sputtering a platinum (Pt) target with high-frequency power of 200 W for twelve minute while heating the silicon wafer (substrate 11) at 400° C. in the argon (Ar) gas atmosphere with a degree of vacuum of 1 Pa. This first electrode layer 13 (platinum layer) is a polycrystalline substance preferentially oriented on the (111) plane.

Then, while heating the silicon wafer (substrate 11) at 580° C. in a mixed-gas atmosphere where argon (Ar) gas and oxygen (O₂) gas are mixed (gas volume ratio of Ar:O₂=16:4), a PZT sintered compact target in which an atomic ratio Zr/Ti between zirconium (Zr) and titanium (Ti) is 52/48 was sputtered with high-frequency power of 250 W for an hour. As a result, the first piezoelectric layer 14a that is made of PZN and has a thickness of 1.6 μm was formed on the first electrode layer 13. In this case, a pressure of the mixed-gas atmosphere at the time of film formation was 0.3 Pa.

The silicon wafer (substrate 11) formed with the first piezoelectric layer 14a was taken out and then a foreign matter mixed into the first piezoelectric layer 14a and a by-product layer, which is formed in the first piezoelectric layer 14a and is made of lead oxide, were removed by repeatedly performing a washing operation three times, that is, by performing ultrasonic washing, performing washing using a dilute sulfuric acid, and then performing washing using hydrogen peroxide solution.

Then, the second piezoelectric layer 14b, which is made of PZT and has a thickness of 1.0 μm, was formed on the first piezoelectric layer 14a from which the foreign matter and the by-product layer were removed by using the sputtering method. At this time, as a sputtering target, a PZT sintered compact target in which an atomic ratio Zr/Ti between zirconium (Zr) and titanium (Ti) is 58/42 was used. While heating the silicon wafer (substrate 11) at 620° C. in a mixed-gas atmosphere where argon (Ar) gas and oxygen (O₂) gas are mixed (gas volume ratio of Ar:O₂=16:4), the sputtering target was sputtered with high-frequency power of 220 W for an hour. A pressure of the mixed-gas atmosphere at the time of film formation was 0.3 Pa.

Thereafter, the silicon wafer (substrate 11) was diced to obtain total fifty in-process parts having a size of 15 mm×2 mm in plan view. Then, the second electrode layer 19 that is made of platinum and has a thickness of 0.2 μm was formed on the second piezoelectric layer 14b in each of the in-process parts using the sputtering method, and as a result, total fifty piezoelectric thin film elements 20 were obtained. When forming the second electrode layer 19, the platinum (Pt) target was sputtered with high-frequency power of 200 W for 10 minutes while keeping the silicon wafer (substrate 11) at the room temperature in an argon (Ar) gas atmosphere with a degree of vacuum of 1 Pa.

As for the piezoelectric thin film element 20 obtained as described above, the crystal structure and crystal orientation of each of the first piezoelectric layer 14a and the second piezoelectric layer 14b were tested using X-ray diffraction. In addition, the crystal structure and the crystal orientation of the first piezoelectric layer 14a were measured in a state before forming the second piezoelectric layer 14b. As a result, both the first piezoelectric layer 14a and the second piezoelectric layer 14b had the rhombohedral-system perovskite type crystal structure and were preferentially oriented on the (111) plane. In both the first piezoelectric layer 14a and the second piezoelectric layer 14b, the orientation rate α(111) was 99%.

Further, the piezoelectric constant d31 of each piezoelectric thin film element 20 was measured (refer to, for example, JP-A-2002-225285 for a method of measuring the piezoelectric constant d31. As a result, an average of the piezoelectric constants d31 of the respective piezoelectric thin film elements 20 was 165 pC/N, and a variation σ was 3.5%. In addition, a relative permittivity ∈r of the first piezoelectric layer 14a was also measured. As a result, the relative permittivity ∈r was 830.

Apart from this, the silicon wafer (substrate 11) was diced to obtain a sample having a size of 15 mm×2 mm in plan view under a state in which the second piezoelectric layer 14b is formed. Then, the second electrode layer that is made of platinum and has a thickness of 0.2 μm was formed on the first piezoelectric layer 14a in an individual sample using the sputtering method and then the piezoelectric constant d31 of the first piezoelectric layer 14a was measured. As a result, an average of the piezoelectric constants d31 of the first piezoelectric layers 14a was 172 pC/N, and a variation σ thereof was 3.9%. In addition, a relative permittivity ∈r of the first piezoelectric layer 14a was also measured. As a result, the relative permittivity ∈r was 870.

From the above result, the piezoelectric constant d31 and the relative permittivity ∈r of the second piezoelectric layer 14b were calculated. As a result, the piezoelectric constant d31 and the relative permittivity ∈r of the second piezoelectric layer 14b were 155 pC/N and 780, respectively.

Then, a voltage of DC 150 V was applied to each of the fifty piezoelectric thin film elements 20 for five minutes. As a result, an increase in leakage current was not observed in all of the piezoelectric thin film elements 20 and an element breakage did not occur.

Furthermore, thirty piezoelectric thin film elements 20 having the same shape as the piezoelectric thin film element 20 were manufactured again. Then, an AC voltage having a sinusoidal waveform of 50 V and 200 Hz was continuously applied for 1000 hours in order to test the durability thereof. As a result, in all of the thirty piezoelectric thin film elements 20, the piezoelectric constants d31 did not decrease.

### First Comparative Example of the Second Embodiment

In a first comparative example in the second embodiment, a piezoelectric thin film element having the same layer configuration as the known piezoelectric thin film element 48 shown in FIG. 13 was used and each layer was formed in the conditions described above. In the first comparative example of the second embodiment, a process of removing a foreign matter existing in a piezoelectric layer and a by-product layer made of lead oxide by means of washing and a process of forming a second piezoelectric layer are not performed, as compared with the first experimental example of the second embodiment.

The thickness of a piezoelectric layer was 2.6 μm and the piezoelectric layer was preferentially oriented on the (111) plane. The orientation rate α(111) was 99%.

After forming the piezoelectric layer, the silicon wafer was diced to obtain total fifty in-process parts having a size of 15 mm×2 mm in plan view. Then, the second electrode layer that is made of platinum and has a thickness of 0.2 μm was formed on the piezoelectric layer in each of the in-process parts using the sputtering method, and then the piezoelectric constant d31 of each of the piezoelectric thin film elements was measured. As a result, an average of the piezoelectric constants d31 of the piezoelectric thin film elements manufactured in the first comparative example of the second embodiment was 177 pC/N, and a variation σ thereof was 3.3%. In addition, a relative permittivity ∈r of the piezoelectric thin film element was also measured. As a result, the relative permittivity ∈r was 835.

Then, a voltage of DC 150 V was applied to each of the fifty piezoelectric thin film elements for five minutes. As a result, an increase in leakage current was observed in twenty-three samples and an element breakage occurred in sixteen of the twenty-three samples.

Furthermore, thirty piezoelectric thin film elements having the same shape as the piezoelectric thin film element were manufactured again. Then, an AC voltage having a sinusoidal waveform of 50 V and 200 Hz was continuously applied for 1000 hours in order to test the durability thereof. As a result, in all of the thirty piezoelectric thin film elements, the piezoelectric constants d31 decreased.

### Second Comparative Example of the Second Embodiment

In a second comparative example of the second embodiment, a piezoelectric thin film element having the same layer configuration as the known piezoelectric thin film element 58 shown in FIG. 14 was used and each layer was formed in the conditions described above. In the second comparative example of the second embodiment, there is no process of forming a second piezoelectric layer after a process of removing a foreign matter existing in a piezoelectric layer and a by-product layer made of lead oxide by means of washing, as compared with the first experimental example of the second embodiment.

The thickness of a piezoelectric layer was 2.6 μm and the piezoelectric layer was preferentially oriented on the (111) plane. The orientation rate α(1111) was 99%.

After forming the piezoelectric layer, the silicon wafer was diced to obtain total fifty in-process parts having a size of 15 mm×2 mm in plan view. Then, the second electrode layer that is made of platinum and has a thickness of 0.2 μm was formed on the piezoelectric layer in each of the in-process parts using the sputtering method, and then the piezoelectric constant d31 of each of the piezoelectric thin film elements was measured. As a result, an average of the piezoelectric constants d31 of the piezoelectric thin film elements manufactured in the second comparative example of the second embodiment was 175 pC/N, and a variation σ thereof was 3.5%. In addition, a relative permittivity ∈r of the piezoelectric thin film element was also measured. As a result, the relative permittivity ∈r was 830.

Then, a voltage of DC 150 V was applied to each of the fifty piezoelectric thin film elements for five minutes. As a result, an increase in leakage current was observed in thirty-four samples and an element breakage occurred in twenty-eight of the thirty-four samples.

Furthermore, thirty piezoelectric thin film elements having the same shape as the piezoelectric thin film element were manufactured again. Then, an AC voltage having a sinusoidal waveform of 50 V and 200 Hz was continuously applied for 1000 hours in order to test the durability thereof. As a result, in all of the thirty piezoelectric thin film elements, the piezoelectric constants d31 decreased.

From the results of the first experimental example, the first comparative example, and the second comparative example of the second embodiment, the piezoelectric thin film element 20 in the first experimental example of the second embodiment is excellent in terms of reliability and durability as compared with the known piezoelectric thin film element.

### Second Experimental Example of the Second Embodiment

In a piezoelectric thin film element in a second experimental example of the second embodiment, the second piezoelectric layer 14b was formed of lead titanate (PLT) doped with lanthanum (La) and the other layers were formed under the same conditions as in the first experimental example of the second embodiment.

Using a PLT sintered compact target containing 30 mol % of lanthanum (La), the second piezoelectric layer 14b was formed by sputtering the sputtering target with high-frequency power of 200 W for an hour while heating the silicon wafer (substrate 11) at 580° C. in a mixed-gas atmosphere where argon (Ar) gas and oxygen (O₂) gas are mixed (gas volume ratio of Ar:O₂=16:4). The pressure of the mixed-gas atmosphere at the time of film formation was 0.3 Pa and the thickness of the second piezoelectric layer 14b that was formed was 1.1 μm.

### Third Experimental Example of the Second Embodiment

In a piezoelectric thin film element in a third experimental example of the second embodiment, the second piezoelectric layer 14b was formed of PLZT and the other layers were formed under the same conditions as in the first experimental example of the second embodiment.

Using a PLZT sintered compact target (atomic ratio of zirconium (Zr) and titanium (Ti): Zr/Ti=58/42) containing 20 mol % of lanthanum (La), the second piezoelectric layer 14b was formed by sputtering the sputtering target with high-frequency power of 200 W for an hour while heating the silicon wafer (substrate 11) at 630° C. at a mixed-gas atmosphere where argon (Ar) gas and oxygen (O₂) gas are mixed (gas volume ratio of Ar:O₂=25:5). The pressure of the mixed-gas atmosphere at the time of film formation was 0.4 Pa and the thickness of the second piezoelectric layer 14b that was formed was 0.9 μm.

### Fourth Experimental Example of the Second Embodiment

In a piezoelectric thin film element in a fourth experimental example of the second embodiment, the second piezoelectric layer 14b was formed of PLZT and the other layers were formed under the same conditions as in the first experimental example of the second embodiment.

Using a PLZT sintered compact target (atomic ratio of zirconium (Zr) and titanium (Ti): Zr/Ti=55/45) containing 10 mol % of lanthanum (La), the second piezoelectric layer 14b was formed by sputtering the sputtering target with high-frequency power of 210 W for an hour while heating the silicon wafer (substrate 11) at 630° C. at a mixed-gas atmosphere where argon (Ar) gas and oxygen (O₂) gas are mixed (gas volume ratio of Ar:O₂=15:5). The pressure of the mixed-gas atmosphere at the time of film formation was 0.3 Pa and the thickness of the second piezoelectric layer 14b that was formed was 1.2 μm.

### Fifth Experimental Example of the Second Embodiment

In a piezoelectric thin film element in a fourth experimental example of the second embodiment, the second piezoelectric layer 14b was formed of PZT having a specific composition and the other layers were formed under the same conditions as in the first experimental example of the second embodiment.

Using a PZT sintered compact target (atomic ratio of zirconium (Zr) and titanium (Ti): Zr/Ti=55/45), the second piezoelectric layer 14b was formed by sputtering the sputtering target with high-frequency power of 200 W for an hour while heating the silicon wafer (substrate 11) at 600° C. in a mixed-gas atmosphere where argon (Ar) gas and oxygen (O₂) gas are mixed (gas volume ratio of Ar:O₂=20:5). The pressure of the mixed-gas atmosphere at the time of film formation was 0.3 Pa and the thickness of the second piezoelectric layer 14b that was formed was 1.0 μm.

For each of the piezoelectric thin film elements in the second to fifth experimental examples of the second embodiment, whether or not a leakage current has increased when a voltage of AC 150 V was applied for five minutes and durability (whether or not a piezoelectric constant has decreased) when an AC voltage having a sinusoidal waveform of 50 V and 200 Hz was continuously applied for 1000 hours were measured under the same conditions as in the first experimental example of the second embodiment. The result is shown in Table 1. In addition, a measurement result in the first experimental example of the second embodiment is also recorded in Table 1.

In Table 1, ‘first experimental example’ to ‘fifth experimental example’ indicates the first to fifth experimental examples, respectively, even though they are simply referred to as ‘first experimental example’ to ‘fifth experimental example’.

TABLE 1

| | PLZT film | | | | |
|---|---|---|---|---|---|
| | composition | | | leakage | |
| | of insulating | d31 | | current □1 | durability □2 |
| | oxide | (pC/N) | εᵣ | (n = 50) | (n = 30) |
| (a)second | La = 30 mol %, | 0 | 650 | OK = 50 | OK = 16 |
| experimental example | Zr/Ti = 0/100 | | | NG = 0 | NG = 14 |
| (b)third | La = 20 mol %, | 5 | 450 | OK = 50 | OK = 21 |
| experimental example | Zr/Ti = 58/42 | | | NG = 0 | NG = 9 |
| (c)fourth | La = 10 mol %, | 17 | 620 | OK = 50 | OK = 30 |
| experimental example | Zr/Ti = 55/45 | | | NG = 0 | NG = 0 |
| (d)fifth | La = 0 mol %, | 95 | 590 | OK = 50 | OK = 30 |
| experimental example | Zr/Ti = 45/55 | | | NG = 0 | NG = 0 |
| (e)first | La = 0 mol %, | 155 | 780 | OK = 50 | OK = 30 |
| experimental | Zr/Ti = 53/47 | | | NG = 0 | NG = 0 |
| example □3 | | | | | |

□1: ‘O.K.’ means a piezoelectric thin film element in which an increase in leakage current was not observed, and ‘NG’ means a piezoelectric thin film element in which an increase in leakage current was observed.
□2: ‘O.K.’ means a piezoelectric thin film element in which a decrease in the piezoelectric constant d31 did not occur, and ‘NG’ means a piezoelectric thin film element in which a decrease in the piezoelectric constant d31 occurred.
□3: The piezoelectric constant d31 of the first piezoelectric layer is 172 pC/N, and the relative permittivity εr thereof is 870.

As is apparent from Table 1, by providing the second piezoelectric layer 14b, it is possible to suppress the generation of the leakage current in a piezoelectric thin film element and to improve the durability of the piezoelectric thin film element. Further, by selecting the composition of the second piezoelectric layer 14b such that the piezoelectric constant d31 of the second piezoelectric layer 14b is equal to or larger than about 1/10 of the piezoelectric constant d31 of the first piezoelectric layer 14a.

### Sixth Experimental Example of the Second Embodiment

In a sixth experimental example of the second embodiment, a predetermined number of piezoelectric thin film elements 20 were obtained by using a 4-inch magnesium oxide single crystal substrate 11 (hereinafter, referred to as ‘MgO single crystal substrate 11’) as the substrate 11.

First, the adhesive layer 12 that is made of titanium and has a thickness of 0.02 μm was formed on the MgO single crystal substrate 11 by sputtering a titanium (Ti) target with high-frequency power of 100 W for one minute while heating the MgO single crystal substrate 11 at 400° C. in an argon (Ar) gas atmosphere with a degree of vacuum of 1 Pa.

Then, the first electrode layer 13 that is made of platinum and has a thickness of 0.22 μm was formed on the adhesive layer 12 by sputtering a platinum (Pt) target with high-frequency power of 180 W for twelve minute while heating the MgO single crystal substrate 11 at 650° C. in the argon (Ar) gas atmosphere with a degree of vacuum of 1 Pa. This first electrode layer 13 (platinum layer) is a polycrystalline substance preferentially oriented on the (001) plane.

Then, while heating the MgO single crystal substrate 11 at 630° C. in a mixed-gas atmosphere where argon (Ar) gas and oxygen (O₂) gas are mixed (gas volume ratio of Ar:O₂=29:1), a PZT sintered compact target in which an atomic ratio Zr/Ti between zirconium (Zr) and titanium (Ti) is 52/48 was sputtered with high-frequency power of 230 W for an hour. As a result, the first piezoelectric layer 14a that is made of PZN and has a thickness of 1.7 μm was formed on the first electrode layer 13. A pressure of the mixed-gas atmosphere at the time of film formation was 0.3 Pa.

The MgO single crystal substrate 11 formed with the first piezoelectric layer 14a was taken out and then a foreign matter mixed into the first piezoelectric layer 14a and a by-product layer, which is formed in the first piezoelectric layer 14a and is made of lead oxide, were removed by repeatedly performing a washing operation three times, that is, by performing ultrasonic washing, performing washing using a dilute sulfuric acid, and then performing washing using hydrogen peroxide solution.

Then, the second piezoelectric layer 14b, which is made of PZT and has a thickness of 0.9 μm, was formed on the first piezoelectric layer 14a from which the foreign matter and the by-product layer were removed by using the sputtering method. At this time, as a sputtering target, a PZT sintered compact target in which an atomic ratio Zr/Ti between zirconium (Zr) and titanium (Ti) is 58/42 was used. While heating the MgO single crystal substrate 11 at 650° C. in a mixed-gas atmosphere where argon (Ar) gas and oxygen (O₂) gas are mixed (gas volume ratio of Ar:O₂=28.5:1.5), the sputtering target was sputtered with high-frequency power of 210 W for an hour. A pressure of the mixed-gas atmosphere at the time of film formation was 0.3 Pa.

Thereafter, the MgO single crystal substrate 11 was diced to obtain total fifty in-process parts having a size of 15 mm×2 mm in plan view. Then, the second electrode layer 19 that is made of platinum and has a thickness of 0.2 μm was formed on the second piezoelectric layer 14b in each of the in-process parts using the sputtering method, and as a result, total fifty piezoelectric thin film elements 20 were obtained. When forming the second electrode layer 19, the platinum (Pt) target was sputtered with high-frequency power of 200 W for 10 minutes while keeping the silicon wafer (substrate 11) at the room temperature in an argon (Ar) gas atmosphere with a degree of vacuum of 1 Pa.

As for the piezoelectric thin film element 20 obtained as described above, the crystal structure and crystal orientation of each of the first piezoelectric layer 14a and the second piezoelectric layer 14b were tested using X-ray diffraction. In addition, the crystal structure and the crystal orientation of the first piezoelectric layer 14a were measured in a state before forming the second piezoelectric layer 14b. As a result, both the first piezoelectric layer 14a and the second piezoelectric layer 14b had the rhombohedral-system perovskite type crystal structure and were preferentially oriented on the (001) plane. In both the first piezoelectric layer 14a and the second piezoelectric layer 14b, the orientation rate α(001) was 99.5%.

In addition, the piezoelectric constant d31 of each piezoelectric thin film element 20 was measured. As a result, an average of the piezoelectric constants d31 of the respective piezoelectric thin film elements 20 was 145 pC/N, and a variation σ was 1.5%. In addition, a relative permittivity ∈r of the piezoelectric thin film element 20 was also measured. As a result, the relative permittivity ∈r was 330.

Apart from this, the silicon wafer (substrate 11) was diced to obtain a sample having a size of 15 mm×2 mm in plan view under a state in which the second piezoelectric layer 14b is formed. Then, the second electrode layer that is made of platinum and has a thickness of 0.2 μm was formed on the first piezoelectric layer 14a in an individual sample using the sputtering method and then the piezoelectric constant d31 of the first piezoelectric layer 14a was measured. As a result, an average of the piezoelectric constants d31 of the first piezoelectric layers 14a was 152 pC/N, and a variation σ thereof was 3.9%. In addition, a relative permittivity ∈r of the first piezoelectric layer 14a was also measured. As a result, the relative permittivity ∈r was 370.

From the above result, the piezoelectric constant d31 and the relative permittivity ∈r of the second piezoelectric layer 14b were calculated. As a result, the piezoelectric constant d31 and the relative permittivity ∈r of the second piezoelectric layer 14b were 128 pC/N and 280, respectively.

Then, a voltage of DC 150 V was applied to each of the fifty piezoelectric thin film elements 20 for five minutes. As a result, an increase in leakage current was not observed in all of the piezoelectric thin film elements 20 and an element breakage did not occur.

Furthermore, thirty piezoelectric thin film elements 20 having the same shape as the piezoelectric thin film element 20 were manufactured again. Then, an AC voltage having a sinusoidal waveform of 50 V and 200 Hz was continuously applied for 1000 hours in order to test the durability thereof. As a result, in all of the thirty piezoelectric thin film elements 20, the piezoelectric constants d31 did not decrease.

From the above result, in the piezoelectric thin film element 20 according to the embodiment of the invention, it can be seen that excellent reliability and durability are achieved even in the when each of the first piezoelectric layer and the second piezoelectric layer 14b is preferentially oriented on the (001) plane, in the same manner as the case when each of the first piezoelectric layer and the second piezoelectric layer 14b is preferentially oriented on the (111) plane.

### Seventh Experimental Example of the Second Embodiment

Hereinafter, the piezoelectric thin film element 72 (refer to FIG. 16) in a seventh experimental example of the second embodiment will be described in detail by properly referring to reference numerals used in FIG. 16 or FIGS. 18A to 18F.

First, under the same conditions as in the first experimental example of the second embodiment, the adhesive layer 62, the first electrode layer 63, and the first piezoelectric layer 64 were sequentially laminated on a silicon wafer (hereinafter, referred to as ‘silicon wafer (substrate 61)’) as the substrate 61. Then, under the same conditions as in the first experimental example of the second embodiment, the first piezoelectric layer 64 was washed such that a foreign matter mixed into the first piezoelectric layer 64 and a by-product layer, which is made of lead oxide and is formed in the first piezoelectric layer 64, were removed. In addition, the thickness of the first piezoelectric layer 64 at a part where the foreign matter is not mixed is 2.5 μm.

Then, under the same conditions as formation of the second piezoelectric layer 14b in the first experimental example of the second embodiment, the piezoelectric layer 68 (refer to FIG. 18C) that is an origin of the second piezoelectric layer 70 was laminated on the first piezoelectric layer 64.

Subsequently, a resist was coated on the piezoelectric layer 68 in order to form the resist layer 69 (refer to FIG. 18D) having a flat top surface. As the resist layer 69 and the piezoelectric layer 68 were etched back to embed the hole 67 of the first piezoelectric layer 64. As a result, the piezoelectric layer 68 (refer to FIGS. 18E and 18F) was left on only the hole 67. At this time, etching gas was selected such that an etching rate of the resist layer 69 is approximately equal to an etching rate of the piezoelectric layer 68. The piezoelectric layer 68 remaining in the hole 67 is the second piezoelectric layer 70.

Thereafter, the silicon wafer (substrate 11) was diced to obtain total fifty in-process parts having a size of 15 mm×2 mm in plan view. Then, under the same conditions as in the first experimental example of the second embodiment, the second electrode layer 71 was formed using the sputtering method such that the first piezoelectric layer 64 and the second piezoelectric layer 70 in each of the in-process parts are covered, and as a result, total fifty piezoelectric thin film elements 72 were obtained.

The piezoelectric constant d31 of each piezoelectric thin film element 72 obtained as described above was measured. As a result, an average of the piezoelectric constants d31 of the respective piezoelectric thin film elements 72 was 172 pC/N, and a variation σ was 3.4%. In addition, a relative permittivity ∈r of the piezoelectric thin film element 72 was also measured. As a result, the relative permittivity ∈r was 870.

Then, a voltage of DC 150 V was applied to each of the fifty piezoelectric thin film elements 72 for five minutes. As a result, an increase in leakage current was not observed in all of the piezoelectric thin film elements 72 and an element breakage did not occur.

Furthermore, thirty piezoelectric thin film elements 72 having the same shape as the piezoelectric thin film element 72 were manufactured again. Then, an AC voltage having a sinusoidal waveform of 50 V and 200 Hz was continuously applied for 1000 hours in order to test the durability thereof. As a result, in all of the thirty piezoelectric thin film elements 72, the piezoelectric constants d31 did not decrease.

From the above result, it can be seen that a piezoelectric thin film element excellent in the reliability and durability can be obtained even in the case in which the second piezoelectric layer 70 is formed in only the hole 67 existing in the first piezoelectric layer 64, in the same manner as in the first or sixth experimental example of the second embodiment.

As described in detail above, the second embodiment includes the following invention.

The piezoelectric thin film element according to the second embodiment is configured to include a substrate, a first electrode layer provided on the substrate, a piezoelectric layer provided on the first electrode layer, and a second electrode layer provided on the piezoelectric layer. The piezoelectric layer includes two layers, that is, a first piezoelectric layer, which is made of an oxide containing lead as a constituent element and having a perovskite type crystal structure, and a second piezoelectric layer that is provided on the first piezoelectric layer so as to embed a hole in the first piezoelectric layer and is made of an electrically insulating oxide.

In the piezoelectric thin film element according to the second embodiment, the hole generated in the first piezoelectric layer is embedded by the second piezoelectric layer. Accordingly, formation of a leak path and the concentration of an electric field when applying a voltage are suppressed. In addition, since both the first piezoelectric layer and the second piezoelectric layer deform when a voltage is applied, a large internal stress is not easily generated. As a result, a microcrack is not easily generated. For this reason, in the piezoelectric thin film element according to the embodiment of the invention, the reliability and the durability are easily improved. By manufacturing a piezoelectric thin film actuator using the piezoelectric thin film element according to the embodiment of the invention, an ink jet head and an ink jet type recording apparatus capable of easily improving the reliability and the durability are obtained.

The piezoelectric thin film element according to the second embodiment is configured to include a substrate, a first electrode layer provided on the substrate, a piezoelectric layer provided on the first electrode layer, and a second electrode layer provided on the piezoelectric layer. The piezoelectric layer includes a first piezoelectric layer, which is made of an oxide containing lead as a constituent element and having a perovskite type crystal structure, and a second piezoelectric layer that is provided on the first piezoelectric layer so as to embed a hole in the first piezoelectric layer and is made of an electrically insulating oxide.

In the piezoelectric thin film element described above, the hole generated in the first piezoelectric layer is embedded by the second piezoelectric layer. Accordingly, formation of a leak path and the concentration of an electric field when applying a voltage are suppressed. In addition, since both the first piezoelectric layer and the second piezoelectric layer deform when a voltage is applied, a large internal stress is not easily generated. As a result, a microcrack is not easily generated. For this reason, in the piezoelectric thin film element, the reliability and the durability are easily improved.

By manufacturing a piezoelectric thin film actuator using the piezoelectric thin film element, an ink jet head and an ink jet type recording apparatus capable of easily improving the reliability and the durability are obtained.

Further, the piezoelectric thin film element according to the second embodiment is characterized in that a by-product layer does not exist in the periphery of the hole. In the piezoelectric thin film element, there is no by-product layer in the periphery of the hole, and accordingly, it is difficult for a leak path to be formed when a voltage is applied. As a result, in the piezoelectric thin film element, the reliability and the durability are easily improved.

Furthermore, the piezoelectric thin film element according to the second embodiment is characterized in that the first piezoelectric layer is a polycrystalline substance preferentially oriented on the (111) plane or the (001) plane. In the piezoelectric thin film element, the first piezoelectric layer is formed with the polycrystalline substance, an excellent piezoelectric property can be realized.

In addition, the piezoelectric thin film element according to the second embodiment is characterized in that the maximum thickness of the first piezoelectric layer is equal to or larger than 1 μm and equal to or smaller than 10 μm. In the piezoelectric thin film element, the maximum thickness of the first piezoelectric layer is selected as described above, the technical effect of the invention can be easily acquired.

Further, a method of manufacturing the piezoelectric thin film element according to the second embodiment is a method of manufacturing a piezoelectric thin film element including a substrate, a first electrode layer provided on the substrate, a piezoelectric layer provided on the first electrode layer, and a second electrode layer provided on the piezoelectric layer. The method of manufacturing the piezoelectric thin film element according to the second embodiment includes: a foreign matter removing process of removing a foreign matter mixed into a first piezoelectric layer or a by-product layer formed in the first piezoelectric layer while the first piezoelectric layer is being formed by washing the substrate on which the first piezoelectric layer, which is made of an oxide containing lead as a constituent element and having a perovskite type crystal structure, is formed with the first electrode layer interposed therebetween; and a second piezoelectric layer forming process of forming a second piezoelectric layer, which is made of an electrically insulating oxide, on the first piezoelectric layer for which the foreign matter removing process was performed such that a hole in the first piezoelectric layer is embedded.

In the manufacturing method described above, the foreign matter mixed into the first piezoelectric layer or the by-product layer formed in the first piezoelectric layer while the first piezoelectric layer is being formed is removed and then the second piezoelectric layer is formed. Accordingly, in the obtained piezoelectric layer, formation of a leak path and the concentration of an electric field when applying a voltage are suppressed. In addition, since both the first piezoelectric layer and the second piezoelectric layer deform when a voltage is applied, a large internal stress is not easily generated. As a result, a microcrack is not easily generated. For this reason, according to the manufacturing method described above, it becomes easy to obtain a piezoelectric layer having improved reliability and the durability.

Furthermore, an ink jet head according to the second embodiment includes: a piezoelectric thin film element in which a piezoelectric layer is formed on a first electrode layer and a second electrode layer is formed on the piezoelectric layer; a vibrating plate layer provided on either the first electrode layer or the second electrode layer of the piezoelectric thin film element; and a pressure chamber member that is bonded to a surface of the vibrating plate layer not facing the piezoelectric thin film element and has a pressure chamber that contains ink. The ink jet head is configured to discharge ink in the pressure chamber by displacing the vibrating plate layer in the thickness direction of the piezoelectric thin film element by means of a piezoelectric effect of the piezoelectric thin film element. The piezoelectric layer includes a first piezoelectric layer, which is made of an oxide containing lead as a constituent element and having a perovskite type crystal structure, and a second piezoelectric layer that is provided on the first piezoelectric layer so as to embed a hole in the first piezoelectric layer and is made of an electrically insulating oxide.

In addition, an ink jet type recording apparatus according to the second embodiment includes the ink jet head described above and a relative movement unit that causes the ink jet head to relatively move with respect to a recording medium. The ink jet type recording apparatus performs recording by discharging ink from the ink jet head onto the recording medium when the ink jet head relatively moves with respect to the recording medium by means of the relative movement unit.

### Third Embodiment

In order to make a piezoelectric thin film element small and manufacture the piezoelectric thin film elements in high density, a piezoelectric layer is made thin using a sputtering method, a CVD method, and a sol-gel method and minute processing for the piezoelectric layer is applied using a photolithography or dry etching method. However, if a high voltage is applied to the piezoelectric thin film element in a state where the piezoelectric thin film element is exposed to a high humidity atmosphere for a long time, an electric insulation performance of a piezoelectric body deteriorates, and as a result, a dielectric breakdown occurs. Such phenomenon has been a serious problem in terms of reliability of a piezoelectric thin film element.

Therefore, various kinds of study have been performed in order to prevent such phenomenon from occurring. Especially, in order to prevent occurrence of migration that is regarded to be most related to the dielectric breakdown, it has been considered to select gold or platinum, which does not allow the migration to easily occur, as an electrode material.

However, even if gold or platinum is used as an electrode material in order to prevent the migration of the electrode material, it was apparent that an insulation resistance of a piezoelectric body decreased. That is, the decrease in insulation resistance occurs because a piezoelectric material is directly affected by moisture. Accordingly, as a method of preventing the decrease in the insulation resistance, for example, in the case when the entire piezoelectric thin film element is housed in a metallic airtight container in which a drying agent is provided and the container is sealed completely, it has been proved that an insulation property of a piezoelectric body does not deteriorate (for example, refer to Patent Document 4-349675).

In recent years, as electronic apparatuses are becoming smaller in size, the piezoelectric thin film element is also strongly requested to be made small.

In order to meet the request, the piezoelectric thin film element is used in the form of a thin film whose volume is much smaller than that of a sintered compact that has been widely used. In addition, in order to make the piezoelectric thin film element small, the piezoelectric thin film element is requested to be in an exposed state without being put into a metallic airtight container. For this reason, a study to make the piezoelectric thin film element not deteriorating even if the piezoelectric thin film element is used under a high humidity environment without being put into the metallic airtight container is also in progress. For example, there has been proposed a method of preventing moisture from being absorbed into a piezoelectric thin film element by providing a heating layer next to a piezoelectric layer, which forms the piezoelectric thin film element, and actively heating the piezoelectric layer by means of the heating layer (for example, refer to Patent Document 2000-43259).

In the case of a lead-based piezoelectric ceramic represented by PZT, a Pb (lead) easily escapes in the form of PbO at the time of film formation, such as baking, sintering, or sputtering, and accordingly, it is difficult to control the lead-based piezoelectric ceramic on the basis of stoichiometric composition. In the case when the content of Pb is smaller than the stoichiometric composition, a crystal orientation property, a piezoelectric property, a ferroelectric property, and a pyroelectric property deteriorate. Therefore, in many cases, the Pb is added slightly excessively as compared with the stoichiometric composition.

For example, a piezoelectric body containing a lead compound, such as PZT is synthesized at the high temperature. This is also true for a thin film form. Since the vapor pressure of lead at the high temperature is high, it is general to set the lead composition of PZT to be slightly excessive as compared with the stoichiometric composition (stoichiometric composition: Pb(Zr₁₋ₓTiₓ)O₃ (0<x<1), stoichiometric composition ratio: Pb:Zr+Ti:O=1:1:3) of PZT (for example, refer to Patent Document 2005-244174).

It is considered that the dielectric breakdown in the piezoelectric thin film element, which uses the piezoelectric thin film with excessive lead, when a high voltage is applied under the high humidity environment occurs due to the following mechanism. That is, in many cases, a piezoelectric thin film is formed of a collection of a plurality of columnar crystal grains, which are arranged from a direction of the thickness direction of the piezoelectric thin film formed using, for example, a sputtering method to the other direction thereof, and a boundary portion between the columnar crystal grains exists as a crystal grain boundary.

In addition, even in the case when a form of the collection of columnar crystal does not appear, many crystal grain boundaries exist. Moreover, a small hole and the like are formed in the thickness direction of the piezoelectric thin film due to a foreign matter existing at the time of thin film formation. On the crystal grain boundary or a surface of the hole in the piezoelectric body, an excessive lead exists as a form of oxide. The lead compound existing on the crystal grain boundary electrochemically reacts with water absorbed due to reaction with moisture. As a result, a property of the lead oxide is changed.

In the case of the known piezoelectric thin film element, the dielectric breakdown occurs in the following mechanism. That is, if moisture permeates into a crystal grain boundary of a piezoelectric thin film through a pinhole of an electrode layer, a lead oxide existing in the crystal grain boundary is changed to lead hydroxide due to the moisture and is then changed to lead dioxide having conductivity.

In consideration of the above, in order to prevent water vapor in the air or a condensed water component from permeating, measures for coating an inorganic material, such as a silicon nitride (SiN) film, polyparaxylene considered to have a good gas-blocking property, or a resin-coated layer made of a derivative thereof are taken (for example, JP-A-10-242539).

However, in a method of forming a protective layer with good gas-blocking property in order to prevent water vapor in the air or a condensed water component from permeating, it is difficult to completely cover a defect of a piezoelectric thin film element surface with a thin film that does not inhibit mechanical displacement of a piezoelectric thin film element.

Furthermore, in a device, such as an ink jet head, in which a plurality of piezoelectric thin film elements are formed in parallel, the individual elements need to be independently controlled. Accordingly, a protective layer formed on each of the elements needs to be a high insulation layer. A resin or an inorganic material is generally selected, and the resin or the inorganic material needs to be formed in a predetermined thickness in order to maintain the gas-blocking property.

Furthermore, under the high humidity environment, moisture permeates through an interface between the piezoelectric thin film element and the protective layer. As a result, the piezoelectric thin film element deteriorates with time and peels off. Accordingly, adhesion between the piezoelectric thin film element and the protective film also need to be maintained.

In view of the above, it is an object of the third embodiment to provide a piezoelectric thin film element, which has a piezoelectric body configured to include a plurality of layers described in the first and second embodiments and is excellent in reliability in the high humidity environment, an ink jet head, and an inkjet recording apparatus.

Hereinafter, the third embodiment of the invention will be described in detail with reference to FIG. the accompanying drawings. In addition, in the following drawings, the same members are denoted by the same reference numerals, and an explanation thereof is omitted. Moreover, values shown below in description of the third embodiment are examples of selectable values. Accordingly, the selectable values are not limited thereto.

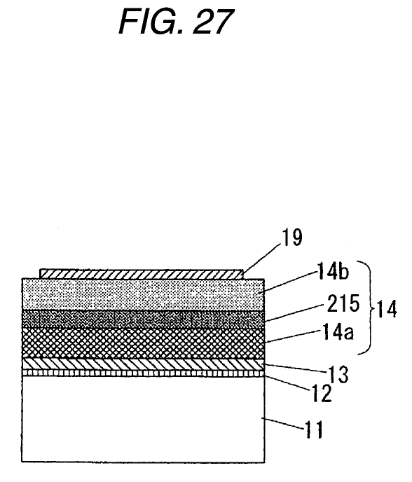

FIG. 27 is a cross-sectional view illustrating the configuration of a piezoelectric thin film element according to the third embodiment of the invention.

In FIG. 27, reference numeral ‘11’ denotes a substrate formed of a silicon (Si) wafer with a thickness of 0.3 mm and a diameter of 4 inches. On the substrate 11, an adhesive layer 12 that has a thickness of 0.02 μm and is made of titanium (Ti) is formed. In addition, the substrate 11 is not limited to silicon (Si). For example, a glass substrate, a metallic substrate, a ceramic substrate, and the like may also be used.

In FIG. 27, reference numeral ‘12’ is an adhesive layer provided to improve adhesion between the substrate 11 and the first electrode layer 13. For example, a titanium (Ti) layer may be used as the adhesive layer 12. However, the adhesive layer 12 is not limited to the titanium (Ti) layer. For example, the adhesive layer 12 may be formed using tantalum, iron, cobalt, nickel, chromium, or a compound thereof. In addition, preferably, the thickness of the adhesive layer 12 is in a range of 0.005 to 1 μm. However, if the adhesion between the substrate 11 and the first electrode layer 13 does not matter, the adhesive layer 12 may not be necessarily provided.

In FIG. 27, reference numeral ‘13’ denotes a first electrode layer that is formed on the adhesive layer 12 and is made of platinum (Pt) with a thickness of 0.22 μm. In addition, a material of the first electrode layer 13 is not limited to platinum (Pt). For example, at least one precious metal selected from a group of platinum (Pt), iridium (Ir), palladium (Pd), and ruthenium (Ru) or a compound thereof may also be used as a material of the first electrode layer 13. In addition, the thickness of the first electrode layer 13 is preferably in a range of 0.05 to 2 μm.

In FIG. 27, reference numeral ‘14’ is a piezoelectric layer that is formed on the first electrode layer 13 and is made of PZT having the rhombohedral-system or tetragonal-system perovskite type crystal structure and having a thickness of 3.0 μm. The piezoelectric layer 14 is preferentially oriented on the (111) plane. The composition of the PZT is composition (Zr/Ti=53/47) near a boundary (morphotropic phase boundary) between the tetragonal system and the rhombohedral system. In addition, the Zr/Ti composition in the piezoelectric layer 14 is not limited to 53/47. For example, the Zr/Ti composition in the piezoelectric layer 14 may be in a range of Zr/Ti=30/70 to 70/30. Moreover, as a material of the piezoelectric layer 14, a piezoelectric material containing PZT as a main component, for example, a material obtained by adding an additive, such as lanthanum (La), strontium (Sr), niobium (Nb), and aluminum (Al), in PZT, may preferably be used. In addition, PMN or PZN may also be used. In addition, the piezoelectric layer 14 may be preferentially oriented on the (001) plane.

In addition, the thickness of the piezoelectric layer 14 is preferably in the range of 0.5 to 5.0 μm.

The piezoelectric layer 14 is configured to include two layers, that is, a first piezoelectric layer 14a and a second piezoelectric layer 14b with a barrier layer 215 interposed between the first piezoelectric layer 14a and the second piezoelectric layer 14b, each of the first piezoelectric layer 14a and the second piezoelectric layer 14b having a larger amount of Pb as compared with a stoichiometric composition. In addition, the piezoelectric layer 14 has a columnar structure with the composition in which 10 mol % of excessive Pb is added as compared with the stoichiometric composition. The diameter of a columnar particle is 0.2 to 0.4 μm.

Furthermore, even though the piezoelectric layer 14 has a two-layered structure in which the first piezoelectric layer 14a is formed on the first electrode layer 13, the barrier layer 215 is formed on the first piezoelectric layer 14a, and the second piezoelectric layer 14b is formed on the barrier layer 215, the number of layers laminated is not limited to the number of barrier layers 215 laminated. Moreover, the amount of excessive Pb in a layer where the amount of Pb is more than the stoichiometric composition is preferably 25 mol % or less, more preferably, 15 mol % or less. In addition, the piezoelectric layer 14 may also be a layer where the amount of Pb is less than the stoichiometric composition. In this case, the amount of loss of Pb is preferably 10 mol % or less, more preferably, 5 mol % or less. Similarly, the piezoelectric layer 14 has a columnar structure and the diameter of a columnar particle is larger than the Pb excessive layer.

In addition, a (111) orientation rate in a layer where the amount of Pb is more than the stoichiometric composition is 99%, which is larger than a layer ((111) orientation rate is 70%) where the amount of Pb is less than the stoichiometric composition. Here, a (111) orientation rate α(111) is defined as α(111)=l(111)/Σl(hkl). Σl(hkl) indicates a total sum of peak intensities of diffraction from respective crystal planes in a PZT having a perovskite type crystal structure when 20 is in a range of 10 to 70° C. in the X-ray diffraction method using Cu—Kα rays. It is preferable that a crystal orientation rate in a layer where the amount of Pb is more than the stoichiometric composition be 70% or more and a crystal orientation rate in a layer where the amount of Pb is less than the stoichiometric composition be 50% or more.

In the piezoelectric layer 14, the barrier layer 215 is inserted and laminated. The barrier layer 215 is formed by laminating titanium (Ti) with a thickness of 0.02 nm and platinum (Pt) with a thickness of 0.1 μm. A material of the barrier layer 215 is not limited to titanium (Ti) or platinum (Pt) as long as a metal layer having a thickness enough to block moisture is used. In addition, tantalum (Ta), iron (Fe), cobalt (Co), nickel (Ni), chromium (Cr), or a compound thereof, preferably, at least one precious metal selected from a group of iridium (Ir), palladium (Pd), and ruthenium (Ru) or a compound thereof may also be used as the material of the barrier layer 215.

In addition, preferably, the thickness of the barrier layer 215 is in a range of 0.05 to 3 μmm.

Moreover, the barrier layer 215 may be a single layer or a laminated layer. Alternatively, the barrier layer 215 may be formed using an alloy containing two or more kinds of metals.

In addition, various kinds of methods may be used as a method of forming the barrier layer 215. Preferably, the barrier layer 215 is formed using a vapor deposition method. Here, the ‘vapor deposition method’ refers to a physical vapor deposition method (PVD method) and a chemical vapor deposition method (CVD method) collectively. Since the vapor deposition method is a dry formation method that does not use a solvent or the like, adsorption of moisture and the like at the time of film formation can be prevented.

Further, since the vapor deposition method is a molecule-level deposition method, it is possible to form a layer excellent in adhesion. Accordingly, it is possible to prevent moisture from permeating through an interface. Furthermore, since a series of processes for manufacturing an electrode can be performed under a vacuum environment, the element can be formed without being exposed to the air. Accordingly, it is possible to prevent the element from deteriorating due to being in contact with moisture in the air. Furthermore, using a co-deposition technique or the like, a mixed layer made of different kinds of materials may also be formed.

As a specific example of a physical vapor deposition that is an example of the vapor deposition method, a resistor heating vacuum deposition method, an electron beam heating vacuum deposition method, a high-frequency induction heating vacuum deposition method, a vapor deposition polymerization method, a plasma vacuum deposition method, an MBE (molecular beam epitaxy) method, an ionized cluster beam method, an ion plating method, a plasma polymerization method (high-frequency excitation ion plating method), a sputtering method, a reactive sputtering method, and the like may be mentioned.

In addition, as a specific example of a chemical vapor deposition that is another example of the vapor deposition method, a plasma CVD method, a heat CVD method, a gas source CVD method, and the like may be mentioned.

In FIG. 27, reference numeral ‘19’ denotes a second electrode layer that is formed on the piezoelectric layer 14 and is made of platinum (Pt) with a thickness of 0.2 μm. In addition, the material of the second electrode layer 19 is not limited to platinum (Pt). For example, an electrically conductive material may be used as the material of the second electrode layer 19, and the thickness of the second electrode layer 19 is preferably in a range of 0.1 to 0.4 μm.

Methods of forming the piezoelectric thin film element described above include a sputtering method, a vacuum deposition method, a laser abrasion method, an ion plating method, an MBE method, a PVD method, an MOCVD method, a plasma CVD method, a sol-gel method, an MOD method, and the like.

In the piezoelectric thin film element, which is configured as described above, according to the third embodiment, the piezoelectric layer 14 is provided between the first electrode layer 13 and the second electrode layer 19. The piezoelectric layer 14 is formed of a piezoelectric thin film containing Pb and a metal thin film that is the barrier layer 215 serving to block moisture is provided within the piezoelectric layer.

In the piezoelectric thin film, a small hole is formed in the thickness direction thereof due to a foreign matter existing in a boundary portion between columnar crystal grains, a crystal grain boundary or existing at the time of film formation. On the crystal grain boundary or a surface of the hole, an excessive lead exists as a form of oxide. The lead compound existing on the crystal grain boundary electrochemically reacts with water absorbed due to reaction with moisture. As a result, a property of the lead oxide is changed. In the case of the known piezoelectric thin film element, if the moisture permeates into the crystal grain boundary of the piezoelectric thin film through a pinhole of an electrode layer, a lead oxide existing in the crystal grain boundary is changed to lead hydroxide due to the moisture and is then changed to lead dioxide having conductivity.

However, in the piezoelectric thin film element according to the third embodiment, a piezoelectric layer including the first piezoelectric layer 14a and the second piezoelectric layer 14b, which contain Pb, is provided and a metal thin film, which is the barrier layer 215 serving to block moisture, is provided between the first piezoelectric layer 14a and the second piezoelectric layer 14b. Accordingly, the electrochemical reaction of lead and moisture is stopped due to the barrier layer 215 formed of a metal thin film, such that an insulation performance is maintained.

Thus, according to the third embodiment, it is possible to realize the piezoelectric thin film element that is excellent in the reliability under the high humidity environment.

Moreover, if the barrier layer 215 is provided at least a part between the first piezoelectric layer 14a and the second piezoelectric layer 14b, an effect of the invention is acquired.

### First Experimental Example in the Third Embodiment

In a first experimental example of the third embodiment, a piezoelectric thin film element having the configuration described was manufactured by sequentially forming the adhesive layer 12, the first electrode layer 13, the first piezoelectric layer 14a, the barrier layer 215, the second piezoelectric layer 14b, and the second electrode layer 19 on the substrate 11 made of silicon using the sputtering method. Hereinafter, the above formation procedures will be described.

First, the adhesive layer 12 was formed on the substrate 11. Using a titanium (Ti) target, the adhesive layer 12 was formed by applying high-frequency power of 100 W for one minute in an argon (Ar) gas atmosphere with a degree of vacuum of 1 Pa while heating the substrate 11 at 400° C.

Then, using a platinum (Pt) target, the first electrode layer 13 was formed by applying high-frequency power of 200 W for 12 minutes in an argon gas atmosphere with a degree of vacuum of 1 Pa while heating the substrate 11 at 400° C. The thickness of the first electrode layer 13 was 0.2 μm and the first electrode layer 13 is oriented on the (111) plane.

Then, the piezoelectric layer 14 was manufactured using a multi-sputtering apparatus. As a target of the piezoelectric layer 14, a sintered compact target of a PZT (Zr/Ti=53/47; 20 mol % of Pb is superfluous) in which the amount of Pb is more than the stoichiometric composition was used. First, the first piezoelectric layer 14a was formed by applying high-frequency power of 250 W for 90 minutes in a mixed-gas atmosphere (gas volume ratio of Ar:O₂=15:5), in which argon (Ar) and oxygen (O₂) are mixed and a degree of vacuum is 0.3 Pa, while heating the substrate 11 at 580° C.

Then, using a Ti target, the barrier layer 215 was formed on the first piezoelectric layer 14a by applying high-frequency power of 100 W for one minute in argon gas with a degree of vacuum is 1 Pa while heating the substrate 11 at 400° C. Subsequently, using a Pt target, the barrier layer 215 was formed by applying high-frequency power of 200 W for five minutes in argon gas with a degree of vacuum is 1 Pa while heating the substrate 11 at 400° C. Since the thickness of the barrier layer 215 is 0.1 μm, the barrier layer 215 reliably serves to block moisture or prevent an electrochemical reaction between moisture and Pb.

Thereafter, using the target used to form the barrier layer 215, the second piezoelectric layer 14b was formed by applying high-frequency power of 200 W for 95 minutes in a mixed-gas atmosphere (gas volume ratio of Ar:O₂=18:2), in which argon (Ar) and oxygen (O₂) are mixed and a degree of vacuum is 0.3 Pa, while heating the substrate 11 at 620° C.

Then, using a Pt target, the second electrode layer 19 was formed by applying high-frequency power of 200 W for 10 minutes at the room temperature and in argon gas with a degree of vacuum of 1 Pa. As a result of observation using an SEM, it was confirmed that the piezoelectric layer 14 had a columnar structure and the diameter of the columnar grain was in a range of 0.2 to 0.4 μm. The thickness of the first piezoelectric layer 14a, which is formed of only one layer, was 1.5 μm and the thickness of the second piezoelectric layer 14b, which is formed of only one layer, was 1.4 μm.

A crystal structure, crystal orientation, and an internal stress of the piezoelectric layer 14 manufactured under the above sputtering condition were tested using X-ray diffraction and sin²φ method. As a result, the obtained piezoelectric layer 14 had a rhombohedral-system perovskite type crystal structure and was oriented on the (111) plane. Furthermore, when (111) crystal orientation was measured in a state in which the first piezoelectric layer 14a was formed, the (111) orientation rate was 99%. After forming the barrier layer 215, the (111) orientation rate of the second piezoelectric layer 14b was 70%.

Furthermore, using an in-process material in a state before forming the second electrode layer 19, thirty cantilevers cut in the form of a strip of paper were manufactured in a size of 10 mm×2 mm by means of dicing. Then, the second electrode layer 19 having a thickness of 0.2 μm was formed on each of the cantilevers using the sputtering method, thereby manufacturing piezoelectric thin film element samples according to the first experimental example of the third embodiment. Here, the area of the first electrode layer 13 is larger than that of the second electrode layer 19, and the area of the barrier layer 215 is larger than that of the second electrode layer 19.

Then, a voltage of DC 35 V was applied between the first electrode layer 13 and the second electrode layer 19 of the piezoelectric thin film element sample under an atmospheric-pressure dry nitrogen gas (25° C., a dew point of −40° C. or less) environment. As a result, in the case of the piezoelectric thin film element according to the experimental example, a leakage current in all of the thirty samples was 5×10⁻⁷ (A/cm²) or less.

Then, a device of measuring a leakage current was put into a high-temperature and high-humidity layer and a voltage of DC 35 V was continuously applied for 150 hours in an atmosphere of 40° C. and 80% in order to test the change of the leakage current. As a result, in all of the thirty samples, the leakage current was 5×10⁻⁷ (A/cm²) or less, which was the same value as before the start of measurement.

From the above result, even if a layer containing a larger amount of Pb than a stoichiometric composition exists in the thickness direction between the first electrode layer 13 and the second electrode layer 19 of the piezoelectric thin film element, it is considered that the leakage current between the first electrode layer 13 and the second electrode layer 19 did not increase because the barrier layer 215 serving to block moisture exists.

### First Comparative Example of the Third Embodiment

In a first comparative example of the third embodiment, there was manufactured a piezoelectric thin film element having a configuration where only the first piezoelectric layer 14a, in which the amount of Pb was larger than the stoichiometric composition, was provided between the first electrode layer 13 and the second electrode layer 19, which were configured in the known art, under the same conditions as in the first experimental example of the third embodiment. The thickness of the first piezoelectric layer 14a was 3.0 μm and the first piezoelectric layer 14a was preferentially oriented on the (111) plane. In addition, as for the Pb composition of the first piezoelectric layer 14a confirmed by an X-ray microanalyzer, 10 mol % of Pb was superfluous as compared with the stoichiometric composition.

Furthermore, using an in-process material in a state before forming the second electrode layer 19, 100 cantilevers cut in the form of a strip of paper were manufactured in a size of 10 mm×2 mm by means of dicing. Then, the second electrode layer 19 having a thickness of 0.2 μm was formed on each of the cantilevers using the sputtering method, thereby manufacturing piezoelectric thin film element samples according to the first comparative example of the third embodiment. Here, the area of the first electrode layer 13 is larger than that of the second electrode layer 19, and the area of the barrier layer 215 is larger than that of the second electrode layer 19.

Then, a voltage of DC 35 V was applied between the first electrode layer 13 and the second electrode layer 19 of the piezoelectric thin film element sample under an atmospheric-pressure dry nitrogen gas (25° C., a dew point of −40° C. or less) environment, in the same manner as in the first experimental example of the third embodiment. As a result, in the case of the piezoelectric thin film element according to the comparative example, a leakage current in all of 100 samples was 5 μm×10⁻⁷ (A/cm²).

Then, in the same manner as in the first experimental example of the third embodiment, a device of measuring a leakage current was put into a high-temperature and high-humidity layer and a voltage of DC 35 V was continuously applied for 150 hours in an atmosphere of 40° C. and 80% in order to test the change of the leakage current. As a result, in all of 100 samples, the leakage current was 1×10⁻³ (A/cm²) or more and the leakage current was apparently generated.

This result indicates that the piezoelectric layer 14, which is preferentially oriented on the (111) plane and is shown in the first experimental example of the third embodiment, is excellent in the reliability for a long time without a leakage current, as compared with a single layer of a piezoelectric body where the amount of Pb is more than the known stoichiometric composition.

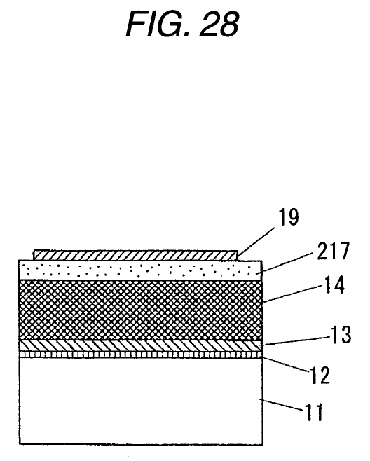

FIG. 28 is a cross-sectional view illustrating the configuration of a piezoelectric thin film element according to the third embodiment of the invention. In FIG. 28, reference numeral ‘11’ denotes a substrate formed of a silicon (Si) wafer with a thickness of 0.3 mm and a diameter of 4 inches. On the substrate 11, the adhesive layer 12 that has a thickness of 0.02 μm and is made of titanium (Ti) is formed. In addition, the substrate 11 is not limited to silicon (Si). For example, a glass substrate, a metallic substrate, a ceramic substrate, and the like may also be used.

In FIG. 28, reference numeral ‘12’ is an adhesive layer provided to improve adhesion between the substrate 11 and the first electrode layer 13. For example, a titanium (Ti) layer may be used as the adhesive layer 12. However, the adhesive layer 12 is not limited to the titanium (Ti) layer. For example, the adhesive layer 12 may be formed using tantalum, iron, cobalt, nickel, chromium, or a compound thereof. In addition, preferably, the thickness of the adhesive layer 12 is in a range of 0.005 to 1 μm. However, if the adhesion between the substrate 11 and the first electrode layer 13 does not matter, the adhesive layer 12 may not be necessarily provided.

In FIG. 28, reference numeral ‘13’ denotes a first electrode layer that is formed on the adhesive layer 12 and is made of platinum (Pt) with a thickness of 0.22 μm. In addition, a material of the first electrode layer 13 is not limited to platinum (Pt). For example, at least one precious metal selected from a group of platinum (Pt), iridium (Ir), palladium (Pd), and ruthenium (Ru) or a compound thereof may also be used as a material of the first electrode layer 13. In addition, the thickness of the first electrode layer 13 is preferably in a range of 0.05 to 2 μm.

In FIG. 28, reference numeral ‘14’ is a piezoelectric layer that is formed on the first electrode layer 13 and is made of PZT having the rhombohedral-system or tetragonal-system perovskite type crystal structure and having a thickness of 3.2 μm. The piezoelectric layer 14 is preferentially oriented on the (111) plane. The composition of the PZT is composition (Zr/Ti=53/47) near a boundary (morphotropic phase boundary) between the tetragonal system and the rhombohedral system. In addition, the Zr/Ti composition in the piezoelectric layer 14 is not limited to 53/47. For example, the Zr/Ti composition in the piezoelectric layer 14 may be in a range of Zr/Ti=30/70 to 70/30. Moreover, as a material of the piezoelectric layer 14, a piezoelectric material containing PZT as a main component, for example, a material obtained by adding an additive, such as La, Sr, Nb, and Al, in PZT, may preferably be used. In addition, PMN or PZN may also be used. In addition, the piezoelectric layer 14 may be preferentially oriented on the (001) plane. In addition, the thickness of the piezoelectric layer 14 is preferably in the range of 0.5 to 5.0 μm.

This piezoelectric layer 14 is formed of a layer where the amount of Pb is more than the stoichiometric composition. In addition, the piezoelectric layer 14 has a columnar structure and has the composition in which the amount of Pb is more than the stoichiometric composition by 10 mol %, and the diameter of a columnar grain is in a range of 0.2 to 0.4 μm.

In addition, the amount of excessive Pb of the layer having a larger amount of Pb than the stoichiometric composition is preferably 25 mol % or less, more preferably, 15 mol % or less. Alternatively, the piezoelectric layer 14 may also be a layer where the amount of Pb is less than the stoichiometric composition. In this case, the amount of loss of Pb is preferably 10 mol % or less, more preferably, 5 mol % or less. In the case of a layer where the amount of Pb is more than the stoichiometric composition, preferential orientation on the (111) plane is preferably 70% or more. In the case of a layer where the amount of Pb is less than the stoichiometric composition, preferential orientation on the (111) plane is preferably 50% or more.

In FIG. 28, reference numeral ‘217’ denotes a barrier layer formed on the piezoelectric layer 14. Since the barrier layer 217 functions as an electrode when the barrier layer 217 is a conductive layer such as a metal layer, an inorganic material layer or an organic layer is selected. Some organic materials or an inorganic material not allowing moisture to be transmitted therethrough may be applied as the barrier layer 217. Preferably, a moisture-proof material whose coefficient of water absorption is 0.1% or less is used. In addition, it is preferable to use an inorganic material that is an insulating material not containing Pb and allows a thin film to be formed.

Examples of an inorganic material include inorganic amorphous materials such as a soda glass, a white plate glass, a blue plate glass, a quartz glass, an amorphous carbon, and an amorphous silicon, inorganic oxides such as an aluminum oxide, a magnesium oxide, and a germanium oxide, and nitrides such as a boron nitride, a silicon nitride, and an aluminum nitride. Further, an organic material whose coefficient of water absorption is 0.1% or less may be applied as the barrier layer 217.

Here, the ‘coefficient of water absorption’ referred in the invention is determined on the basis of ASTMD570-81 (24 h test). Specific examples include high-molecular organic materials, such as polyethylene (coefficient of water absorption is 0.015% or less), polypropylene (coefficient of water absorption is 0.01% or less), polytetrafluoroethylene (coefficient of PTFE absorption is 0.00%), polychlorotrifluoroethylene (coefficient of PCTFE absorption is 0.00%), and poly paraxylene.

Furthermore, it is preferable that the thickness of the barrier layer 217 be in a range of 0.1 to 5 μm. In addition, even though various kinds of methods of forming the barrier layer 217 may be used, it is preferable to form the barrier layer 217 using a vapor deposition method. For example, the barrier layer 217 may be formed of an inorganic material not containing Pb, such as barium titanate (BaTiO₃) or strontium titanate (SrTiO₃), in a thickness of 0.3 μm using the sputtering method.

In FIG. 28, reference numeral ‘19’ is a second electrode layer that is formed on the barrier layer 217 and is made of platinum (Pt) with a thickness of 0.2 μm. In addition, the material of the second electrode layer 19 is not limited to the platinum (Pt). For example, an electrically conductive material may be used as the material of the second electrode layer 19. In addition, the thickness of the second electrode layer 19 is preferably in a range of 0.1 to 0.4 μm.

Moreover, methods of forming the piezoelectric thin film element described above include a sputtering method, a vacuum deposition method, a laser abrasion method, an ion plating method, an MBE method, a PVD method, a MOCVD method, a plasma CVD method, a sol-gel method, and an MOD method.

In the piezoelectric thin film element, which is configured as described above, according to the third embodiment of the invention, the piezoelectric layer 14 containing a larger amount of Pb than the stoichiometric composition is provided between the first electrode layer 13 and the second electrode layer 19, and a metal layer that is the barrier layer 217 serving to block moisture is provided between the first electrode layer 13 and the second electrode layer 19. Accordingly, even if a layer containing a larger amount of Pb than the stoichiometric composition exists in the thickness direction between the upper and lower electrode layers, progress of reaction to a lead oxide can be prevented because the barrier layer 217 that serves to block moisture and does not contain a Pb component exists.

Therefore, according to the third embodiment, it is possible to realize the piezoelectric thin film element that is excellent in the reliability under the high humidity environment.

In the above description, a case in which a metal layer that is the barrier layer 217 is provided between the piezoelectric layer 14 and the second electrode layer 19 was exemplified. However, the barrier layer 217 may be provided between the piezoelectric layer 14 and the first electrode layer 13. In addition, an effect of the invention is achieved if the barrier layer 217 is provided between the piezoelectric layer 14 and the second electrode layer 19 or at least a part between the piezoelectric layer 14 and the first electrode layer 13.

### Second Experimental Example in the Third Embodiment

In a second experimental example of the third embodiment, the piezoelectric thin film element having the configuration described above was manufactured by sequentially forming the adhesive layer 12, the first electrode layer 13, the piezoelectric layer 14, the barrier layer 217, and the second electrode layer 19 on the substrate 11 made of silicon using the sputtering method.

First, the adhesive layer 12 was formed on the substrate 11. Using a titanium (Ti) target, the adhesive layer 12 was formed by applying high-frequency power of 100 W for one minute in an argon (Ar) gas atmosphere with a degree of vacuum of 1 Pa while heating the substrate 11 at 400° C.

Then, using a platinum (Pt) target, the first electrode layer 13 was formed by applying high-frequency power of 200 W for 12 minutes in an argon gas atmosphere with a degree of vacuum of 1 Pa while heating the substrate 11 at 400° C. The thickness of the first electrode layer 13 was 0.2 μm and the first electrode layer 13 was oriented on the (111) plane.

Then, the piezoelectric layer 14 was manufactured using a multi-sputtering apparatus in the same manner as in the first experimental example of the third embodiment. As a target of the piezoelectric layer 14, a sintered compact target of a PZT (Zr/Ti=53/47; 25 mol % of Pb is superfluous) in which the amount of Pb is more than the stoichiometric composition was used. The piezoelectric layer 14 containing a larger amount of Pb than the stoichiometric composition was formed by applying high-frequency power of 250 W for 190 minutes in a mixed-gas atmosphere (gas volume ratio of Ar:O₂=19:1), in which argon (Ar) and oxygen (O₂) are mixed and a degree of vacuum is 0.3 Pa, while heating the substrate 11 at 580° C.

Thereafter, by performing rotational film formation using barium titanate (BaTiO₃) and strontium titanate (SrTiO₃) at the same time, the barrier layer 217 was formed on the piezoelectric layer 14 by applying high-frequency power of 250 W for 15 minutes in a mixed-gas atmosphere (gas volume ratio of Ar:O₂=19:1), in which argon (Ar) and oxygen (O₂) are mixed and a degree of vacuum is 0.3 Pa, while heating the substrate 11 at 580° C.

As a result of observation using an SEM, it was confirmed that the piezoelectric layer 14 had a columnar structure and the diameter of the columnar grain was in a range of 0.2 to 0.4 μm. The thickness of the piezoelectric layer 14 was 3.0 μm. Since the thickness of the barrier layer 217 is 0.3 μm, the barrier layer 217 reliably serves to block moisture or prevent an electrochemical reaction between moisture and Pb.

The crystal structure and crystal orientation of the piezoelectric layer 14 manufactured under the above sputtering condition were tested using X-ray diffraction and sin²φ method. As a result, the obtained piezoelectric layer 14 had a rhombohedral-system perovskite type crystal structure and was oriented on the (111) plane. Furthermore, when (111) crystal orientation was measured in a state in which the piezoelectric layer 14 was formed, the (111) orientation rate was 99%.

Furthermore, using an in-process material in a state before forming the second electrode layer 19, thirty cantilevers cut in the form of a strip of paper were manufactured in a size of 10 mm×2 mm by means of dicing. Then, the second electrode layer 19 having a thickness of 0.2 μm was formed on each of the cantilevers using the sputtering method, thereby manufacturing piezoelectric thin film element samples according to the second experimental example of the third embodiment. Here, the area of the first electrode layer 13 is larger than that of the second electrode layer 19, and the area of the barrier layer 217 is larger than that of the second electrode layer 19.

Then, a voltage of DC 35 V was applied between the first electrode layer 13 and the second electrode layer 19 of the piezoelectric thin film element sample under an atmospheric-pressure dry nitrogen gas (25° C., a dew point of −40° C. or less) environment. As a result, in the case of the piezoelectric thin film element according to the experimental example, a leakage current in all of the thirty samples was 5×10⁻⁷ (A/cm²) or less.

Then, in the same manner as in the first experimental example of the third embodiment, a device of measuring a leakage current was put into a high-temperature and high-humidity layer and a voltage of DC 35 V was continuously applied for 150 hours in an atmosphere of 40° C. and 80% in order to test the change of the leakage current. As a result, in all of the thirty samples, the leakage current was 5×10⁻⁷ (A/cm²) or less, which was the same value as before the start of measurement.

From the above result, even if a layer containing a larger amount of Pb than the stoichiometric composition exists in the thickness direction between the first electrode layer 13 and the second electrode layer 19 of the piezoelectric thin film element, it is considered that the leakage current between the first electrode layer 13 and the second electrode layer 19 did not increase without a progress of reaction to the lead oxide because the barrier layer 215, which serves to block moisture and does not contain Pb, exists.

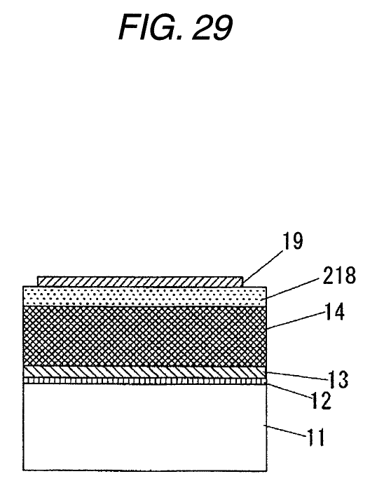

FIG. 29 is a cross-sectional view illustrating the configuration of the piezoelectric thin film element according to the third embodiment of the invention. In FIG. 29, a moisture absorption layer 218 which absorbs moisture is provided instead of the barrier layer 217 described above.

As shown in FIG. 29, in the piezoelectric thin film element, the adhesive layer 12, the first electrode layer 13, the piezoelectric layer 14, the moisture absorption layer 218, and the second electrode layer 19 are formed in this order on the substrate 11. The configuration of the piezoelectric thin film element is the same as that of the piezoelectric thin film element including the barrier layer 217 described above except that the moisture absorption layer 218 is provided instead of the barrier layer 217.

In general, an organic material layer or some inorganic material layers are selected as the moisture absorption layer 218. The moisture absorption layer 218 is formed of an organic material, such as polyvinyl alcohol (coefficient of water absorption is 80%) and nylon 6 (coefficient of water absorption is 9.5%), to have a thickness of about 0.3 μm using a vacuum deposition method. In addition, the thickness of the moisture absorption layer 218 is not limited thereto. For example, the thickness of the moisture absorption layer 218 may be in a range of 0.1 to 5 μm.

In addition, an organic material whose coefficient of water absorption is 1% or more, preferably, 100% or more may be applied as a moisture absorption layer. Other materials that can be used for the moisture absorption layer include nylon 66 (coefficient of water absorption is 8.5%), an acetyl cellulose (coefficient of water absorption is 5 to 9%), a polyamide (coefficient of water absorption is 9.5%), a chlorinated rubber (coefficient of water absorption is 5%), a urea resin, a butyl acetyl cellulose, and the like. As a polymer with high water absorbability, Arasoaf (product name: made by Arakawa Chemical Industries, Ltd.), Wondergel (product name: made by Kao Corporation), Aquakeep (product name; made by Nippon Steel Chemical Co., Ltd.), Aqualic (product name: made by Nippon Shokubai Co., Ltd.), Drytech (product name: made by Dow Chemical Company), and favour (product name: made by Stock Hausen) are mentioned.

In addition, examples of an inorganic material include: an inorganic material with a large surface area, such as a zeolite (coefficient of water absorption is 20%), a silica gel (coefficient of water absorption is 20%), an activated alumina (coefficient of water absorption is 15%), an activated carbon, and molecular sieves; a film-shaped material, such as graphite or transition metal dichalcogenite such as NbS₃, NbSe₂, and TaSe₂; unsaturated oxides such as GeO and CaO; and a compound having water of crystallization, such as CuSO₄, NiSO₄, LiClO₄, sodium p-toluenesulfonate, sodium acetate, and sodium citrate.

As a more preferable material, a polymer with high water absorbability of which a coefficient of water absorption is 400% or more may be used. In addition, even though various kinds of methods of forming the moisture absorption layer 218 may be used, it is preferable to form the moisture absorption layer 218 using a vapor deposition method.

In the piezoelectric thin film element, which is configured as described above, according to the third embodiment of the invention, the piezoelectric layer 14 containing a larger amount of Pb than the stoichiometric composition is provided between the first electrode layer 13 and the second electrode layer 19, and the moisture absorption layer 218 that absorbs moisture is provided between the first electrode layer 13 and the second electrode layer 19. Accordingly, even if a layer containing a larger amount of Pb than the stoichiometric composition exists in the thickness direction between the upper and lower electrode layers, progress of reaction to a lead oxide can be prevented by removing the moisture.

Therefore, according to the third embodiment, it is possible to realize the piezoelectric thin film element that is excellent in the reliability under the high humidity environment.

In the above description, a case in which the moisture absorption layer 218 is provided between the piezoelectric layer 14 and the second electrode layer 19 was exemplified. However, the moisture absorption layer 218 may be provided between the piezoelectric layer 14 and the first electrode layer 13. In addition, the effect of the invention is achieved if the moisture absorption layer 218 is provided between the piezoelectric layer 14 and the second electrode layer 19 or at least a part between the piezoelectric layer 14 and the first electrode layer 13.

### Third Experimental Example in the Third Embodiment

In a third experimental example of the third embodiment, the piezoelectric thin film element having the configuration described above was manufactured by sequentially forming the adhesive layer 12, the first electrode layer 13, the piezoelectric layer 14, the moisture absorption layer 218, and the second electrode layer 19 on the substrate 11 made of silicon using the sputtering method, in the same manner as in the second experimental example of the third embodiment.

First, the adhesive layer 12 was formed on the substrate 11. Using a titanium (Ti) target, the adhesive layer 12 was formed by applying high-frequency power of 100 W for one minute in an argon (Ar) gas atmosphere with a degree of vacuum of 1 Pa while heating the substrate 11 at 400° C.

Then, using a platinum (Pt) target, the first electrode layer 13 was formed by applying high-frequency power of 200 W for 12 minutes in an argon gas atmosphere with a degree of vacuum of 1 Pa while heating the substrate 11 at 400° C. The thickness of the first electrode layer 13 was 0.2 μm and the first electrode layer 13 was oriented on the (111) plane.

Then, the piezoelectric layer 14 was manufactured using a multi-sputtering apparatus in the same manner as in the first experimental example of the third embodiment. As a target of the piezoelectric layer 14, a sintered compact target of a PZT (Zr/Ti=53/47; 25 mol % of Pb is superfluous) in which the amount of Pb is more than the stoichiometric composition was used. The piezoelectric layer 14 containing a larger amount of Pb than the stoichiometric composition was formed by applying high-frequency power of 250 W for 190 minutes in a mixed-gas atmosphere (gas volume ratio of Ar:O₂=19:1), in which argon (Ar) and oxygen (O₂) are mixed and a degree of vacuum is 0.3 Pa, while heating the substrate 11 at 580° C.

Then, the moisture absorption layer 218 made of polyvinyl alcohol (PVA) was formed on the piezoelectric layer 14 using a vacuum deposition method. In order to form the moisture absorption layer 218, first, 2 g PVA was put into a crucible formed of alumina and a tungsten heater was wound around the periphery of the crucible, thereby manufacturing an evaporation source for evaporating a water-absorbing material. Then, using the evaporation source, the PVA was evaporated in the deposition rate of 0.2 nm/sec. for 25 minutes.

As a result of observation using an SEM, it was confirmed that the piezoelectric layer 14 had a columnar structure and the diameter of the columnar grain was in a range of 0.2 to 0.4 μm. The thickness of the piezoelectric layer 14 was 3.0 μm. Since the thickness of the moisture absorption layer 218 is 0.3 μm, the moisture absorption layer 218 reliably serves to absorb and hold moisture permeating in the layer thickness direction and prevent an electrochemical reaction between moisture and Pb.

The crystal structure and crystal orientation of the piezoelectric layer 14 manufactured under the above sputtering condition were tested using X-ray diffraction and sin²φ method. As a result, the obtained piezoelectric layer 14 had a rhombohedral-system perovskite type crystal structure and was oriented on the (111) plane. Furthermore, when (111) crystal orientation was measured in a state in which the piezoelectric layer 14 was formed, the (111) orientation rate was 99%.

Furthermore, using an in-process material in a state before forming the second electrode layer 19, thirty cantilevers cut in the form of a strip of paper were manufactured in a size of 10 mm×2 mm by means of dicing.

Then, the second electrode layer 19 having a thickness of 0.2 μm was formed on each of the cantilevers using the sputtering method, thereby manufacturing piezoelectric thin film element samples according to the third experimental example of the third embodiment. Here, the area of the first electrode layer 13 is larger than that of the second electrode layer 19, and the area of the moisture absorption layer 218 is larger than that of the second electrode layer 19.

Then, a voltage of DC 35 V was applied between the first electrode layer 13 and the second electrode layer 19 of the piezoelectric thin film element sample under an atmospheric-pressure dry nitrogen gas (25° C., a dew point of −40° C. or less) environment. As a result, in the case of the piezoelectric thin film element according to the experimental example, a leakage current in all of the thirty samples was 5×10⁻⁷ (A/cm²) or less.

Then, in the same manner as in the first experimental example of the third embodiment, a device of measuring a leakage current was put into a high-temperature and high-humidity layer and a voltage of DC 35 V was continuously applied for 150 hours in an atmosphere of 40° C. and 80% in order to test the change of the leakage current. As a result, in all of the thirty samples, the leakage current was 5×10⁻⁷ (A/cm²) or less, which was the same value as before the start of measurement.

From the above result, even if a layer containing a larger amount of Pb than the stoichiometric composition exists in the thickness direction between the first electrode layer 13 and the second electrode layer 19 of the piezoelectric thin film element, it is considered that the leakage current between the first electrode layer 13 and the second electrode layer 19 did not increase without a progress of reaction to the lead oxide because the moisture absorption layer 218 that absorbs the moisture is provided.

Hereinafter, the entire configuration of an ink jet head substrate according to the third embodiment 3 will be described with reference to FIGS. 2 and 3 which were used for description of the first embodiment.

The ink jet head substrate according to the third embodiment is configured to include a piezoelectric thin film element already described above. Constituent components of the ink jet head substrate will now be described briefly. In FIGS. 2 and 3, reference numeral ‘A’ denotes a pressure chamber member. The pressure chamber member A is formed with a pressure chamber opening that penetrates the pressure chamber member A in the thickness direction (up and down directions) thereof.

Reference numeral ‘B’ is a piezoelectric actuator part provided to cover an end (upper end in FIG. 3) opening of the pressure chamber opening 101, and reference numeral ‘C’ is an ink passage member provided to the other end (lower end in FIG. 3) opening of the pressure chamber opening 101. The pressure chamber opening 101 of the above pressure chamber member A is blocked by the piezoelectric actuator part B and the ink passage member C positioned thereabove and therebelow, respectively, thereby serving as the pressure chamber 102.

The piezoelectric actuator part B includes the first electrode layer 103 (individual electrode) located right above each pressure chamber 102, and a plurality of pressure chambers 102 and a plurality of first electrode layers 103 are arranged in a zigzag manner as can be seen from FIG. 2.

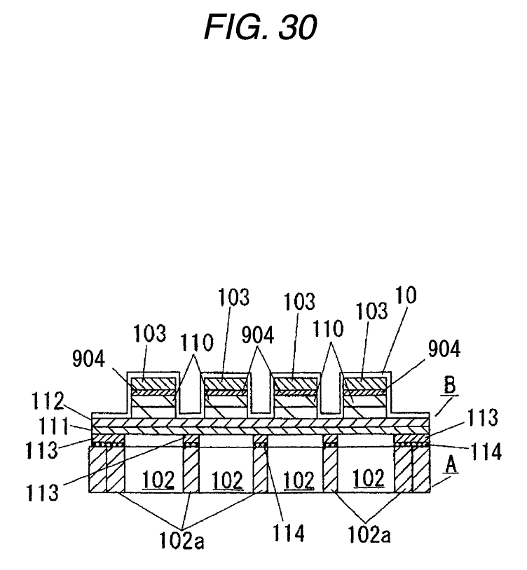

The configuration of the piezoelectric actuator part B will now be described with reference to FIG. 30.

FIG. 30 is a cross-sectional view illustrating main parts of the ink jet head substrate in the direction perpendicular to an ink supply direction (arrow X) in the third embodiment of the invention. In FIG. 30, the pressure chamber member A having four pressure chambers 102 provided in a line in the perpendicular direction and the piezoelectric actuator part B are drawn for reference.

In FIG. 30, reference numeral ‘103’ denotes a first electrode layer located right above each pressure chamber 102, as described above. Reference numeral ‘904’ denotes an orientation control layer provided on the first electrode layer 103 (lower surface of the first electrode layer 103 in FIG. 30). Reference numeral ‘110’ denotes a piezoelectric layer provided on a surface of the orientation control layer 904 (lower surface of the orientation control layer 904 in FIG. 30). Reference numeral ‘140’ denotes a barrier layer that is inserted and laminated into the piezoelectric layer 110. Reference numeral ‘112’ denotes a second electrode layer (common electrode) that is provided on a surface of the piezoelectric layer 110 (lower surface of the second piezoelectric layer 110 in FIG. 30) and is common to all the piezoelectric layers 110.

Reference numeral ‘111’ denotes a vibrating plate layer that is provided on a surface of the second electrode layer 112 (lower surface of the second electrode layer 112 in FIG. 30) and that is displaced in the layer thickness direction due to a piezoelectric effect of the piezoelectric layer 110 so as to vibrate. Reference numeral ‘113’ is an intermediate layer (longitudinal wall) that is provided on a surface of the vibrating plate layer 111 (lower surface of the vibrating plate layer 111 in FIG. 30) and that is located above each of the partition walls 102a serving to separate the pressure chambers 102 from each other.

The first electrode layer 103, the orientation control layer 904, the piezoelectric layer 110, the barrier layer 140 that is inserted and laminated into the piezoelectric layer 110, and the second electrode layer 112 are laminated in this order, thereby forming a piezoelectric thin film element. In addition, the vibrating plate layer 111 is provided on a surface of the second electrode layer 112. In addition, a protective layer 10 is formed to cover the whole constituent components.

Furthermore, in FIG. 30, reference numeral ‘114’ denotes an adhesive for bonding the pressure chamber member A and the piezoelectric actuator part B to each other. When bonding the pressure chamber member A and the piezoelectric actuator part B to each other using the adhesive 114, the intermediate layer 113 serves to secure a distance between an upper surface of the pressure chamber 102 and a lower surface of the vibrating plate layer 111 such that the adhesive 114 is not attached to the vibrating plate layer 111 and the vibrating plate layer 111 performs the same displacement and vibration as in the initial state, even if a part of the adhesive 114 overflows into the outside of the partition wall 102a.

Thus, it is preferable that the pressure chamber member A be bonded to a surface of the vibrating plate layer 111 of the piezoelectric actuator part B not facing the second electrode layer 112 with the intermediate layer 113 interposed therebetween. However, the pressure chamber member A may be directly bonded to the surface of the vibrating plate layer 111 not facing the second electrode layer 112.

A material used to form each of the first electrode layer 103, the piezoelectric layer 110, the barrier layer 140, and the second electrode layer 112 is the same as that of each of the first electrode layer 13, the piezoelectric layer 14, the barrier layer 215, and the second electrode layer 19, which was already explained (content of elements may be different). In addition, the structure of each of the piezoelectric layer 110 and the barrier layer 140 is also the same as that of each of the piezoelectric layer 14 and the barrier layer 215.

The ink channel member C includes a common fluid chamber 105 shared between the pressure chambers 102 provided in a line in the ink supply direction, a supply port 106 for supplying ink in the common fluid chamber 105 to the pressure chambers 102, and an ink passage 107 used to discharge ink in the pressure chambers 102.

Reference numeral ‘D’ denotes a nozzle plate, and the nozzle hole 108 communicating with the ink passage 107 is formed in the nozzle plate D. In addition, reference numeral ‘E’ denotes an IC chip, and a voltage is supplied from the IC chip E to the first electrode layer (individual electrode) 103 through the bonding wire BW.

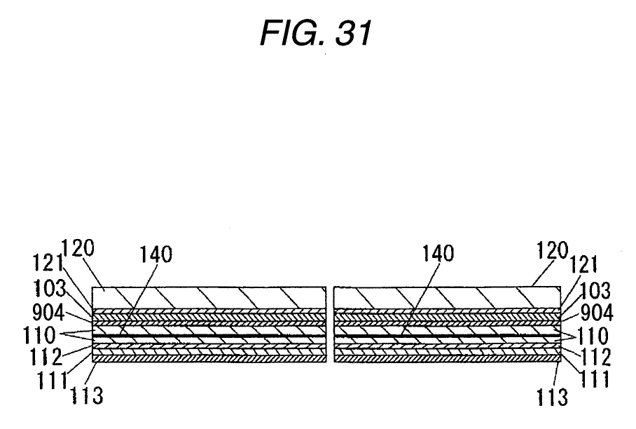

Next, a method of manufacturing the ink jet head substrate excluding the IC chip E shown in FIG. 2, that is, the ink jet head substrate configured to include the pressure chamber member A, the piezoelectric actuator part B, the ink passage member C, and the nozzle plate D shown in FIG. 3 will be described with reference to FIGS. 31 to 43.

FIG. 31 is a cross-sectional view illustrating a laminating process of the ink jet head substrate according to the third embodiment of the invention.

First, as shown in FIG. 31, the adhesive layer 121, the first electrode layer 103, the piezoelectric layer 110, the barrier layer 140 that is inserted and laminated into the piezoelectric layer 110, the second electrode layer 112, the vibrating plate layer 111, and the intermediate layer 113 are sequentially laminated on the substrate 120 using the sputtering method. In addition, in the same manner as the adhesive layer 12 that was already described above, the adhesive layer 121 is provided between the substrate 120 and the first electrode layer 103 in order to improve adhesion between the substrate 120 and the first electrode layer 103. Therefore, the adhesive layer 121 may not be necessarily formed. The adhesive layer 121 is removed in the same manner as the substrate 120, which will be described later.

A silicon (Si) substrate cut to have a size of 18 mm square is used as the substrate 120. The substrate 120 is not limited to the Si substrate. For example, a glass substrate, a metallic substrate, or a ceramic substrate may be used as the substrate 120. In addition, the substrate size is not limited to 18 mm square. In the case of the Si substrate, a wafer having a diameter of 2 to 10 inches may be used.

Using a titanium (Ti) target, the adhesive layer 121 was formed by applying high-frequency power of 100 W for one minute in an argon (Ar) gas atmosphere with a degree of vacuum of 1 Pa while heating the substrate 120 at 400° C.

The thickness of the adhesive layer 121 is set to 0.02 μm, for example. In addition, a material of the adhesive layer 121 is not limited to titanium. For example, tantalum, iron, cobalt, nickel, chromium, or a compound (containing Ti) thereof may be used. It is preferable that the thickness of the adhesive layer 121 be in a range of 0.005 to 0.2 μm.

Then, using a Pt target, the first electrode layer 103 was formed by applying high-frequency power of 200 W for 12 minutes in an argon gas atmosphere with a degree of vacuum of 1 Pa while heating the substrate 120 at 600° C. The thickness of the first electrode layer 103 is 0.2 μm, for example, and the first electrode layer 103 is oriented on the surface (111) plane. As a material of the first electrode layer 103, at least one precious metal selected from a group of platinum, iridium, palladium, and ruthenium or a compound thereof may be used. Furthermore, it is preferable that the thickness of the first electrode layer 103 be in a range of 0.05 to 2 μm.

The orientation control layer 904 is formed of PLZT ((Pb_{0.9}La_{0.1})(Zr_{0.52}Ti_{0.48})O₃) that is a part (A site of Pb is replaced by La) of PZT or lead zirconate (PbZrO₃). In addition, a material obtained by replacing a part of PZT with another element may also be used. The orientation control layer 904 is formed using the sputtering method in which, for example, a sintered compact target is used. For example, the orientation control layer 904 was formed by applying high-frequency power of 150 W for 10 minutes in a mixed-gas atmosphere (gas volume ratio of Ar:O₂=19:1), in which argon (Ar) and oxygen (O₂) are mixed and a degree of vacuum is 0.3 Pa, while keeping the substrate temperature at 600° C.

Further, the piezoelectric layer 110 was manufactured using a multi-sputtering apparatus. A method of manufacturing the piezoelectric layer 110 or a sputtering condition is the same as that in the first experimental example of the third embodiment. In addition, the Zr/Ti composition of the piezoelectric layer 110 may be preferably in a range of 30/70 to 70/30. Furthermore, it is preferable that the thickness of the piezoelectric layer 110 be in a range of 1 to 5 μm. In addition, as a material of the piezoelectric layer 110, a piezoelectric material containing PZT as a main component, for example, a material obtained by adding an additive, such as La, Sr, Nb, and Al, in PZT, may preferably be used. In addition, PMN or PZN may also be used.

The barrier layer 140 is formed by using titanium (Ti) and platinum (Pt) in a sputtering apparatus. The material of the barrier layer 140 is not limited to Ti or Pt as long as a metal layer having an enough thickness to block moisture is used. In addition, a single layer, a laminated layer, or an alloy containing two or more kinds of metal may be used to form the barrier layer 140. The material of the barrier layer 140 is not limited to titanium. For example, tantalum, iron, cobalt, nickel, chromium, or a compound thereof, preferably, at least one precious metal selected from a group of iridium, palladium, and ruthenium or a compound thereof may also be used as the material of the barrier layer 140. Furthermore, it is preferable that the thickness of the barrier layer 140 be in a range of 0.05 to 3 um.

Using a Pt target, the second electrode layer 112 is obtained by applying high-frequency power of 200 W for 10 minutes in an argon gas atmosphere with a degree of vacuum of 1 Pa while keeping the room temperature. The thickness of the second electrode layer 112 is set to 0.2 μm, for example. In addition, the material of the second electrode layer 112 is not limited to Pt. For example, a conductive material may be used. Moreover, it is preferable that the thickness of the second electrode layer 112 be in a range of 0.1 to 0.4 um.

Using a chromium (Cr) target, the vibrating plate layer 111 is obtained by applying high-frequency power of 200 W for 6 hours in an argon gas atmosphere with a degree of vacuum of 1 Pa while keeping the room temperature. The thickness of the vibrating plate layer 111 is set to 3 μm, for example. The material of the vibrating plate layer 111 is not limited to chromium. For example, nickel, aluminum, tantalum, tungsten, silicon, an oxide thereof, or a nitride thereof (for example, silicon dioxide, aluminum oxide, zirconium oxide, or silicon nitride) may be used. In addition, it is preferable that the thickness of the vibrating plate layer 111 be in a range of 2 to 5 μm.

Using a titanium (Ti) target, the intermediate layer 113 is obtained by applying high-frequency power of 200 W for 5 hours in an argon gas atmosphere with a degree of vacuum of 1 Pa while keeping the room temperature. The thickness of the intermediate layer 113 is set to 5 μm, for example. The material of the intermediate layer 113 is not limited to titanium. For example, a conductive material, such as chromium (Cr), may be used. In addition, it is preferable that the thickness of the intermediate layer 113 be in a range of 3 to 10 μm.

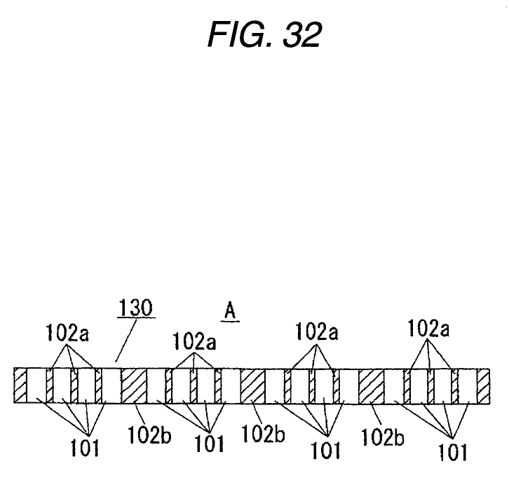

FIG. 32 is a cross-sectional view illustrating a process of forming a pressure chamber opening of the ink jet head substrate according to the third embodiment of the invention.

As shown in FIG. 32, the pressure chamber member A is formed. The pressure chamber member A is formed using, for example, the silicon substrate 130 (refer to FIG. 10 described in the first embodiment) using a 4-inch wafer, which is larger than the substrate 120. Specifically, first, the plurality of pressure chamber openings 101 are patterned on the substrate 130 (for pressure chamber member). As shown in FIG. 32, in the patterning, four pressure chamber openings 101 are set as a group, and the width of a partition wall 102b serving to separate a group from another group is set to about twice that of the partition wall 102a serving to separate the pressure chamber openings 101 within each group from each other. Then, the patterned substrate 130 is processed using chemical etching or dry etching in order to form four pressure chamber openings 101 in each group, thereby obtaining the pressure chamber member A.

Thereafter, the substrate 120 (for film formation) after the above film formation and the pressure chamber member A are bonded to each other using an adhesive. Formation of the adhesive is based on electrodeposition.

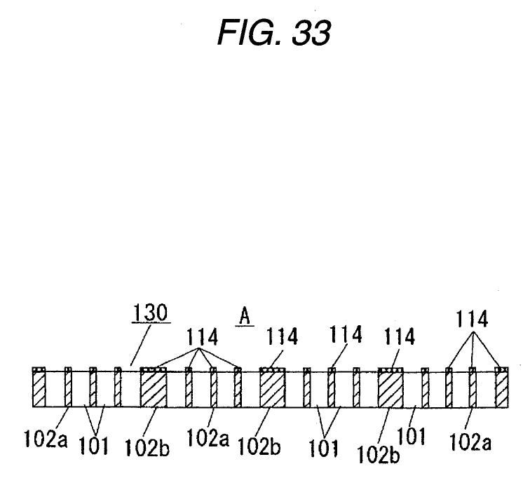

FIG. 33 is a cross-sectional view illustrating an adhesive bonding process in the ink jet head substrate according to the third embodiment of the invention.

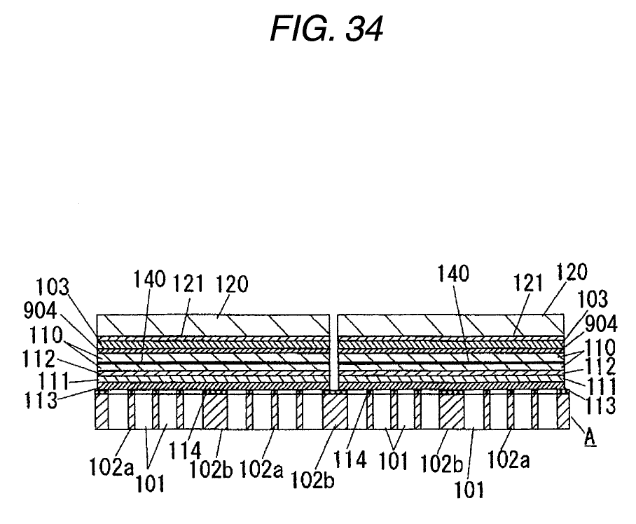

FIG. 34 is a cross-sectional view illustrating a process of bonding a substrate after film formation and a pressure chamber member to each other in the ink jet head substrate according to the third embodiment of the invention.

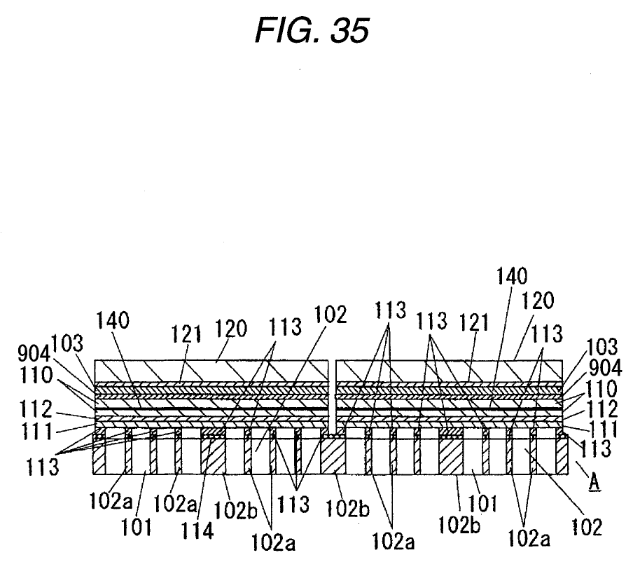

FIG. 35 is a cross-sectional view illustrating a process of forming a longitudinal wall in the ink jet head substrate according to the third embodiment of the invention.

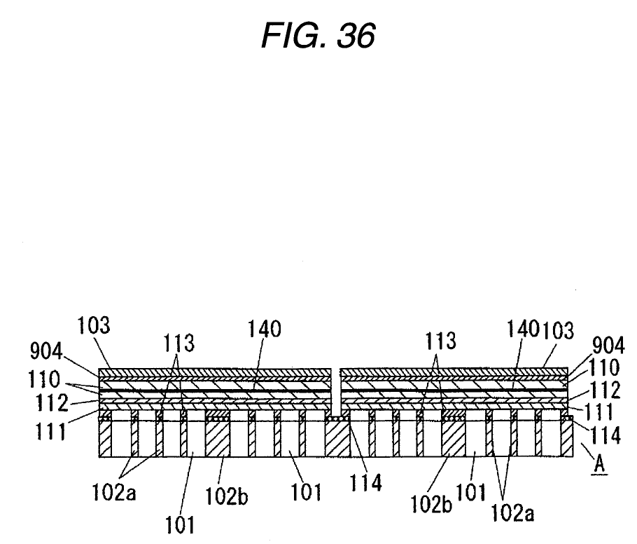

FIG. 36 is a cross-sectional view illustrating a process of removing a substrate (for film formation) and an adhesive layer in the ink jet head substrate according to the third embodiment of the invention.

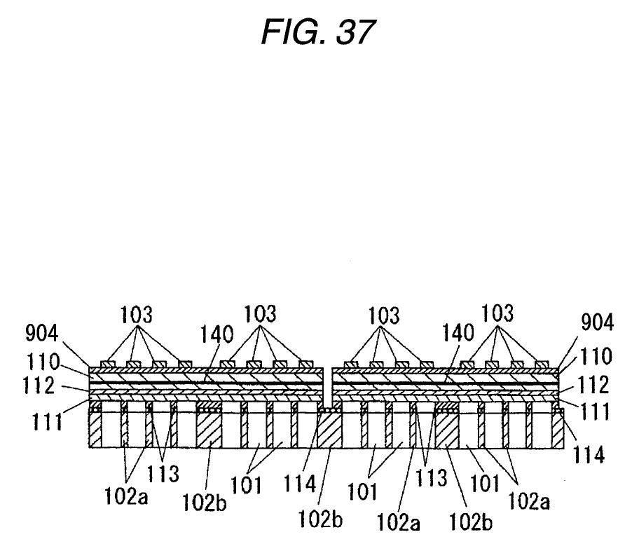

FIG. 37 is a cross-sectional view illustrating a process of separating a first electrode layer into individual parts in the ink jet head substrate according to the third embodiment of the invention.

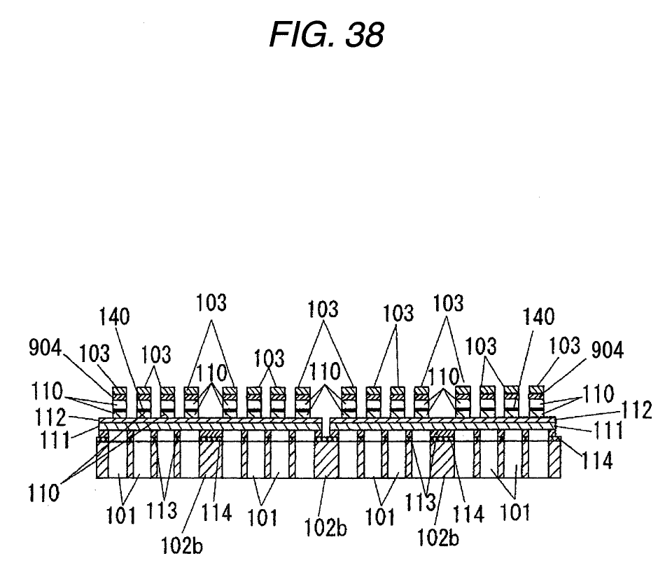

FIG. 38 is a cross-sectional view illustrating a process of separating a piezoelectric layer into individual parts in the ink jet head substrate according to the third embodiment of the invention.

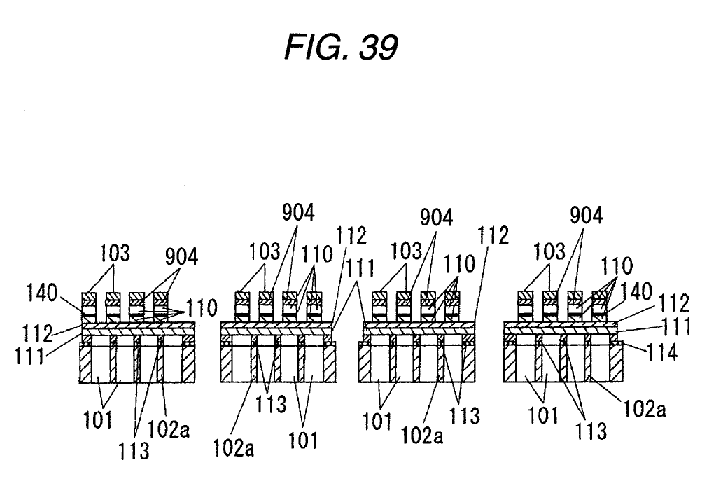

FIG. 39 is a cross-sectional view illustrating a process of cutting a substrate (for pressure chamber member) in the ink jet head substrate according to the third embodiment of the invention.

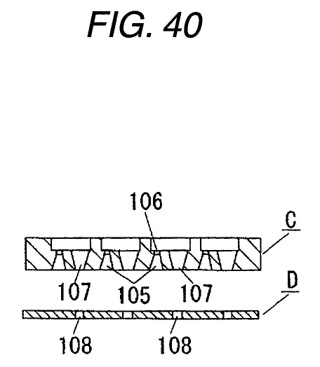

FIG. 40 is a cross-sectional view illustrating a process of generating an ink passage member and a nozzle plate in the ink jet head substrate according to the third embodiment of the invention.

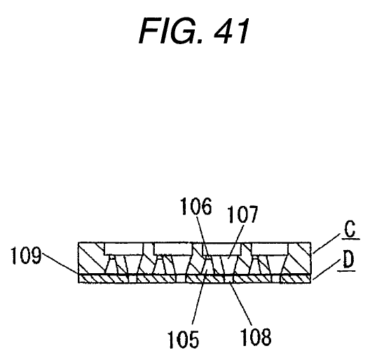

FIG. 41 is a cross-sectional view illustrating a process of bonding the ink passage member and the nozzle plate to each other in the ink jet head substrate according to the third embodiment of the invention.

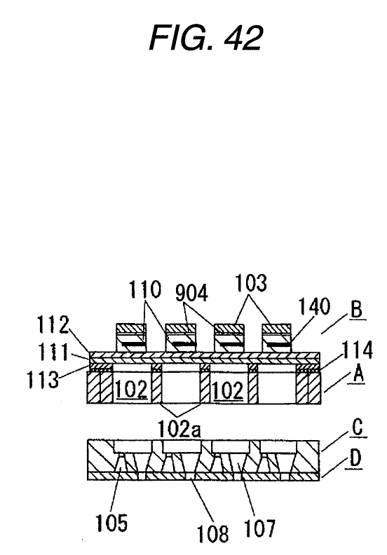

FIG. 42 is a cross-sectional view illustrating a process of bonding the pressure chamber member and the ink passage member to each other in the ink jet head substrate according to the third embodiment of the invention.

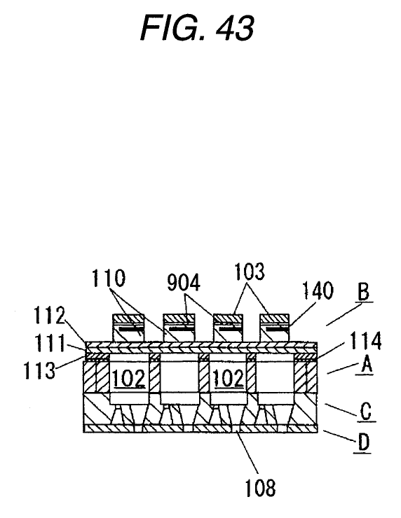

FIG. 43 is a cross-sectional view illustrating a state in which the ink jet head substrate according to the third embodiment of the invention is completed.

Hereinafter, a method of manufacturing the ink jet head according to the third embodiment will be described with reference to FIGS. 33 to 43.

First, as shown in FIG. 33, the adhesive 114 is bonded to top surfaces, which serve as bonding surfaces of the pressure chamber member A, of the partition walls 102a and 102b of pressure chambers by means of electrodeposition.

Specifically, although not shown, an Ni thin film having a thickness of several tens of angstrom, which is so thin that light is transmitted therethrough, is formed as a lower electrode layer on the top surfaces of the partition walls 102a and 102b using the sputtering method and then the patterned adhesive 114 is formed on the Ni thin film. At this time, as electrodeposition liquid, a solution obtained by adding 0 to 50 parts by weight of pure water in acrylic resin based water dispersion liquid and agitating and mixing them well is used.

In addition, the reason why the thickness of the Ni thin film is set to be so thin that light can be transmitted therethrough is to make it easy to check whether or not the substrate 13 (for pressure chamber member) and a bonding resin are completely bonded to each other. According to the experiment, as preferable electrodeposition conditions, the temperature is about 25° C., a DC voltage is 30 V, and a power supply time is 60 seconds. Under these conditions, an acrylic resin having a thickness of about 3 to 10 μm is formed on the nickel (Ni) thin film of the substrate 130 (for pressure chamber member) by using an electrodeposition method.

As shown in FIG. 34, the pressure chamber member A and the substrate 120 (for film formation) on which the individual layers are laminated are bonded to each other using the electrodeposited adhesive 114. This bonding is performed by using the intermediate layer 113, which is formed on the substrate 120 (for film formation), as a substrate-side bonding surface. In addition, the substrate 120 (for film formation) is 18 mm in size and the substrate 130 used to form the pressure chamber member A is 4 inches in size, which is large. Accordingly, as shown in FIG. 10, a plurality of substrates 120 (for film formation) (14 substrates 120 in the drawing) are bonded to one pressure chamber member A (substrate 130). This bonding is performed in a state in which a center of each substrate 120 (for film formation) is positioned at a center of the partition wall 102b of the pressure chamber member A, as shown in FIG. 34A. After the bonding, the pressure chamber member A is pressed against the substrate 120 (for film formation) so as to be adhered to the substrate 120 (for film formation), such that the pressure chamber member A and the substrate 120 (for film formation) are bonded to each other with improved liquid tightness.

Then, the pressure chamber member A and the substrate 120 (for film formation) that are bonded to each other are gradually heated in a heating furnace, such that the adhesive 114 is completely cured. Then, a plasma treatment is performed to remove protruding fractions from the adhesive 114.

Furthermore, even though the substrate 120 (for film formation) after forming the individual layers and the pressure chamber member A were bonded to each other in FIG. 34, the substrate 130 (for pressure chamber member) in which the pressure chamber openings 101 are not formed may be bonded to the substrate 120 (for film formation) after the film formation.

Thereafter, as shown in FIG. 35, the intermediate layer 113 is etched by using the partition walls 102a and 102b of the pressure chamber member A as a mask and is then processed to have a predetermined shape (that is, the etched intermediate layer 113 have a shape (shape of a longitudinal wall) running continuously on the partition walls 102a and 102b).

As shown in FIG. 36, the substrate 120 (for film formation) and the adhesive layer 121 are etched to be removed.

Thereafter, as shown in FIG. 37, the first electrode layer 103 located on the pressure chamber member A is etched using a photolithographic technique, such that the first electrode layer 103 is separated into individual parts corresponding to each pressure chamber 102.

Then, as shown in FIG. 38, the orientation control layer 904, the piezoelectric layer 110, and the barrier layer 140 are etched using the photolithography technique, such that the first electrode layer 103 is separated into individual parts in the same manner as the first electrode layer 103.

After performing the etching, the first electrode layer 103, the orientation control layer 904, the piezoelectric layer 110, and the barrier layer 140 are positioned above each pressure chamber 102 and are formed such that centers of the first electrode layer 103 and the piezoelectric layer 110 in the width direction thereof match the center of the corresponding pressure chamber 102 in the width direction thereof with high precision. In addition, the etched shape is a forward tapered shape (not shown), that is, the width of the nozzle hole 108 is smaller than that of the barrier layer 140. Thereafter, the first electrode layer 103 may be formed to have a predetermined size using the photolithographic method again. Since the area of the barrier layer 140 is larger than that of the first electrode layer 103, a more satisfactory effect is achieved.

Thus, after separating each of the first electrode layer 103, the orientation control layer 904, the piezoelectric layer 110, and the piezoelectric layer 140 into individual parts for each pressure chamber 102, as shown in FIG. 39, the substrate 130 (pressure chamber member) is cut with the individual partition walls 102b as a reference such that four pairs of pressure chamber members A and actuator parts B are completed, the pressure chamber member A having four pressure chambers 102 and the actuator part B being fixed on a top surface of the pressure chamber member A.

Subsequently, as shown in FIG. 40, the common fluid chamber 105, the supply port 106, and the ink passage 107 are formed in the ink channel member C and the nozzle hole 108 is formed in the nozzle plate D. Then, as shown in FIG. 41, the ink channel member C and nozzle plate D are bonded to each other using the adhesive 109.

Then, as shown in FIG. 42, an adhesive (not shown) is transferred onto a lower end surface of the pressure chamber member A or an upper end surface of the ink channel member C, an alignment adjustment between the pressure chamber member A and the ink channel member C is performed, and the pressure chamber member A and the ink channel member C are bonded to each other using the adhesive. As a result, as shown in FIG. 43, an ink jet head substrate including the pressure chamber member A, the actuator part B, the ink channel member C, and nozzle plate D is completed.

A 20 V AC voltage having a frequency of 20 kHz was continuously applied, for 10 days, between the first electrode layer 103 and the second electrode layer 112 of the ink jet head substrate obtained as described above under an environment of 40° C. and 80%. As a result, there was no ink discharge failure in the ink jet head substrate, and deterioration of discharge performance was not also observed.

On the other hand, an ink jet head substrate, which is different from the ink jet head substrate according to the third embodiment of the invention in that a piezoelectric layer has only a first piezoelectric layer 14a containing a larger amount of Pb than the stoichiometric composition, was manufactured and then a 20 V AC voltage having a frequency of 20 kHz was continuously applied, for 10 days, between the first electrode layer 103 and the second electrode layer 112 of the ink jet head substrate under the environment of 40° C. and 80%. As a result, an ink discharge failure occurred in portions corresponding to about 40% of all of the pressure chambers 102. Since this was not caused by clogging of ink, it is considered that a leakage current was generated in the actuator part B (piezoelectric thin film element).

As described in detail above, the third embodiment includes the following invention.

The piezoelectric thin film element according to the third embodiment is configured to include: a first electrode layer; a second electrode layer; a piezoelectric layer that is provided between the first electrode layer and the second electrode layer and contains lead; and a barrier layer that serves to block moisture and is provided at least a part within the piezoelectric layer, between the first electrode layer and the piezoelectric layer, and between the second electrode layer and the piezoelectric layer. Accordingly, the electrochemical reaction of lead and moisture is stopped due to the barrier layer formed of the metal thin film, such that an insulation performance of the piezoelectric layer is satisfactorily maintained.

Further, in the piezoelectric thin film element according to the third embodiment, the area of the barrier layer is set to be larger than that of at least one of the first electrode layer and the second electrode layer. Accordingly, a leak path connecting between the first electrode layer and the second electrode layer is not created since the area of the barrier layer is larger than that of at least one of the first electrode layer and the second electrode layer.

Furthermore, in the piezoelectric thin film element according to the third embodiment, the barrier layer is formed of a thin film using platinum group metals or a compound thereof. Accordingly, it becomes possible to make the barrier layer thin and the crystal growth of thin layers that form the piezoelectric layer becomes easy. As a result, deterioration of characteristics due to a decrease in the amount of lead, which is caused by electrochemical reaction of lead and moisture, is suppressed to the minimum.

Furthermore, in the piezoelectric thin film element according to the third embodiment, in the case when the barrier layer is provided within the piezoelectric layer, a preferential orientation surface of each of the piezoelectric layers divided by the barrier layer is equal. Accordingly, since a characteristic of each of the piezoelectric layers do not deteriorate, a piezoelectric thin film element having a more improved characteristic is formed.

Furthermore, in the piezoelectric thin film element according to the third embodiment, the barrier layer is formed of an inorganic material. Accordingly, physical characteristics and process consistency with respect to the piezoelectric layer are satisfactorily adjusted while maintaining a moisture-blocking property.

Furthermore, in the piezoelectric thin film element according to the third embodiment, an inorganic material not containing lead is used. Accordingly, since the barrier layer does not contain a lead compound that electrochemically reacts with moisture, a lead dioxide having a conductive property is not formed and an insulating property of the piezoelectric layer is satisfactorily maintained.

Furthermore, in the piezoelectric thin film element according to the third embodiment, the barrier layer is formed of a moisture-proof material whose coefficient of water absorption is in a range of 0 to 0.1%. Accordingly, since permeation of moisture is satisfactorily prevented due to the barrier layer, reliability in blocking moisture is improved.

In addition, the piezoelectric thin film element according to the third embodiment is configured to include: a first electrode layer; a second electrode layer; a piezoelectric layer that is provided between the first electrode layer and the second electrode layer and contains lead; and a moisture absorption layer that serves to absorb moisture and is provided at least a part between the first electrode layer and the piezoelectric layer and between the second electrode layer and the piezoelectric layer. Accordingly, even if moisture permeates into a crystal grain boundary of the piezoelectric thin film through a pinhole of the electrode layer, the moisture is held in the moisture absorption layer and the permeation of moisture in the layer thickness direction does not further progress. As a result, the insulation performance of the piezoelectric layer is maintained.

In addition, in the piezoelectric thin film element according to the third embodiment, the area of the moisture absorption layer is set to be larger than that of at least one of the first electrode layer and the second electrode layer. Accordingly, a leak path connecting between the first electrode layer and the second electrode layer is not created.

In addition, in the piezoelectric thin film element according to the third embodiment, the moisture absorption layer is formed of an organic material whose coefficient of water absorption is equal to or larger than 1% and less than 100%. Accordingly, the moisture absorption layer absorbs moisture more efficiently and holds a moisture absorption property. As a result, the insulation performance of the piezoelectric layer is satisfactorily maintained.

Furthermore, the piezoelectric thin film element according to the third embodiment is configured to include: a first electrode layer; a second electrode layer; a piezoelectric layer that is provided between the first electrode layer and the second electrode layer and contains lead; a barrier layer that serves to block moisture and is provided at least a part within the piezoelectric layer, between the first electrode layer and the piezoelectric layer, and between the second electrode layer and the piezoelectric layer; and a moisture absorption layer that serves to absorb moisture and is provided at least a part between the first electrode layer and the piezoelectric layer and between the second electrode layer and the piezoelectric layer. Accordingly, the insulation performance of the piezoelectric layer is maintained for a long time.

Furthermore, in the piezoelectric thin film element according to the third embodiment, the area of the barrier layer is set to be larger than that of at least one of the first electrode layer and the second electrode layer. Accordingly, a leak path connecting between the first electrode layer and the second electrode layer is not created since the area of the barrier layer is larger than that of at least one of the first electrode layer and the second electrode layer.

Furthermore, in the piezoelectric thin film element according to the third embodiment, the barrier layer is formed of a thin film using platinum group metals or a compound thereof. Accordingly, it becomes possible to make the barrier layer thin and the crystal growth of thin layers that form the piezoelectric layer becomes easy. As a result, deterioration of characteristics due to a decrease in the amount of lead, which is caused by electrochemical reaction of lead and moisture, is suppressed to the minimum.

Furthermore, in the piezoelectric thin film element according to the third embodiment, in the case when the barrier layer is provided within the piezoelectric layer, a preferential orientation surface of each of the piezoelectric layers divided by the barrier layer is equal. Accordingly, since a characteristic of each of the piezoelectric layers do not deteriorate, a piezoelectric thin film element having a more improved characteristic is formed.

Furthermore, in the piezoelectric thin film element according to the third embodiment, the area of the moisture absorption layer is set to be larger than that of at least one of the first electrode layer and the second electrode layer. Accordingly, a leak path connecting between the first electrode layer and the second electrode layer is not created.

Furthermore, in the piezoelectric thin film element according to the third embodiment, the moisture absorption layer is formed of an organic material whose coefficient of water absorption is 1% or more. Accordingly, the moisture absorption layer absorbs moisture more efficiently and holds a moisture absorption property, and the permeation of moisture in the layer thickness direction does not further progress. As a result, the insulation performance of the piezoelectric layer is satisfactorily maintained.

Furthermore, in the piezoelectric thin film element according to the third embodiment, the barrier layer or the moisture absorption layer is formed using a vapor deposition method. Accordingly, since moisture is not absorbed at the time of forming the barrier layer or the moisture absorption layer, precision of the layer thickness or uniformity of a layer is improved. As a result, the reliability is further improved.

In addition, the ink jet head according to the third embodiment includes: a main head body having a pressure chamber that serves to discharge supplied ink through an opening by means of change of a pressure; and a piezoelectric vibrator that is provided on a surface of the pressure chamber in the main head body and applies a pressure to the pressure chamber. In addition, the piezoelectric vibrator includes the piezoelectric thin film element described above and a vibrating plate that is provided on a surface located at a side of any electrode of the piezoelectric thin film element. Since the ink jet head according to the third embodiment includes the piezoelectric thin film element, the ink jet head shows satisfactory reliability under a high humidity environment.

In addition, the ink jet recording apparatus according to the third embodiment includes the ink jet head mounted therein. Since the ink jet recording apparatus according to the third embodiment includes the ink jet head, the ink jet recording apparatus shows satisfactory reliability under the high humidity environment.

### Fourth Embodiment

In a fourth embodiment, an example of the configuration of an ink jet type recording apparatus, to which the piezoelectric thin film element described in detail in the first, second, and third embodiments is applied, will be described.

Specifically, the ink jet type recording apparatus includes: an ink jet head to which the piezoelectric thin film element having a multi-layered piezoelectric thin film (piezoelectric layer) described in the first to third embodiments is applied; and a relative movement unit that causes the ink jet head to relatively move with respect to a recording medium such as recording paper. In the ink jet type recording apparatus, while the ink jet head is relatively moving with respect to the recording medium by means of the relative movement unit, ink in a pressure chamber is discharged from a nozzle hole, which is provided to communicate with the pressure chamber in the ink jet head, and thus recording is performed. Hereinafter, a specific example of the configuration will be described.

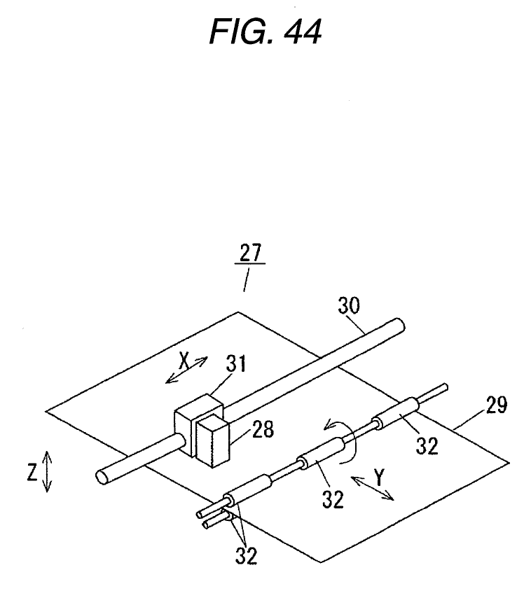

FIG. 44 is a perspective view schematically illustrating the configuration of an ink jet type recording apparatus according to the fourth embodiment of the invention.

An ink jet type recording apparatus 27 shown in FIG. 44 includes an ink jet head 28 configured to include the piezoelectric thin film element described in detail in the first to third embodiments. The ink jet head 28 is configured to perform recording by causing ink in a pressure chamber (pressure chamber 102 (for example, refer to FIG. 3)) to be discharged from a nozzle hole (nozzle hole 108 (for example, refer to FIG. 3), which is provided to communicate with the pressure chamber, onto a recording medium 29, such as recording paper.

The ink jet head 28 is mounted in a carriage 31 provided on a carriage shaft 30 extending in a main scanning direction X and reciprocates in the main scanning direction X as the carriage 31 reciprocates along the carriage shaft 30. In such a manner, the carriage 31 serves as a relative movement unit that causes the ink jet head 28 and the recording medium 29 to relatively move in the main scanning direction X.

In addition, the ink jet type recording apparatus 27 includes a plurality of rollers 32 serving to move the recording medium 29 in a sub-scanning direction Y approximately perpendicular to the main scanning direction X (width direction) of the ink jet head 28. In such a manner, the plurality of rollers 32 serve as a relative movement unit that causes the ink jet head 28 and the recording medium 29 to relatively move in the sub-scanning direction X. In FIG. 44, reference numeral ‘Z’ denotes a vertical direction.

The relative movement unit is controlled such that one-scan recording is completed by discharging ink from a nozzle hole (not shown) of the ink jet head 28 onto the recording medium 29 while the ink jet head 28 is moving in the main scanning direction X by means of the carriage 31 and then the recording medium 29 is moved by a predetermined amount in the Y direction by means of the rollers 32 so as to perform next one-scan recording.

Thus, since the ink jet type recording apparatus according to the fourth embodiment includes the ink jet head configured to include the piezoelectric thin film (piezoelectric layer) described in the first to third embodiments, a satisfactory printing performance and durability are achieved in the ink jet type recording apparatus according to the fourth embodiment.

Hereinbefore, the first to fourth embodiments of the invention have been described in detail.

In any of the first to third embodiments described above, the piezoelectric thin film element is configured to include a plurality of piezoelectric layers. The first to third embodiments may be applied in combination with each other. For example, it may be possible to apply a structure obtained by adding a second piezoelectric layer, which is made of an electrically insulating oxide to embed a hole of the first piezoelectric layer described in the second embodiment, in the three or more layered structure described in the first embodiment or a structure obtained by adding the barrier layer described in the third embodiment in the three or more layered structure described in the first embodiment. It is needless to say that the second and third embodiments can be applied in combination with each other. Furthermore, an ink jet head configured to include a piezoelectric thin film element, which is formed by combination of the embodiments, may be easily obtained and an ink jet type recording apparatus having the ink jet head mounted therein may also be easily obtained.

As mentioned above, the piezoelectric thin film element according to any one of the embodiments of the invention is most suitably applied to an ink jet head and an ink jet recording apparatus. In addition to the ink jet head and the ink jet type recording apparatus, the piezoelectric thin film element according to any one of the embodiments of the invention may also be applied to a thin film capacitor, a charge storage capacitor of a nonvolatile memory device, various kinds of actuators, an infrared sensor, an ultrasonic sensor, a pressure sensor, an angular velocity sensor, an acceleration sensor, a flow rate sensor, a shock sensor, a piezoelectric transformer, a piezoelectric ignition device, a piezoelectric speaker, a piezoelectric microphone, a piezoelectric filter, a piezoelectric pickup, a sound vibrator, a delay line, and the like. In particular, the piezoelectric thin film element according to any one of the embodiments of the invention may be suitably applied to a thin-film piezoelectric actuator (for example, refer to Patent Document 5) for disk device that deforms a substrate by means of a piezoelectric thin film element provided on the substrate such that the a head is displaced, in a head supporting mechanism where the head, which performs recording or reproduction of information with respect to a disk rotatably driven in a disk device (for example, disk device used as a storage device of a computer), is provided on the substrate.

This application is based upon and claims the benefit of priority of Japanese Patent Application No 2006-201582 filed on Jun. 7, 1925, Japanese Patent Application No 2006-214116 filed on Jun. 8, 2007, Japanese Patent Application No 2006-245225 filed on Jun. 9, 1911, the contents of which are incorporated herein by reference in its entirety.

1. A piezoelectric thin film element comprising:
a piezoelectric body; and
a pair of electrodes provided on both sides of the piezoelectric body in the thickness direction thereof,
wherein the piezoelectric body is configured to include three or more piezoelectric layers, and
a piezoelectric constant of each of the piezoelectric layers that are in contact with the electrodes is set to be smaller than that of each of the piezoelectric layers that are not in contact with the electrodes.

2. The piezoelectric thin film element according to claim 1, wherein a relative permittivity of each of the piezoelectric layers that are in contact with the electrodes is set to be smaller than that of each of the piezoelectric layers that are not in contact with the electrodes.

3. The piezoelectric thin film element according to claim 1, wherein the thickness of each of the piezoelectric layers that are in contact with the electrodes is set to be smaller than that of each of the piezoelectric layers that are not in contact with the electrodes.

4. The piezoelectric thin film element according to claim 3, wherein the thickness of each of the piezoelectric layers that are not in contact with the electrodes is in a range of 1 μm to 10 um.

5. A piezoelectric thin film element comprising:
a piezoelectric layer formed of an oxide that has a perovskite type crystal structure and contains Pb; and
electrode layers formed on both surfaces of the piezoelectric layer in the thickness direction thereof,
wherein the piezoelectric layer is configured to include three piezoelectric layers of first, second, and third piezoelectric layers provided from one of the electrode layers toward the other electrode layer, and
composition of the oxide applied to each of the piezoelectric layers is selected such that a piezoelectric constant of each of the first and third piezoelectric layers facing the electrode layers is smaller than that of the second piezoelectric layer.

6. The piezoelectric thin film element according to claim 5, wherein a relative permittivity of each of the first and third piezoelectric layers is set to be smaller than that of the second piezoelectric layer.

7. The piezoelectric thin film element according to claim 5, wherein the thickness of each of the first and third piezoelectric layers is set to be smaller than that of the second piezoelectric layer.

8. The piezoelectric thin film element according to claim 7,
wherein the thickness of the second piezoelectric layer is in a range of 1 μm to 10 um.

9. The piezoelectric thin film element according to claim 1,
wherein all of the piezoelectric layers are preferentially oriented on the same plane of either a (111) plane or a (001) plane.

10. An ink jet head comprising:
the piezoelectric thin film element according to claim 1;
a vibrating plate layer provided on a surface of one of the electrode layers of the piezoelectric thin film element; and
a pressure chamber that is bonded to a surface of the vibrating plate layer not facing the piezoelectric thin film element and performs ink discharge corresponding to displacement of the vibrating plate layer due to a piezoelectric effect of the piezoelectric thin film element.

11. An ink jet type recording apparatus comprising:
the ink jet head according to claim 10;
a relative movement unit that causes the ink jet head to relatively move with respect to a recording medium; and
a driving unit that drives the piezoelectric thin film element such that recording is performed by discharging ink in the pressure chamber through a nozzle hole, which is provided to communicate with the pressure chamber in the ink jet head, while the ink jet head is relatively moving with respect to the recording medium by means of the relative movement unit.

12. The piezoelectric thin film element according to claim 5,
wherein all of the piezoelectric layers are preferentially oriented on the same plane of either a (111) plane or a (001) plane.

13. An ink jet head comprising:
the piezoelectric thin film element according to claim 5;
a vibrating plate layer provided on a surface of one of the electrode layers of the piezoelectric thin film element; and
a pressure chamber that is bonded to a surface of the vibrating plate layer not facing the piezoelectric thin film element and performs ink discharge corresponding to displacement of the vibrating plate layer due to a piezoelectric effect of the piezoelectric thin film element.

14. An ink jet type recording apparatus comprising:
the ink jet head according to claim 13;
a relative movement unit that causes the ink jet head to relatively move with respect to a recording medium; and
a driving unit that drives the piezoelectric thin film element such that recording is performed by discharging ink in the pressure chamber through a nozzle hole, which is provided to communicate with the pressure chamber in the ink jet head, while the ink jet head is relatively moving with respect to the recording medium by means of the relative movement unit.
